(19) United States
(12) Patent Application Publication
(10) Pub. No.: US 2026/0270275 A1
(43) Pub. Date: Sep. 10, 2026

(54) SYSTEMS AND METHODS FOR MACHINE LEARNING-BASED GENERATION OF CYBERSECURITY INCIDENT REPORTING ARTIFACTS

(71) Applicant: Expel, Inc., Herndon, VA (US)

(72) Inventors: Xenia Mountrouidou, Charleston, SC (US); Jane Hung, Raleigh, NC (US); Elisabeth Weber, Herndon, VA (US); Preeti Ravindra, Durham, NC (US)

(73) Assignee: Expel, Inc., Herndon, VA (US)

(21) Appl. No.: 19/556,618

(22) Filed: Mar. 4, 2026

Related U.S. Application Data
(60) Provisional application No. 63/951,165, filed on Dec. 30, 2025.
(60) Provisional application No. 63/767,123, filed on Mar. 5, 2025.

(51) Int. Cl. H04L 9/40; H04L 41/16

(52) U.S. Cl. CPC H04L 63/1416; H04L 41/16

(57) ABSTRACT

A computer-implemented system, computer-implemented method, and computer-program product include automatically generating, using a large language model, a security incident explanation that explains a security incident in natural language based on providing the large language model with a security incident explanation prompt. The security incident explanation prompt includes a plurality of distinct security alerts, investigation findings data, and a plurality of remediation actions.

### CROSS-REFERENCE TO RELATED APPLICATIONS

This application claims the benefit of US Provisional Application number 63/951,165, filed 30-DEC-2025 and US Provisional Application number 63/767,123, filed 05-MAR-2025, which are incorporated in their entireties by this reference.

### TECHNICAL FIELD

This invention relates generally to the cybersecurity field, and more specifically to a new and useful cyber threat detection and mitigation system and methods in the cybersecurity field.

### BACKGROUND

Modern computing and organizational environments have increasingly evolved to rely on complex, distributed, and heterogeneous computing infrastructures that include on-premises systems, cloud-based services, identity platforms, software-as-a-service applications, and networked computing resources. As a result, many organizational entities have adopted security operation services that abstract responsibility for monitoring, detecting, and responding to security threats affecting such computing and organizational resources to professionally managed security service providers operating outside of the organizational entity.

As organizational entities continue to expand their digital footprints and migrate critical workloads, data assets, and identity resources to cloud-based and hybrid computing environments, the volume, diversity, and sophistication of security alerts and cybersecurity events generated by security monitoring tools have increased substantially. In many cases, security operation services are required to ingest, process, and correlate large volumes of heterogeneous security alert data originating from multiple security technologies, vendors, and detection systems, each producing alerts with varying formats, semantics, and confidence levels.

Accordingly, security operation services may encounter technical challenges in efficiently interpreting, investigating, and communicating the significance of detected security alerts and confirmed security incidents to subscribing entities. In particular, transforming raw or semi-structured security alert data into coherent, explainable, and actionable investigation findings that can be readily understood by stakeholders may require substantial manual effort, expert analysis, and contextual reasoning. Such technical challenges may be further exacerbated by time-sensitive response requirements and the need to maintain consistent reporting quality across a large number of concurrent security incidents.

Thus, there is a need in the cybersecurity field to develop improved systems and methods for automatically generating structured security incident reporting artifacts that aggregate, contextualize, and communicate investigation findings data derived from detected security incidents.

The embodiments of the present application described herein provide technical solutions that address, at least the needs described above.

### BRIEF SUMMARY OF THE EMBODIMENTS

In one embodiment, a computer-implemented method includes at an event detection and response service implemented by a network of distributed computers: displaying, via a graphical user interface, a security alert associated with a subscribing entity; receiving, while the security alert is displayed on the graphical user interface, an input from a user selecting a security incident creation object; in response to receiving the input selecting the security incident creation object: automatically escalating the security alert to a security incident; automatically generating, based in part on the security alert, a security incident artifact that corresponds to the security alert; automatically updating the graphical user interface from displaying the security alert to displaying the security incident artifact corresponding to the security alert; and displaying a security incident explanation button on the graphical user interface while the graphical user interface is displaying the security incident artifact; receiving, from the user, an input selecting the security incident explanation button; in response to receiving the input from the user selecting the security incident explanation button: automatically creating a security incident explanation prompt based on (i) alert metadata associated with the security alert and (ii) investigation findings data obtained from investigating the security alert; and generating, using a large language model, a security incident explanation for the security incident based on providing the security incident explanation prompt to the large language model; adapting the security incident artifact to include the security incident explanation generated by the large language model; and surfacing, using one or more processors, the security incident artifact comprising the security incident explanation to the subscribing entity.

In one embodiment, the computer-implemented method further includes in response to receiving the input from the user selecting the security incident explanation button: automatically instantiating, before creating the security incident explanation prompt, an incident explanation user interface panel overlaying the security incident artifact displayed on the graphical user interface; displaying, within the incident explanation user interface panel, a loading animation while the large language model is generating the security incident explanation for the security incident; and automatically rendering, within the incident explanation user interface panel, the security incident explanation generated for the security incident.

In one embodiment, adapting the security incident artifact to include the security incident explanation includes: writing the security incident explanation to a memory buffer in response to receiving an input from the user selecting a copy button displayed within the incident explanation user interface panel; receiving, via the graphical user interface, an input from the user selecting an adding finding button displayed within a findings section of the security incident artifact; instantiating a finding entry popover in response to receiving the input selecting the adding finding button; inserting the security incident explanation stored in the memory buffer into the finding entry popover; receiving a findings confirmation input from the user at the finding entry popover; and in response to receiving the findings confirmation input from the user, automatically adding the security incident explanation inserted into the finding entry popover into the findings section of the security incident artifact.

In one embodiment, the security incident explanation prompt automatically created by the event detection and response service includes: a first distinct instruction instructing the large language model to assess the alert metadata and the investigation findings data to determine a start time of malicious activity; a second distinct instruction instructing the large language model to assess the alert metadata and the investigation findings data to determine an end time of the malicious activity; a third distinct instruction instructing the large language model to assess the alert metadata and the investigation findings data to determine a total number of distinct computing assets of the subscribing entity involved in the security incident; a fourth distinct instruction instructing the large language model to assess the alert metadata and the investigation findings data to determine a plurality of distinct tools used by an attacker to perform the malicious activity; a fifth distinct instruction instructing the large language model to determine a corresponding attack technique associated with each of the plurality of distinct tools used by the attacker to perform the malicious activity; a sixth distinct instruction instructing the large language model to assess the alert metadata and the investigation findings data to determine a degree of risk for the security incident; a seventh distinct instruction instructing the large language model to generate a risk justification explaining a basis for the degree of risk determined for the security incident; and an eighth distinct instruction instructing the large language model to generate, for each piece of evidence included in the alert metadata or the investigation findings data, one or more text strings explaining how that respective piece of evidence relates to the malicious activity.

In one embodiment, the security incident explanation includes a first timestamp value corresponding to an earliest timestamped piece of evidence included in the investigation findings data, a second timestamp value corresponding to a latest timestamped piece of evidence included in the investigation findings data, a total number of distinct computing assets of the subscribing entity involved in the security incident, a command string executed in a computing environment of the subscribing entity that caused the security incident, a first file path corresponding to a first executable file that executed the command string, a second file path corresponding to a second executable file that invoked execution of the first executable file, and a set of text strings that explains, in natural language: (i) that the second executable file invoked the first executable file, (ii) that the first executable file executed the command string, and (iii) a malicious operation performed by execution of the command string.

In one embodiment, the computer-implemented method further includes ingesting, by the event detection and response service, a plurality of distinct third-party security alerts generated by a plurality of distinct third-party security services in operable communication with the event detection and response service; assessing the plurality of distinct third-party security alerts against a plurality of detection instructions provided by the event detection and response service; and generating, by the event detection and response service, the security alert associated with the subscribing entity based on detecting that the plurality of distinct third-party security alerts satisfies at least one of the plurality of detection instructions, wherein: the plurality of distinct third-party security alerts are associated with the security alert generated by the event detection and response service; and the security incident explanation prompt includes: the alert metadata associated with the security alert, and each distinct piece of alert data specified in the plurality of distinct third-party security alerts.

In one embodiment, the computer-implemented method further includes before receiving the input selecting the security incident creation object: displaying, by the event detection and response service, an incident creation popover that includes the security incident creation object; receiving, via the incident creation popover, one or more remediation actions specified by the user for remediating or mitigating a security threat associated with the security incident; and in response to receiving the input selecting the security incident creation object, automatically performing, in real-time or near real-time, the one or more remediation actions to remediate or mitigate the security threat associated with the security incident, wherein: the security incident explanation prompt further includes the one or more remediation actions.

In one embodiment, investigating the security alert includes: automatically identifying, from a repository of automated investigation workflows, one or more automated investigation workflows digitally mapped to a threat type associated with the security alert; and automatically executing, using the one or more processors, the one or more automated investigation workflows in response to identifying the one or more automated investigation workflows digitally mapped to the threat type associated with the security alert, wherein executing each of the one or more automated investigation workflows includes: generating one or more application programming interface (API) calls based on the alert metadata associated with the security alert, transmitting the one or more API calls to one or more API endpoints of the plurality of distinct third-party security services, and obtaining, in response to transmitting the one or more API calls, log data associated with the security incident, the investigation findings data includes the log data obtained from executing each of the one or more automated investigation workflows, and the security incident explanation prompt further includes the log data obtained from executing each of the one or more automated investigation workflows.

In one embodiment, the large language model generates the security incident explanation by at least: assessing, in accordance with one or more instructions included in the security incident explanation prompt, the alert metadata associated with the security alert, assessing, in accordance with the one or more instructions included in the security incident explanation prompt, each distinct piece of alert data specified in the plurality of distinct third-party security alerts, assessing, in accordance with the one or more instructions included in the security incident explanation prompt, the one or more remediation actions, and assessing, in accordance with the one or more instructions included in the security incident explanation prompt, the log data obtained from executing each of the one or more automated investigation workflows.

In one embodiment, the security incident explanation prompt includes: a plurality of example security alerts associated with a prior security incident, a plurality of example remediation actions performed in response to detecting the prior security incident, a plurality of example malicious activity findings identified during a security investigation of the prior security incident, an example security incident explanation generated for the prior security incident based on an assessment of the plurality of example security alerts, the plurality of example remediation actions, and the plurality of example malicious activity findings, a first instruction that: (i) instructs the large language model to use the example security incident explanation when generating the security incident explanation for the security incident, and (ii) specifies the example security incident explanation is derived from the plurality of example security alerts, the plurality of example remediation actions, and the plurality of example malicious activity findings, the alert metadata associated with the security alert, the investigation findings data obtained from investigating the security alert, one or more remediation actions proposed by the event detection and response service to remediate or mitigate a security threat associated with the security incident, and a second instruction that further instructs the large language model to generate the security incident explanation for the security incident based on the alert metadata associated with the security alert, the investigation findings data obtained from investigating the security alert, and the one or more remediation actions proposed by the event detection and response service to remediate or mitigate the security threat associated with the security incident.

In one embodiment, the computer-implemented method further includes before generating the security incident explanation prompt: assessing an alert queue to determine whether the alert queue includes any pending security alerts associated with the subscribing entity and related to the security incident; detecting, based on the assessing of the alert queue, that a plurality of pending security alerts stored in the alert queue are related to the security incident; and generating a plurality of remediation actions to remediate or mitigate a security threat associated with the security alert and the plurality of pending security alerts, wherein: the investigation findings data includes a plurality of distinct malicious activity findings identified during investigation of the security alert and the plurality of pending security alerts, the security incident explanation prompt includes: the security alert associated with the subscribing entity, the plurality of pending security alerts, the plurality of remediation actions generated for the security alert and the plurality of pending security alerts, and the plurality of distinct malicious activity findings identified during the investigation of the security alert and the plurality of pending security alerts, a first instruction that instructs the large language model to generate the security incident explanation based on the security alert, the plurality of pending security alerts, the plurality of distinct malicious activity findings, and the plurality of remediation actions, and a second instruction that further instructs the large language model to generate the security incident explanation by at least: determining, based on one or more event selection criteria, a target event included in the security alert and the plurality of pending security alerts, using the plurality of distinct malicious activity findings to add context to the security incident explanation, and using the plurality of remediation actions to describe malicious digital activity that occurred in one or more computing environments of the subscribing entity.

In one embodiment, the security incident explanation includes a first set of text strings describing, in natural language, an earliest timestamp of malicious activity identified in the investigation findings data, a second set of text strings describing, in natural language, the malicious activity that occurred at the earliest timestamp, a third set of text strings describing, in natural language, a total number of digital accounts of the subscribing entity determined to be compromised, a fourth set of text strings describing, in natural language, a plurality of computing hosts within a computing environment of the subscribing entity that were accessed during the security incident, a fifth set of text strings describing, in natural language, one or more techniques used by a threat actor to access or move between the plurality of computing hosts during the security incident, and a sixth set of text strings describing, in natural language, that the plurality of computing hosts were compromised; and a seventh set of text strings describing, in natural language, one or more pieces of evidence included in the investigation findings data that resulted in the large language model detecting that the plurality of computing hosts were compromised.

In one embodiment, the security incident explanation includes a first set of text strings describing, in natural language, an earliest timestamp of attacker activity detected in the investigation findings data, a second set of text strings describing, in natural language, a computing resource of the subscribing entity that a threat actor accessed during the security incident, a third set of text strings describing, in natural language, a digital account of the subscribing entity that the threat actor used to access the computing resource of the subscribing entity, and a fourth set of text strings describing, in natural language, that the threat actor operated command-and-control infrastructure at a network address specified in the investigation findings data.

In one embodiment, the computer-implemented method further includes in response to escalating the security alert to the security incident, transmitting, over a computer network, a security incident explanation request to a security incident explanation microservice; in response to the security incident explanation microservice receiving the security incident explanation request, querying one or more databases of the event detection and response service to retrieve the alert metadata associated with the security alert and the investigation findings data obtained from investigating the security alert; generating, using the security incident explanation microservice, the security incident explanation prompt after the security incident explanation microservice receives the alert metadata associated with the security alert and the investigation findings data obtained from investigating the security alert; transmitting the security incident explanation prompt generated by the security incident explanation microservice to the large language model; storing, in computer memory accessible to the security incident explanation microservice, the security incident explanation generated by the large language model; and transmitting, by the security incident explanation microservice, the security incident explanation stored in the computer memory to the event detection and response service.

In one embodiment, the computer-implemented method further includes after the large language model generates the security incident explanation for the security incident: receiving, via the graphical user interface, feedback data from the user indicating an efficacy of the security incident explanation generated by the large language model; automatically generating, using the one or more processors, a training data sample that includes: the security incident explanation prompt provided to the large language model, the security incident explanation generated by the large language model based on the large language model processing the security incident explanation prompt, and the feedback data; and training the large language model using at least the training data sample.

In one embodiment, the event detection and response service automatically created the security incident explanation prompt based on one or more prompt generation parameters stored in memory, and the computer-implemented method includes: after the large language model generates the security incident explanation for the security incident: receiving, via the graphical user interface, feedback data from the user indicating an efficacy of the security incident explanation generated for the security incident, and adjusting, based on the feedback data, at least one of the one or more prompt generation parameters to modify how the event detection and response service constructs subsequent security incident explanation prompts.

In one embodiment, adapting the security incident artifact to include the security incident explanation generated by the large language model includes automatically inserting the security incident explanation generated by the large language model into a findings section of the security incident artifact.

In one embodiment, automatically creating the security incident explanation prompt includes: obtaining, from one or more databases of the event detection and response service, the alert metadata associated with the security alert and the investigation findings data obtained from investigating the security alert, and automatically anonymizing, by the one or more processors, at least one piece of data included in the alert metadata or the investigation findings data to an anonymized piece of data, wherein the security incident explanation prompt includes the anonymized piece of data and excludes the at least one piece of data in original form, the security incident explanation generated by the large language model includes the anonymized piece of data, and the computer-implemented method further includes: in response to adapting the security incident artifact to include the security incident explanation generated by the large language model, automatically replacing the anonymized piece of data included in the security incident artifact with the at least one piece of data in original form.

In one embodiment, automatically creating the security incident explanation prompt includes: automatically obtaining, from one or more databases of the event detection and response service, the alert metadata associated with the security alert and the investigation findings data obtained from investigating the security alert, automatically detecting personally identifiable information included in the alert metadata and the investigation findings data, in response to detecting the personally identifiable information, automatically generating a sanitized version of the alert metadata and the investigation findings data by removing the personally identifiable information from the alert metadata and the investigation findings data, and automatically constructing the security incident explanation prompt using the sanitized version of the alert metadata and the investigation findings data.

In one embodiment, the event detection and response service generated the security alert based on digital activity that occurred on a computing asset of the subscribing entity, and investigating the security alert includes executing an automated investigation protocol for the security alert, wherein executing the automated investigation protocol includes automatically extracting, from the security alert, an alert identifier of the security alert, a third-party service that detected the digital activity, and a globally unique identifier (GUID) that corresponds to the subscribing entity; automatically detecting that (i) a first directory path comprising the GUID exists within a hierarchical file system and (ii) a second directory path comprising a name of the third-party service exists within the hierarchical file system; in response to detecting that the first directory path and the second directory path exist within the hierarchical file system, automatically loading, into memory, a subscriber-specific investigative queries file located within the first directory path and a service-specific investigative queries file located within the second directory path; automatically extracting, from the subscriber-specific investigative queries file loaded into the memory, a plurality of subscriber-specific investigative query objects digitally mapped to the alert identifier corresponding to the security alert; in response to extracting the plurality of subscriber-specific investigative query objects, automatically constructing a first plurality of computer-executable investigation queries using the plurality of subscriber-specific investigative query objects and a first subset of the alert metadata associated with the security alert; automatically extracting, from the service-specific investigative queries file loaded into the memory, a plurality of service-specific investigative query objects digitally mapped to the alert identifier corresponding to the security alert; in response to extracting the plurality of service-specific investigative query objects, automatically constructing a second plurality of computer-executable investigation queries using the plurality of service-specific investigative query objects and a second subset of the alert metadata associated with the security alert; and obtaining, in response to executing the first plurality of computer-executable investigation queries and the second plurality of computer-executable investigation queries, the investigation findings data.

In one embodiment, executing the first plurality of computer-executable investigation queries includes transmitting, over a computer network, one or more API calls to an API endpoint provided by the third-party service, and the computer-implemented method further includes: in response to transmitting the one or more API calls to the API endpoint provided by the third-party service, obtaining a subset of the investigation findings data, wherein the subset of the investigation findings data includes: a first set of raw logs retrieved from the third-party service that occurred before the security alert was generated, and a second set of raw logs retrieved from the third-party service that occurred after the security alert was generated.

In one embodiment, executing the second plurality of computer-executable investigation queries includes transmitting, over a computer network, one or more API calls to an API endpoint provided by the third-party service, and the computer-implemented method further includes: in response to transmitting the one or more API calls to the API endpoint provided by the third-party service, obtaining a subset of the investigation findings data, wherein the subset of the investigation findings data includes: a first set of raw logs retrieved from the third-party service that occurred before the security alert was generated, and a second set of raw logs retrieved from the third-party service that occurred after the security alert was generated.

In one embodiment, the first plurality of computer-executable investigation queries and the second plurality of computer-executable investigation queries are simultaneously executed, executing one of the first plurality of computer-executable investigation queries includes: creating a first application programming interface (API) call operably configured to retrieve a first set of investigation findings data from the third-party service; creating a second API call operably configured to retrieve a second set of investigation findings data from a second third-party service different from the third-party service; transmitting, over a computer network, the first API call to an API endpoint provided by the third-party service; and transmitting, over the computer network, the second API call to an API endpoint provided by the second third-party service, executing one of the second plurality of computer-executable investigation queries includes: creating a third API call operably configured to retrieve a third set of investigation findings data from the third-party service; and transmitting, over the computer network, the third API call to the API endpoint provided by the third-party service, and the investigation findings data includes the first set of investigation findings data, the second set of investigation findings data, and the third set of investigation findings data.

In one embodiment, the event detection and response service generated the security alert based on digital activity that occurred on a computing asset of the subscribing entity, and investigating the security alert includes executing an automated investigation protocol for the security alert, wherein executing the automated investigation protocol includes: automatically extracting, from the security alert, an alert identifier of the security alert, a third-party service that detected the digital activity, and a globally unique identifier (GUID) that corresponds to the subscribing entity; automatically detecting that (i) a first directory path comprising the GUID exists within a hierarchical file system and (ii) a second directory path comprising a name of the third-party service exists within the hierarchical file system; in response to detecting that the first directory path and the second directory path exist within the hierarchical file system, automatically loading, into memory, a subscriber-specific investigative queries file located within the first directory path and a service-specific investigative queries file located within the second directory path; automatically extracting, from the subscriber-specific investigative queries file loaded into the memory, a plurality of subscriber-specific investigative query objects digitally mapped to the alert identifier corresponding to the security alert; in response to extracting the plurality of subscriber-specific investigative query objects, automatically constructing a first plurality of computer-executable investigation queries using the plurality of subscriber-specific investigative query objects and a first subset of the alert metadata associated with the security alert; automatically extracting, from the service-specific investigative queries file loaded into the memory, a plurality of service-specific investigative query objects digitally mapped to the alert identifier corresponding to the security alert; in response to extracting the plurality of service-specific investigative query objects, automatically constructing a second plurality of computer-executable investigation queries using the plurality of service-specific investigative query objects and a second subset of the alert metadata associated with the security alert; and obtaining, in response to executing the first plurality of computer-executable investigation queries and the second plurality of computer-executable investigation queries, the investigation findings data.

In one embodiment, executing the first plurality of computer-executable investigation queries includes transmitting, over a computer network, one or more API calls to an API endpoint provided by the third-party service, and the computer-implemented method further includes: in response to transmitting the one or more API calls to the API endpoint provided by the third-party service, obtaining a subset of the investigation findings data, wherein the subset of the investigation findings data includes: a first set of raw logs retrieved from the third-party service that occurred before the security alert was generated, and a second set of raw logs retrieved from the third-party service that occurred after the security alert was generated.

In one embodiment, executing the second plurality of computer-executable investigation queries includes transmitting, over a computer network, one or more API calls to an API endpoint provided by the third-party service, and the computer-implemented method further includes: in response to transmitting the one or more API calls to the API endpoint provided by the third-party service, obtaining a subset of the investigation findings data, wherein the subset of the investigation findings data includes: a first set of raw logs retrieved from the third-party service that occurred before the security alert was generated, and a second set of raw logs retrieved from the third-party service that occurred after the security alert was generated.

In one embodiment, the first plurality of computer-executable investigation queries and the second plurality of computer-executable investigation queries are simultaneously executed, executing one of the first plurality of computer-executable investigation queries includes: creating a first application programming interface (API) call operably configured to retrieve a first set of investigation findings data from the third-party service; creating a second API call operably configured to retrieve a second set of investigation findings data from a second third-party service different from the third-party service; transmitting, over a computer network, the first API call to an API endpoint provided by the third-party service; and transmitting, over the computer network, the second API call to an API endpoint provided by the second third-party service, executing one of the second plurality of computer-executable investigation queries includes: creating a third API call operably configured to retrieve a third set of investigation findings data from the third-party service; and transmitting, over the computer network, the third API call to the API endpoint provided by the third-party service, and the investigation findings data includes the first set of investigation findings data, the second set of investigation findings data, and the third set of investigation findings data.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application;

FIG. 3 illustrates a schematic representation of a process for executing one or more automated investigation workflows for a security alert in accordance with one or more embodiments of the present application;

FIG. 4 illustrates a schematic representation of a process for generating a security incident reporting artifact in accordance with one or more embodiments of the present application;

FIGS. 5, 5A and 5B illustrate various sections of the security incident reporting artifact in accordance with one or more embodiments of the present application;

FIG. 6 illustrates an example process for evaluation of investigation finding data in accordance with one or more embodiments of the present application;

FIG. 7 illustrates an example of a system or service implementing method 200 in accordance with one or more embodiments of the present application;

FIGS. 8, 8A, 8B and 8C illustrate example security incident explanation prompts in accordance with one or more embodiments of the present application;

FIGS. 9, 10, 10A, 11 and 11A illustrate example security incident explanations in accordance with one or more embodiments of the present application;

FIG. 12 illustrates an example of a graphical user interface displaying an alert queue in accordance with one or more embodiments of the present application;

FIG. 13 illustrates an example of a graphical user interface displaying an incident creation popover in accordance with one or more embodiments of the present application;

FIG. 14 illustrates an example of a graphical user interface displaying an incident creation popover in accordance with one or more embodiments of the present application; and

FIG. 15 illustrates an example of a security incident artifact generated for a security incident in accordance with one or more embodiments of the present application.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

The systems, methods, and computer-program products described herein may be used in any suitable security environment that requires real-time or near real-time investigation, assessment, escalation, explanation, and/or remediation of inbound security alerts to protect computing assets, digital infrastructure, digital accounts, and computing environments of subscribing entities from malicious activity. Such inbound security alerts may relate to suspicious authentication events, anomalous process execution events, command-line activity, file execution chains, lateral movement across computing hosts, command-and-control communications, compromised credentials, or any other digital activity that may exhibit malicious or suspicious characteristics within a computing environment.

Conventional cybersecurity systems are unable to automatically generate a security incident explanation that explains, in natural language, a security incident that occurred or is occurring within a computing environment of a subscribing entity. Consequently, such conventional cybersecurity systems are unable to explain, in natural language, complex security incidents to subscribing entities as they are detected in real-time or near real-time. As a result, since a subscribing entity is not provided with a security incident explanation in real-time or near real-time, the subscribing entity lacks contextual understanding of the security incident, which may delay execution of remediation actions and extend the duration that a malicious actor remains active within the computing environment.

Conversely, in response to detecting a security incident, the systems, methods, and computer-program products described herein may be operably configured to automatically generate, in real-time or near real-time, a security incident explanation that explains, in natural language, the security incident to a respective subscribing entity.

Furthermore, the systems, methods, and computer-program products described herein may be operably configured to generate the security incident explanation for the security incident in a secure manner to prevent data leaks. For instance, in some embodiments, the machine learning model (e.g., large language model) used to generate the security incident explanation may be deployed in a computing environment of the event detection and response service instead of using a large language model that is publicly accessible, thereby preventing alert metadata, investigation findings data, or remediation data from being transmitted outside of the event detection and response service. Additionally, in some embodiments, the event detection and response service may automatically detect one or more sensitive data elements included in alert metadata or investigation findings data, generate anonymized versions of the one or more sensitive data elements, and construct the security incident explanation prompt using the anonymized versions such that the machine learning model generates the security incident explanation without exposure to the original sensitive data elements, thereby isolating the machine learning model from direct access to the original sensitive data elements and preventing propagation of such original sensitive data elements into the security incident explanation. Additionally, in one or more embodiments, the event detection and response service may automatically identify and remove personally identifiable information (PII) from alert metadata or investigation findings data before constructing the security incident explanation prompt, thereby preventing the machine learning model from generating a security incident explanation that includes the personally identifiable information.

Furthermore, the systems, methods, and computer-program products described herein may reduce or minimize the number of inputs required for a user to generate a security incident explanation for a respective security incident. For example, in some embodiments, a user may select a single security incident explanation control (e.g., a button) within the graphical user interface, and in response to the single input, the event detection and response service may automatically perform a plurality of backend operations without further user interaction. Such backend operations may include retrieving alert metadata and investigation findings data from one or more data stores, constructing a security incident explanation prompt, anonymizing or filtering sensitive data elements within the security incident explanation prompt, providing the security incident explanation prompt to a machine learning model, receiving a security incident explanation generated from the machine learning model, and programmatically rendering the security incident explanation within the graphical user interface. By consolidating these operations into a single user-initiated action, the systems described herein eliminates the need for the user to navigate and/or use multiple different user interfaces, systems, and/or services. It shall be recognized that, in such an embodiment, reducing the number of inputs required for the user to generate the security incident explanation reduces interface transitions, rendering events, and repeated data retrieval operations, thereby reducing power usage and improving battery life of battery-operated devices by enabling the user to use the electronic device (e.g., computing device, battery-operated device, etc.) displaying the graphical user interface more efficiently. Additionally, reducing the number of inputs required prevents unnecessary consumption of central processing unit (CPU) resources, memory resources, and network resources while accelerating the end-to-end handling of security alerts, including triage, threat assessment, explanation generation, and threat mitigation.

Furthermore, the systems, methods, and computer-program products described herein may be operably configured to iteratively and/or automatically improve generation of security incident explanations based at least in part on feedback received from one or more users via the graphical user interface. In some embodiments, after the large language model generates the security incident explanation, the event detection and response service may receive feedback data indicating an efficacy, completeness, or accuracy of the generated security incident explanation. The systems, methods, and computer-program products described herein may automatically generate a training data sample comprising the security incident explanation prompt, the generated security incident explanation, and the received feedback data, and may use the training data sample to retrain, fine-tune, or otherwise adjust parameters of the large language model. In one or more embodiments, the feedback data may additionally or alternatively be used to modify one or more prompt generation parameters stored in memory to refine construction of subsequent security incident explanation prompts. By incorporating such feedback into a continuous improvement loop, the systems described herein reduce hallucinations, improve factual consistency, and enhance reliability of automatically generated security incident explanations over time. In other words, incorporating user feedback into retraining and prompt refinement mechanisms reduces hallucinations generated by the large language model and improves factual alignment between the generated security incident explanation and the underlying security data. Stated another way, the feedback-driven refinement process incrementally constrains generative behavior of the large language model such that subsequently generated security incident explanations more accurately reflect the alert metadata and the investigation findings data, thereby increasing reliability of automated explanation generation and reducing the likelihood that erroneous or unsupported content is displayed within the graphical user interface.

### 1. System for Remote Cyber Security Operations & Automated Investigations

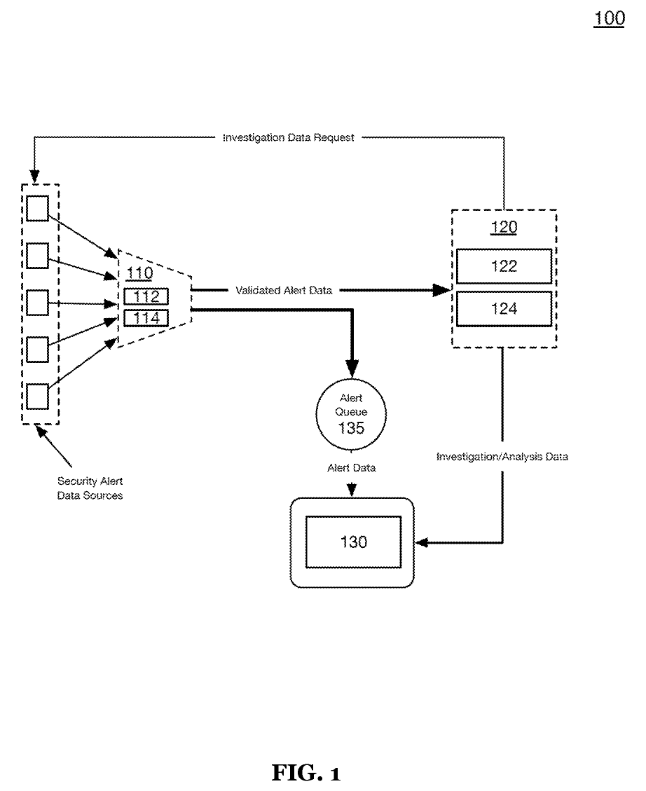

As shown in FIG. 1, a system 100 for implementing remote cybersecurity operations includes a security alert engine 110, an automated security investigations engine 120, and a security threat mitigation user interface 130. The system 100 may sometimes be referred to herein as a cybersecurity threat detection and threat mitigation system 100 or a cybersecurity event detection and response service.

The system 100 may function to enable real-time cybersecurity threat detection, agile, and intelligent threat response for mitigating detected security threats.

### 1.1 Security Alert Engine

The security alert aggregation and identification module 110, sometimes referred to herein as the “security alert engine 110” may be in operable communication with a plurality of distinct sources of cyber security alert data. In one or more embodiments, the module 110 may be implemented by an alert application programming interface (API) that may be programmatically integrated with one or more APIs of the plurality of distinct sources of cyber security alert data and/or native APIs of a subscriber to a security service implementing the system 100.

In one or more embodiments, the security alert engine 110 may include a security threat detection logic module 112 that may function to assess inbound security alert data using predetermined security detection logic that may validate or substantiate a subset of the inbound alerts as security threats requiring an escalation, an investigation, and/or a threat mitigation response by the system 100 and/or by a subscriber to the system 100.

Additionally, or alternatively, the security alert engine 100 may function as a normalization layer for inbound security alerts from the plurality of distinct sources of security alert data by normalizing all alerts into a predetermined alert format.

### 1.1.1 Security Alert Machine Learning Classifier

Optionally, or additionally, the security alert engine 110 may include a security alert machine learning system 114 that may function to classify inbound security alerts as validated or not validated security alerts, as described in more detail herein.

The security alert machine learning system 114 may implement a single machine learning algorithm or an ensemble of machine learning algorithms. Additionally, the security alert machine learning system 114 may be implemented by the one or more computing servers, computer processors, and the like of the artificial intelligence virtual assistance platform 110.

The machine learning models and/or the ensemble of machine learning models of the security alert machine learning system 114 may employ any suitable machine learning including one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) may be used in implementing the security alert machine learning system 114 and/or other components of the system 100.

### 1.2 Automated Investigations Engine

The automated security investigations engine 120, which may be sometimes referred to herein as the “investigations engine 120”, preferably functions to automatically perform investigative tasks for addressing a security task and/or additionally, resolve a security alert. In one or more embodiments, the investigations engine 120 may function to automatically resolve a security alert based on results of the investigative tasks.

In one or more embodiments, the investigations engine 120 may include an automated investigation workflows module 122 comprising a plurality of distinct automated investigation workflows that may be specifically configured for handling distinct security alert types or distinct security events. Each of the automated investigation workflows preferably includes a sequence of distinct investigative and/or security data production tasks that may support decisioning on or a disposal of a validated security alert. In one or more embodiments, the investigations engine 120 may function to select or activate a given automated investigation workflow from among the plurality of distinct automated investigation workflows based on an input of one or more of validated security alert data and a security alert classification label.

Additionally, or alternatively, the investigations engine 120 may include an investigations instructions repository 124 that includes a plurality of distinct investigation instructions/scripts or investigation rules that inform or define specific investigation actions and security data production actions for resolving and/or addressing a given validated security alert. In one or more embodiments, the investigations instructions repository 124 and/or the security alert engine 110 may be dynamically updated to include additional or to remove one or more of the plurality of distinct investigation instructions/scripts or investigation rules.

### 1.3. Security Mitigation User Interface

The security mitigation user interface 130 may function to enable an analyst or an administrator to perform, in a parallel manner, monitoring, investigations, and reporting of security incidents and resolutions to subscribers of the system 100 and/or service implementing the system 100. In some embodiments, an operation of the security user interface 130 may be transparently accessible to subscribers, such that one or more actions in monitoring, investigation, and reporting security threats or security incidents may be surfaced in real-time to a user interface accessible to a subscribing entity.

Accordingly, in one or more embodiments, a system user (e.g., an analyst) or an administrator implementing the security mitigation user interface 130 may function to make requests for investigation data, make requests for automated investigations to the automated investigations engine 120, obtain security incident status data, observe or update configuration data for automated investigations, generate investigation reports, and/or interface with any component of the system 100 as well as interface with one or more systems of a subscriber.

Additionally, or alternatively, in one or more embodiments, the security mitigation user interface 130 may include and/or may be in digital communication with a security alert queue 135 that stores and prioritizes validated security alerts.

### 2. Method for Automated Generation of Security Incident Reporting Artifacts for System-Validated Security Alerts

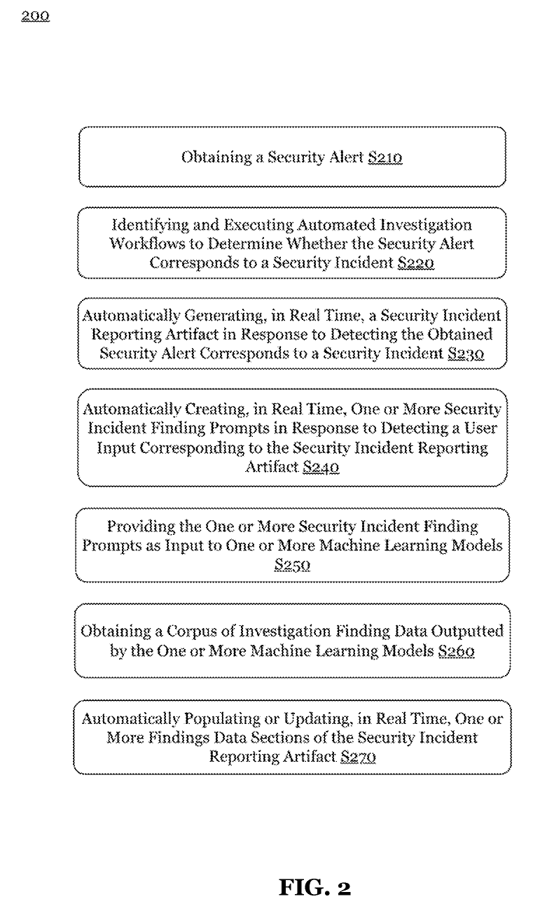

As shown in FIG. 2, a method 200 for automated generation of security incident reporting artifacts for system-validated security alerts includes obtaining a security alert S210, identifying and executing automated investigation workflows to determine whether the security alert corresponds to a security incident S220, automatically generating, in real time, a security incident reporting artifact in response to detecting the obtained security alert corresponds to a security incident S230, automatically creating, in real time, one or more security incident finding prompts in response to detecting a user input corresponding to the security incident reporting artifact S240, providing the one or more security incident finding prompts as input to one or more machine learning models S250, obtaining a corpus of investigation finding data outputted by the one or more machine learning models S260, and automatically populating or updating, in real time, one or more findings data sections of the security incident reporting artifact S270.

### 2.10 Obtaining a Security Alert

S210, which includes obtaining a security alert, may function to obtain security alert data signals from one or more distinct security or technology data sources. In an embodiment, S210 may function to collect and/or receive security alert data involving digital or computing assets of subscribing entities, including, but not limited to, one or more computing resources, computer network resources, data resources, cloud-based resources, identity resources, application resources, any computer-accessible digital entity or device, and/or the like.

In one or more embodiments, the one or more distinct security or technology data sources may include one or more third-party web-based security services and/or one or more digital services implemented or operating on one or more systems or networks of a subscriber. For example, S210 may function to periodically request or generate application programming interface (API) calls to each of the one or more distinct security or technology data sources for providing security alert data signals to a system (e.g., the system 100 implementing the method 200). Additionally, or alternatively, via an intelligent data source and service system (e.g., the system 100), S210 may function to receive automatic pushes of security alert data signals from the one or more distinct security or technology data sources to the system 100.

In one or more embodiments, the security alert data signals produced by the one or more distinct security or technology data sources may include, but should not be limited to, vendor-generated alert data, threat detection alert data, anomaly detection alert data, authentication-related alert data, endpoint activity alert data, network activity alert data, cloud activity alert data, subscriber-generated alert data, third-party alert data, and other security-related alert data associated with activity occurring within or involving computing environments of a subscriber.

Accordingly, in one or more embodiments, the security alert data signals generated from the one or more distinct security or technology data sources may be processed through an automated security alert engine implemented by the system 100 that may or may not produce system-validated security alerts. In other words, S210 may function to obtain security alert data signals that may be indicative of a probable security threat and may also obtain security alert data signals that may not be indicative of a likely security threat.

In one or more embodiments, a security alert data signal may comprise a machine-readable digital data structure generated by a cybersecurity application, security service, or security monitoring system in response to detecting activity that satisfies one or more predefined security conditions. The security alert data signal may represent a discrete indication of potentially suspicious, anomalous, or policy-violating activity occurring within or involving a computing environment of a subscribing entity.

In one or more embodiments, the security alert data signal may include one or more data fields describing attributes of the detected activity, including, but not limited to, an event identifier, an alert identifier, a timestamp, a source identifier, a destination identifier, an asset identifier, a user or identity identifier, an application identifier, a network address, a device identifier, a resource identifier, a security policy identifier, a severity indicator, a confidence indicator, and/or a classification label assigned by the cybersecurity application. The security alert data signal may further include contextual metadata describing environmental conditions under which the activity occurred, such as authentication context, authorization context, network context, device posture context, or cloud resource context.

In one or more embodiments, the security alert data signal may be generated by a cybersecurity application implementing one or more detection mechanisms, including rule-based detection logic, heuristic detection logic, statistical detection logic, anomaly detection logic, signature-based detection logic, behavioral analysis logic, or machine learning-based detection logic. In such embodiments, the security alert data signal may encode detection outputs produced by the cybersecurity application, including detection scores, probability values, threshold evaluations, or explanatory attributes associated with the detection.

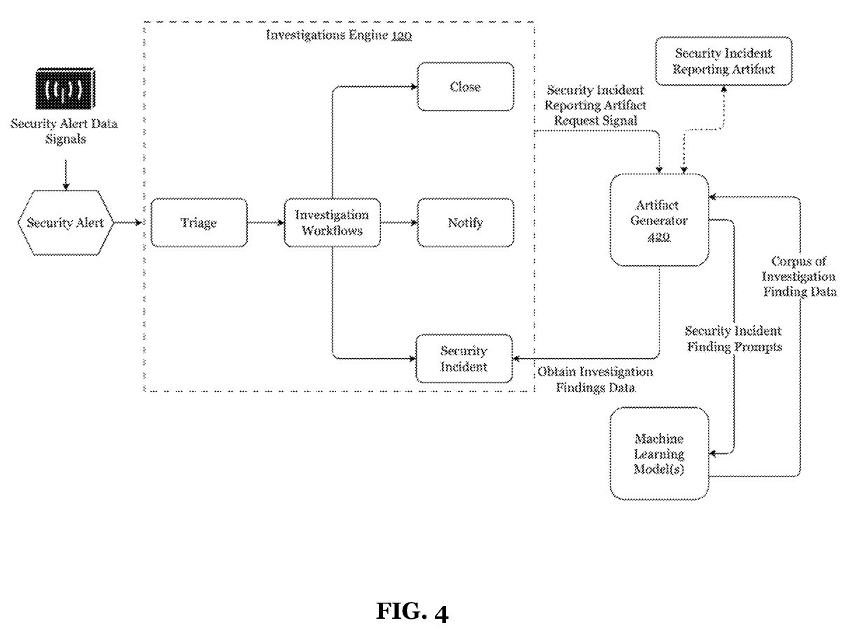

In one or more embodiments, the security alert data signal may be transmitted by the cybersecurity application in a structured or semi-structured format, including, but not limited to, JavaScript Object Notation (JSON) format, extensible markup language format, key-value pair format, log record format, or other machine-readable serialization formats suitable for transmission, storage, and downstream automated processing. The security alert data signal may be transmitted as a discrete message, as part of a batch transmission, or as a stream of security alert data signals (as shown in a non-limiting example in FIG. 4).

In one or more embodiments, the security alert data signal may correspond to a wide range of cybersecurity applications, including endpoint security applications, identity and access management applications, network security applications, cloud security applications, data loss prevention applications, threat detection applications, and security information and event management applications. In such embodiments, the security alert data signal may represent detections associated with authentication events, authorization events, process execution events, network communication events, data access events, configuration change events, privilege escalation events, lateral movement events, or other security-relevant activity occurring within or involving computing systems of a subscribing entity.

In one or more embodiments, the security alert data signal may be generated independently of whether the detected activity ultimately corresponds to a confirmed security incident. Accordingly, the security alert data signal may represent a preliminary, intermediate, or advisory indication of activity that may require further evaluation, investigation, correlation, or disposition by an automated security system.

It shall be recognized that the system or service implementing method 200 may function to generate, obtain, and/or receive a security alert using one or more system components and/or processes described in U.S. Patent No. 12,530,450, titled SYSTEMS AND METHODS FOR AUTOMATICALLY TUNING ONE OR MORE API POLLERS IN A CYBERSECURITY EVENT DETECTION AND RESPONSE SERVICE, U.S. Patent No. 12,346,447, titled SYSTEMS, METHODS, AND GRAPHICAL USER INTERFACES FOR CONFIGURING AND IMPLEMENTING COMPUTER-EXECUTABLE DETECTION INSTRUCTIONS IN A CYBERSECURITY THREAT DETECTION AND MITIGATION PLATFORM, U.S. Patent No. 12,381,897, titled SYSTEMS AND METHODS FOR AUTOMATICALLY CREATING NORMALIZED SECURITY EVENTS IN A CYBERSECURITY THREAT DETECTION AND MITIGATION PLATFORM, which are incorporated herein in their entireties by this reference.

### 2.20 Identifying and Executing Automated Investigation Workflows to Determine Whether the Security Alert Corresponds to a Security Incident

S220, which includes identifying and executing automated investigation workflows, may function to identify an automated investigation workflow based on one or more characteristics of a security alert obtained by the system 100 and to execute the identified automated investigation workflow to determine whether the security alert corresponds to a security incident. In one embodiment, S220 may function to selectively identify and execute an automated investigation workflow of a plurality of distinct automated investigation workflows for automatically handling one or more portions of a cybersecurity investigation associated with a security alert that has been escalated beyond an initial alerting stage.

In one or more embodiments, an automated investigation workflow may comprise a sequence or collection of distinct investigative actions, investigation automations, investigative queries, or investigative subroutines that, when executed, may perform one or more automated investigative tasks. Such automated investigative tasks may include, but should not be limited to, automatically sourcing investigation data, automatically correlating investigation data, automatically performing validation checks, and automatically producing investigation outputs that support a determination of whether the security alert represents a security incident. In this regard, execution of an automated investigation workflow may function to construct additional context and explanation relating to activity associated with the security alert.

In one or more embodiments, a plurality of distinct automated investigation workflows may be maintained by the system, wherein each automated investigation workflow may be configured for a distinct security alert type, security event type, or threat classification. In such embodiments, S220 may function to map a security alert to a corresponding automated investigation workflow using a reference table, data structure, or workflow selection logic that associates security alert attributes with predefined investigation workflows. For example, a first security alert type may be mapped to a first automated investigation workflow and a second security alert type may be mapped to a second automated investigation workflow that is distinct from the first automated investigation workflow.

In one or more embodiments, S220 may function to automatically execute the identified automated investigation workflow by generating and submitting one or more investigation queries to one or more subscriber data sources associated with the security alert. In such embodiments, the automated investigation workflow may define data criteria, data requirements, or investigation instructions that specify how investigation data should be sourced from the subscriber data sources. The investigation data returned in response to the investigation queries may be used to evaluate security-relevant activity associated with the security alert and to support a determination of whether the security alert corresponds to a security incident.

In one or more embodiments, a security incident may comprise a confirmed or substantiated occurrence of unauthorized, anomalous, malicious, or policy-violating activity involving one or more computing resources of the subscribing entity, wherein the activity exceeds a predefined alerting threshold and warrants escalation beyond an initial security alert stage. A security incident may represent a determination by the system 100 that the security alert corresponds to activity that poses a material risk to the confidentiality, integrity, or availability of computing systems, data resources, network resources, identity resources, and/or cloud-based resources of the subscribing entity.

In one or more embodiments, a security incident may be identified based on execution of automated investigation workflows performed by the investigation engine 120 that evaluate security alert data signals in view of additional investigation data, contextual metadata, historical activity patterns, or threat classification logic. In such embodiments, a security incident may correspond to a security alert that has been validated through automated investigation as requiring remediation, containment, notification, or further incident response actions.

In one or more embodiments, a security incident may be distinguished from a security alert in that a security alert represents a preliminary indication of potentially suspicious activity, whereas a security incident represents a system-validated determination that the activity constitutes a confirmed or highly probable security threat.

In non-limiting examples, a security incident may include, but should not be limited to, a confirmed unauthorized access event, a confirmed malware execution event, a confirmed phishing compromise, a confirmed cloud resource misconfiguration or abuse event, a confirmed data exfiltration event, wherein investigation workflows identify anomalous data transfer volumes, unauthorized data access operations, or transmission of sensitive data to external network destinations, and/or a confirmed insider threat event. Other examples may be possible and are contemplated.

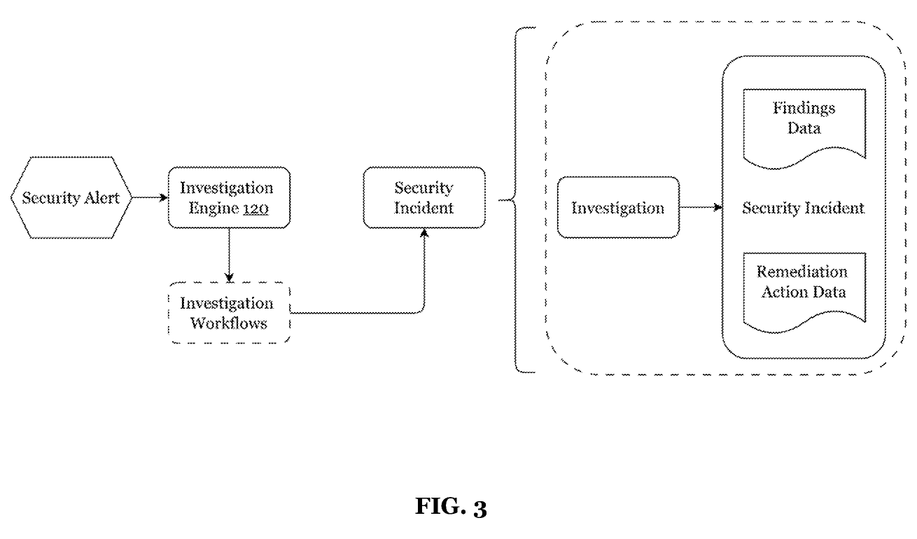

As illustrated in one non-limiting example of FIG. 3, the security alert may be obtained by the investigations engine 120, which may be configured to perform one or more automated investigation workflows. As illustrated in FIG. 3, once a determination is made that the security alert corresponds to a security incident, subsequent investigation activities may be logically associated with the security incident rather than the original security alert. In this example, FIG. 3 shows that investigation workflows may continue at the security incident level, and investigation outputs may be organized with respect to the security incident. This incident level investigation may include continued analysis, correlation, and interpretation of investigation finding data in order to understand the nature and scope of the security incident.

In one or more embodiments, “investigation finding data,” as used herein may include machine-readable data generated, collected, or derived during execution of one or more automated investigation workflows for the security alert. The investigation finding data may represent information obtained from querying, analyzing, or correlating security-relevant data sources to evaluate activity associated with the security alert. In some examples, investigation finding data may include contextual, descriptive, and/or explanatory data identifying characteristics of the activity associated with the security alert. Such characteristics may include, but should not be limited to, identifying what type of activity occurred, where the activity occurred within a computing environment, when the activity occurred, how the activity occurred, or what entities, resources, or identities were involved in the activity.

In one or more embodiments, investigation finding data may be obtained from one or more subscriber data sources, security data sources, or internal system data sources, including event logs, authentication records, access records, network traffic data, endpoint activity data, cloud service data, or other security-relevant data associated with the security alert. The investigation finding data may be generated automatically in response to execution of investigative queries, investigative scripts, or investigative actions defined by an automated investigation workflow.

In one or more embodiments, investigation finding data may further include determinations, classifications, correlations, or summaries produced by the investigation engine 120 based on analysis of the obtained security-relevant data. In one or more embodiments, investigation finding data may be used as input for generating, populating, or updating the security incident reporting artifact, and may be maintained in association with a security alert identifier, a security incident identifier, or both, for use during investigation, reporting, or response operations.

Referring again to FIG. 3, the investigation outputs associated with the security incident may at least include findings data and/or remediation action data. In some examples, findings data may represent investigation-derived explanations or descriptions of the activity associated with the security incident. Further, remediation action data may represent actions taken or recommended to contain, mitigate, or resolve the security incident. Accordingly, S220 may function to not only to execute automated investigation workflows and determine whether the security alert corresponds to a security incident, but also to establish the security incident as the primary unit of investigation and response once such a determination is made.

FIG. 4 illustrates another example of investigation of the security alert identified using one or more security alert data signals. The security alert may be obtained by the investigations engine 120 for automated handling and disposition. In one or more embodiments, the investigations engine 120 may receive the security alert that has been normalized and validated by upstream alert processing operations and may subject the security alert to an initial triage stage prior to execution of one or more automated investigation workflows. The triage stage may function to preliminarily assess attributes of the security alert, including alert type, severity indicators, contextual metadata, or other characteristics associated with the security alert.

In one or more embodiments, following triage, the investigations engine 120 may function to route the security alert to an automated investigation workflows stage, wherein one or more automated investigation workflows may be identified and executed based on the characteristics of the security alert. The automated investigation workflows may comprise predefined sequences of investigation actions, investigation automations, or investigative queries configured to obtain additional investigation data relating to activity associated with the security alert. Execution of the automated investigation workflows may function to generate investigation finding data that supports a determination of an appropriate disposition for the security alert.

As further illustrated in FIG. 4, execution of an automated investigation workflow may result in multiple alternative outcomes. In one or more embodiments, the investigations engine 120 may determine, based on investigation finding data produced by the automated investigation workflows, that the security alert should be closed without further action. Additionally, or alternatively, the investigations engine 120 may determine that the security alert should result in a notification action, wherein notification data may be transmitted to a subscriber, an analyst, or another system. In still other embodiments, execution of the automated investigation workflows may result in classification of the security alert as a security incident, thereby triggering downstream incident handling operations.

Accordingly, S220 may function as a controlled, machine-executed investigation process in which the security alert is evaluated through triage and automated investigation workflows to determine whether the security alert should be closed, notified, or escalated to a security incident, without requiring manual investigative intervention.

It shall be recognized that the system or service implementing method 200 may identify, investigate, and/or respond to security events and/or security alerts as described in U.S. Patent Application No. 17/488,800, titled SYSTEMS AND METHODS FOR INTELLIGENT CYBER SECURITY THREAT DETECTION AND MITIGATION THROUGH AN EXTENSIBLE AUTOMATED INVESTIGATIONS AND THREAT MITIGATION PLATFORM, U.S. Patent Application No. 17/501,708, titled SYSTEMS AND METHODS FOR INTELLIGENT PHISHING THREAT DETECTION AND PHISHING THREAT REMEDIATION IN A CYBER SECURITY THREAT DETECTION AND MITIGATION PLATFORM, U.S. Patent Application No. 17/671,881, titled SYSTEMS AND METHODS FOR INTELLIGENT CYBER SECURITY THREAT DETECTION AND INTELLIGENT VERIFICATION-INFORMED HANDLING OF CYBER SECURITY EVENTS THROUGH AUTOMATED VERIFICATION WORKFLOWS, U.S. Patent Application No. 17/850,328, titled SYSTEMS AND METHODS FOR INTELLIGENT CYBERSECURITY ALERT SIMILARITY DETECTION AND CYBERSECURITY ALERT HANDLING, U.S. Patent Application No. 18/123,137, titled SYSTEMS AND METHODS FOR ACCELERATED REMEDIATIONS OF CYBERSECURITY ALERTS AND CYBERSECURITY EVENTS IN A CYBERSECURITY EVENT DETECTION AND RESPONSE PLATFORM, U.S. Patent Application No. 18/129,638, titled SYSTEMS AND METHODS FOR INTELLIGENT CONFIGURATION AND DEPLOYMENT OF ALERT SUPPRESSION PARAMETERS IN A CYBERSECURITY THREAT DETECTION AND MITIGATION PLATFORM, and U.S. Patent Application No. 19/304,982, titled SYSTEMS AND METHODS FOR REAL-TIME GENERATION AND EXECUTION OF COMPUTER-EXECUTABLE INVESTIGATIVE QUERIES IN A CYBERSECURITY EVENT DETECTION AND RESPONSE PLATFORM, which are incorporated herein in their entireties by this reference.

### 2.30 Automatically Generating, in Real Time, a Security Incident Reporting Artifact in Response to Detecting the Obtained Security Alert Corresponds to a Security Incident

S230, which includes automatically generating, in real time, a security incident reporting artifact in response to detecting the obtained security alert corresponds to a security incident, may function to source and/or generate a security incident reporting artifact based on a likely or probable incident type or threat type associated with the security incident determined by the system. A security incident reporting artifact, as generally referred to herein, may be a subscriber facing digital cybersecurity artifact that may include a plurality of distinct regions that may be digitally mapped to one or more incident type specific content automations specifically designed for communicating investigation finding data of the security incident to the subscribing entity. In one or more embodiments, S230 may function to selectively source and/or automatically instantiate a security incident reporting artifact from a plurality of security incident reporting artifacts based on a threat type, an incident type, a security alert classification label, a severity designation, one or more security alert attributes, and/or a combination thereof.

In a first implementation, a distinct security incident reporting artifact may be defined for each recognized and/or distinct threat type classification or category of the security incident. In such implementation, via a reference table or any suitable data structure, each class or distinct type of security incident may be mapped or electronically linked to a distinct security incident reporting artifact that may be digitally mapped to a plurality of threat type specific content automations. For instance, a first security incident type or distinct threat type classification may be mapped to a first security incident reporting artifact and a second security incident type or distinct threat type classification may be mapped to a second security incident reporting artifact that may be distinct from the first security incident reporting artifact and that may be specifically configured to communicate investigation finding data relating to a target cybersecurity event. It shall be noted that, in one or more embodiments, each sourced or instantiated security incident reporting artifact may include a plurality of distinct regions digitally mapped to one or more threat type specific content automations, and preferably include a plurality of automatically generated threat type specific content automations that may be specifically designed to install, encode, and/or present investigation finding data into the plurality of distinct regions using selective subsets of investigation finding data.

Accordingly, in one or more embodiments of the first implementation, in response to an escalation of the security alert to the security incident, S230 may function to automatically source, trigger, or cause a system generated spin up or system generated creation of security incident reporting artifact (e.g., security incident artifact or the like) by performing a search of a reference mapping data structure using a cybersecurity threat type, an incident type identifier, a security alert classification label, and/or other classification data associated with the security incident. In such embodiments, the sourced security incident reporting artifact may be initialized or instantiated as an electronically accessible incident reporting template that may be stored and maintained by the system and that may be available through a dynamic console or dynamic digitally accessible interface of a cybersecurity event detection and response service.

Additionally, or alternatively, in a second implementation, a set of threat type specific content automations may be defined for each recognized and/or distinct threat type classification or category of a security incident. In such embodiments, via a reference table or any suitable data structure, each class or distinct type of security incident may be mapped or electronically linked to a set of threat type specific content automations. For instance, a first security incident type or distinct threat type classification may be mapped to a first set of threat type specific content automations and a second security incident type or distinct threat type classification may be mapped to a second set of threat type specific content automations that may be specifically configured to communicate investigation finding data relating to a distinct security incident type.

Accordingly, in one or more embodiments of the second implementation, S230 may function to source or instantiate a non-threat type specific security incident reporting artifact that may include a plurality of customizable regions. Each of the plurality of customizable regions may be modified to include one or more system determined content automations such that the one or more system determined content automations may be selected by the system to provide content automations salient to comprehension of the security incident to a subscribing entity. In such embodiments, S230 may function to spin up a non-threat type specific security incident reporting artifact and install, encode, or digitally map a subset of the mapped or electronically linked threat type specific content automations to one or more of the plurality of customizable regions based on a subject security incident and/or based on investigation finding data corresponding to the subject security incident.

Additionally, or alternatively, in a third implementation, a set of threat type specific content automations and/or a distinct security incident reporting artifact may be defined for each recognized and/or distinct class of remediation actions associated with a security incident. In one or more embodiments, via a reference table or any suitable data structure, each class or distinct type of remediation action may be mapped or electronically linked to a set of threat type specific content automations and/or mapped to a security incident reporting artifact configured to present remediation actions data together with investigation finding data. For instance, a first remediation action type or distinct remediation classification may be mapped to a first set of threat type specific content automations and a second remediation action type or distinct remediation classification may be mapped to a second set of threat type specific content automations that may be specifically configured to communicate investigation finding data and remediation actions data that support mitigation of a security incident.

In one or more embodiments of the third implementation, S230 may function to automatically source, trigger, or cause a system generated spin up, system generated creation, or instantiation of a prefabricated security incident reporting artifact by performing a search of a reference mapping data structure using one or more remediation actions, remediation action identifiers, remediation action categories, and/or remediation action classifications associated with the security incident. In such embodiments, the sourced security incident reporting artifact may be initialized or instantiated and maintained by the system as an incident level digital cybersecurity artifact that is configured for population with investigation finding data and remediation actions data during ongoing investigation and response operations.

It shall be noted that, in one or more embodiments, the security incident reporting artifact may be generated in an initialized state that includes the plurality of distinct regions prior to full population of investigation finding data and remediation actions data. In such embodiments, S230 may function to generate the structure of the security incident reporting artifact contemporaneously with, or immediately following, a determination that the obtained security alert corresponds to a security incident, and the system may subsequently populate one or more of the plurality of distinct regions based on investigation finding data obtained from one or more automated investigation workflows and based on remediation actions data associated with remediation operations for the security incident.

As illustrated in one non-limiting example of FIG. 4, generation of the security incident reporting artifact may be performed by an artifact generator 420 that is operably coupled to the investigations engine 120. In one or more embodiments, upon a determination by the investigations engine 120 that the obtained security alert corresponds to a security incident, the investigations engine 120 may generate or transmit a security incident reporting artifact request signal to the artifact generator 420. The security incident reporting artifact request signal may function as a system-generated control signal indicating that an incident-level digital artifact should be created, instantiated, or updated for a corresponding security incident. In such embodiments, the artifact generator 420 may respond to receipt of the security incident reporting artifact request signal by initiating generation of the security incident reporting artifact associated with the security incident.

In one or more embodiments, the artifact generator 420 may function to obtain investigation finding data associated with the security incident from one or more system-accessible data stores, from the investigations engine 120, or from outputs of one or more automated investigation workflows executed by the investigations engine 120. The investigation finding data may include investigation-derived data collected, generated, or correlated during automated investigation of the security alert and may be associated with one or more identifiers corresponding to the security incident. The artifact generator 420 may use the obtained investigation finding data as input for constructing and populating one or more portions of the security incident reporting artifact, thereby generating an incident-level digital cybersecurity artifact that aggregates investigation finding data produced during investigation of the security incident.

In one or more embodiments, the artifact generator 420 may function to generate the security incident reporting artifact as a structured digital artifact comprising one or more predefined regions configured to receive and store investigation finding data associated with the security incident. In one or more embodiments, generation of the security incident reporting artifact may include initializing the structured digital artifact prior to full population of investigation finding data. In such embodiments, the artifact generator 420 may generate the security incident reporting artifact in an initialized state and subsequently populate or update one or more regions of the security incident reporting artifact as additional investigation finding data becomes available to the system. Accordingly, the artifact generator 420 may maintain the security incident reporting artifact as a persistent, incident-level representation that evolves during ongoing investigation and response operations associated with the security incident.

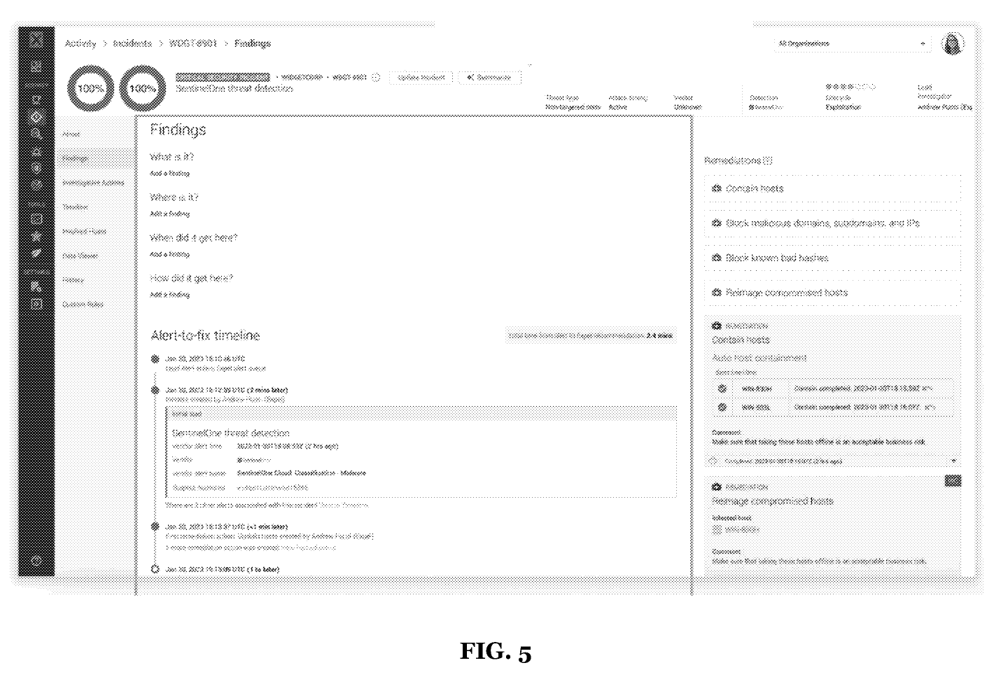

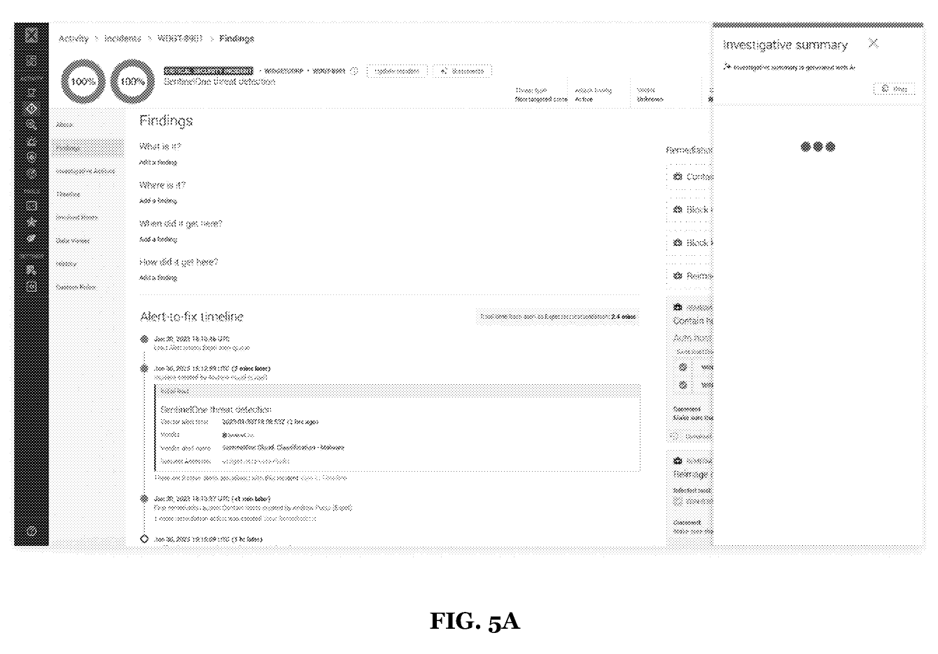

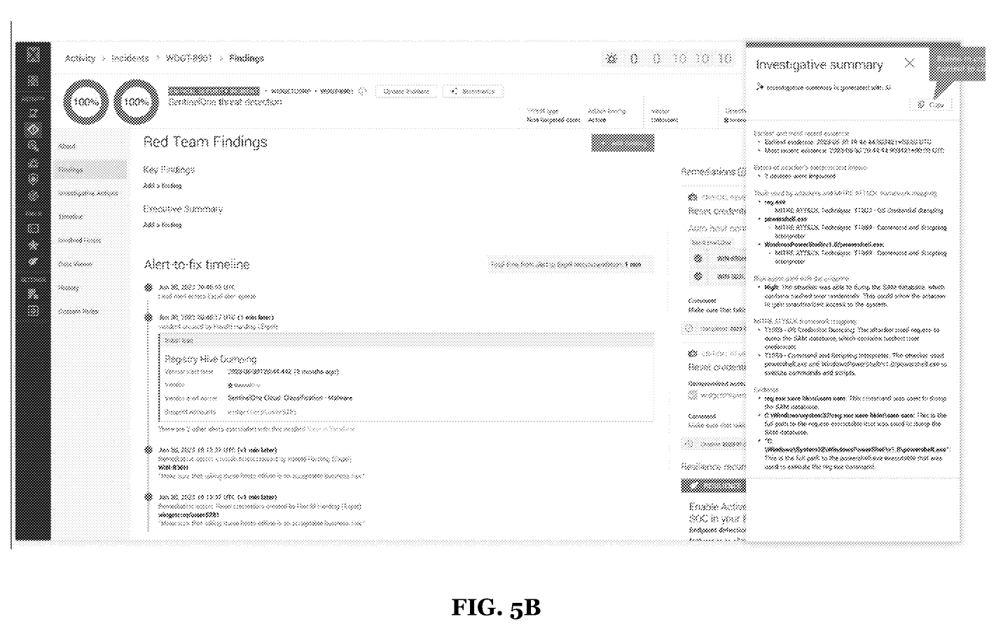

As illustrated in one non-limiting example of FIG. 5, the security incident reporting artifact may be implemented as an electronically accessible, incident-level digital interface generated and maintained by the system. In one or more embodiments, FIG. 5 depicts an example rendering of the security incident reporting artifact after generation by the artifact generator 420 and population with investigation finding data associated with the security incident. In such embodiments, the security incident reporting artifact may function as a centralized, system-generated digital representation that aggregates investigation finding data, remediation-related information, and temporal incident context associated with the security incident into a single coherent presentation.

In one or more embodiments, the security incident reporting artifact shown in FIG. 5 may be dynamically generated in response to promotion of the security alert to a security incident and may be continuously updated as additional investigation finding data becomes available to the system during investigation and response operations. The security incident reporting artifact may be maintained in association with a security incident identifier and may be accessible through a computing interface provided by the system 100. Accordingly, FIG. 5 illustrates one exemplary implementation in which the security incident reporting artifact serves as a persistent, incident-specific digital artifact that supports ongoing investigation, interpretation, communication, and remediation activities associated with the security incident, without requiring manual assembly of investigation outputs.

It shall be recognized that, in one or more embodiments, the system or service implementing method 2oo may generate, instantiate, or construct the security incident reporting artifact (e.g., security incident artifact or the like) using one or more system components and/or one or more processes described in U.S. Patent 11,416,609, titled SYSTEMS AND METHODS FOR CYBER SECURITY THREAT DETECTION AND EXPEDITED GENERATION OF INVESTIGATION STORYBOARDS USING INTELLIGENT CYBER SECURITY AUTOMATIONS, which is incorporated herein in its entirety by this reference.

### Automated Instantiation of one or more Findings Data Sections of the Security Incident Reporting Artifact

As shown in the non-limiting example of FIG. 5, in one or more embodiments, S230 may function to automatically initiate (e.g., instantiate or the like) one or more findings data sections of a security incident reporting artifact. In such embodiments, initiation of the one or more findings data sections may include instantiating one or more predefined, structurally distinct regions of the security incident reporting artifact that are each digitally mapped to a respective category of investigation finding data associated with the security incident.

In one or more embodiments, each findings data section of the security incident reporting artifact may be instantiated in a foundational, extensible, or skeletal state, prior to automated population of each findings data section with investigation finding data. In such embodiments, the initiated findings data sections may comprise predefined section headers, predefined prompts, predefined structural layouts, and/or predefined semantic expectations that collectively define the type of investigation finding data that may be presented within each section.

In one or more embodiments, the one or more findings data sections may be predefined based on investigation-oriented questions that may be used to explain, summarize, and/or contextualize a security incident to the subscriber entity. In such embodiments, the predefined findings data sections may include, but are not limited to, a first findings data section corresponding to a “what is it” investigative category, a second findings data section corresponding to a “where is it” investigative category, a third findings data section corresponding to a “when did it get here” investigative category, and a fourth findings data section corresponding to a “how did it get here” investigative category. Each such findings data section may be initiated as a distinct region within the security incident reporting artifact.

In one or more embodiments, each initiated findings data section may include one or more predefined prompts, placeholders, or user-visible indicators that signal the expected type of investigation finding data to be generated for that findings data section. For example, a findings data section corresponding to a “what is it” investigative category may include a predefined textual prompt indicating that descriptive information identifying the nature of the detected activity is expected to be presented in the section. Similarly, a findings data section corresponding to a “where is it” investigative category may include a predefined prompt indicating that information identifying affected computing resources, network locations, user identities, cloud resources, or other digital entities is expected to be presented in the section.

In one or more embodiments, initiation of the findings data sections may further include rendering one or more interactive affordances within each findings data section that indicate readiness for later augmentation. Such interactive affordances may include, but are not limited to, visual placeholders, section-level controls, or system-generated indicators that a findings data section has been instantiated but not yet populated. In such embodiments, the presence of the interactive affordances may communicate to a subscriber or analyst that investigation finding data may be subsequently introduced into the findings data section through automated processes performed by the system.

As illustrated in one non-limiting example of FIG. 5, the security incident reporting artifact may be presented as a digital interface that includes a findings region comprising multiple vertically arranged findings data sections. In such example, each findings data section may be visually labeled with an investigation-oriented prompt, such as “What is it,” “Where is it,” “When did it get here,” and “How did it get here,” and may further include a corresponding placeholder indicator indicating that findings data has not yet been introduced into the section. In such embodiments, S230 may function to cause the security incident reporting artifact to be rendered with the findings data sections visible and structurally defined, while deferring population of the sections to subsequent method steps.

In one or more embodiments, the initiated findings data sections may be logically associated with a security incident identifier and maintained by the system as part of the security incident reporting artifact throughout the lifecycle of the security incident. In such embodiments, the findings data sections may serve as persistent containers for investigation finding data that may be generated, updated, or refined during subsequent investigation and response operations.

### Alert-to-Fix Timeline Automation

In one or more embodiments, as shown by way of an example in FIG. 5, S230 may further function to automatically initiate the security incident reporting artifact including a region digitally mapped to an alert-to-fix timeline automation. In such embodiments, the alert-to-fix timeline automation of the security incident reporting artifact may be instantiated in an initial structural state that is configured to receive and organize a plurality of system-generated temporal milestones associated with lifecycle progression of the security alert and a corresponding security incident. The alert-to-fix timeline automation may function as a machine-readable and subscriber-visible chronological representation of security-relevant events beginning with detection of the security alert and extending through execution and completion of remediation actions associated with the security incident.

In one or more embodiments, the alert-to-fix timeline automation may be automatically initiated contemporaneously with, or immediately following, a determination by the system 100 that an obtained security alert corresponds to a security incident. In such embodiments, initiation of the alert-to-fix timeline automation may occur based on system-recorded execution events, timestamps, and state transitions produced during automated processing of the security alert by the system 100.

In one or more embodiments, the alert-to-fix timeline automation may comprise a predefined timeline structure including a plurality of prefabricated milestone placeholders, each milestone placeholder being configured to correspond to a distinct phase or event in handling of the security alert or the security incident. Non-limiting examples of such milestone placeholders may include a security alert ingestion milestone, an alert triage milestone, an investigation initiation milestone, a security incident creation milestone, one or more remediation action initiation milestones, and one or more remediation action completion milestones. Each milestone placeholder may be configured to accept system-generated timestamp data and contextual metadata associated with the corresponding phase of processing.

In one or more embodiments, initiation of the alert-to-fix timeline automation may include automatically populating an initial milestone corresponding to receipt of the security alert by the system 100, including an associated timestamp indicating when the security alert entered an alert processing queue executing and/or newly originated within the investigations engine 120. In such embodiments, subsequent milestones may be configured for automatic population as additional processing events occur within the system 100, including execution of investigation workflows, classification of the security alert as a security incident, and initiation of remediation actions.

In one or more embodiments, the alert-to-fix timeline automation may be configured such that each milestone entry includes one or more of a timestamp, an event label, an event description, and a source identifier indicating which subsystem, workflow, or automation of the system 100 generated the milestone. In such embodiments, the alert-to-fix timeline automation may provide a structured, chronological account of system-executed actions and decisions without requiring manual annotation or narrative synthesis.

In one or more embodiments, the alert-to-fix timeline automation may further be configured to update dynamically as additional system-generated events occur during investigation and response operations. In such embodiments, initiation of the alert-to-fix timeline automation during S230 may establish a persistent timeline region within the security incident reporting artifact that remains active throughout the lifecycle of the security incident and that is incrementally updated as remediation actions are executed, modified, or completed.

In one non-limiting example shown in FIG. 5, initiation of the alert-to-fix timeline automation may include generating a first timeline entry corresponding to receipt of a security alert by the system 100. As shown in the illustrated example, the first timeline entry may include a timestamp such as “Jan 30, 2023, 18:10:46 UTC” and an associated textual descriptor indicating that a lead alert enters an alert processing queue managed by the system 100. The first timeline entry may visually indicate commencement of system handling of the security alert.

The alert-to-fix timeline automation may further include generating a subsequent timeline entry corresponding to creation of a security incident. In the illustrated example, a second timeline entry may include a timestamp such as “Jan 30, 2023, 18:12:59 UTC (2 mins later)” and an associated textual descriptor indicating that a security incident was created. In such embodiments, the timeline entry may further include a visual grouping labeled as an initial lead that identifies the originating security alert associated with the security incident.

In one or more embodiments, the initial lead portion of the alert-to-fix timeline automation may display structured identifying information associated with the originating security alert. As shown in the example, such identifying information may include a vendor identifier, a vendor alert name, a vendor alert classification, a vendor alert detection time, and one or more suspect identities associated with the security alert. In the illustrated example, the timeline entry may include a label such as “SentinelOne threat detection,” a vendor alert name such as “SentinelOne Cloud: Classification – Malware,” and a suspect account identifier such as “widgetcorp\user5281.”

In one or more embodiments, the alert-to-fix timeline automation may further include generating one or more remediation-related timeline entries. As illustrated in the example, a subsequent timeline entry may include a timestamp such as “Jan 30, 2023, 18:13:37 UTC (<1 min later)” and a textual descriptor indicating that a first remediation action was created. In such embodiments, the remediation-related timeline entry may indicate the remediation action type, such as containment of hosts, and may reference a system or service responsible for executing the remediation action.

In one or more embodiments, the alert-to-fix timeline automation may further include a summary indicator associated with the alert-to-fix timeline region. As shown in the example, such a summary indicator may display a computed duration value such as “Total time from alert to recommendation: 2.4 mins,” representing elapsed time between initial receipt of the security alert and generation of one or more system-recommended actions.

### Remediation Actions Data Automation

In one or more embodiments, S230 may function to automatically initiate a security incident reporting artifact that includes a region digitally mapped to a remediation actions data automation. In such embodiments, the remediation actions data automation may be instantiated as a distinct section of the security incident reporting artifact that is configured to present remediation-related information associated with a security incident in a structured and machine-generated manner.

In one or more embodiments, initiation of the remediation actions data automation may occur contemporaneously with, or immediately following, a determination by the system 100 that an obtained security alert corresponds to a security incident. In such embodiments, the remediation actions data automation may be initialized in an extensible structural state that includes one or more predefined remediation action entries, each remediation action entry being configured to represent a distinct remediation action applicable to the security incident.

In one or more embodiments, the remediation actions data automation may include a list-based remediation actions section that displays a plurality of remediation action options available for mitigating the security incident. As shown in the illustrated example in FIG. 5, such remediation action options may include actions such as containing one or more hosts, blocking malicious domains, subdomains, and internet protocol addresses, blocking known malicious file hashes, and reimaging compromised hosts. Each remediation action option may be displayed as a discrete remediation action entry within the remediation actions section.

In one or more embodiments, each remediation action entry of the remediation actions data automation may include a remediation action label identifying the remediation action type and a visual indicator indicating availability or selection status of the remediation action. In the illustrated example, remediation action entries may be visually grouped under a remediation label and presented in a selectable format, indicating that such remediation actions are applicable to the security incident.

In one or more embodiments, the remediation actions data automation may further include one or more remediation execution detail sections associated with selected remediation actions. As shown in the illustrated example, a remediation execution detail section may include a remediation action title, a remediation execution mode descriptor, and identification of one or more affected computing resources. For example, a remediation execution detail section may display a remediation action titled “Contain hosts,” an execution mode labeled as “auto host containment”, and a list of host identifiers subject to the remediation action. For instance, the “auto host containment” includes a first host “WIN-830H” and corresponding remediation action “Contain completed: 2023-01-30T18:15:59Z.” In another example, the “auto host containment” includes a second host “WIN-503L” and corresponding remediation action “Contain completed: 2023-01-30T18:16:07Z.”

In one or more embodiments, the remediation execution detail section may further include status indicators corresponding to remediation execution outcomes. As illustrated in the example, such status indicators may include completion indicators associated with specific host identifiers and timestamps indicating when remediation actions were completed. In such embodiments, the remediation actions data automation may present remediation completion states in a visually distinguishable manner to indicate successful execution of remediation actions.

In one or more embodiments, the remediation actions data automation may further include one or more remediation annotation fields configured to display explanatory or advisory information associated with remediation actions. As shown in the illustrated example, a remediation annotation field may include a comment indicating a contextual consideration associated with execution of the remediation action, such as an advisory statement regarding operational impact of taking computing resources offline.

In one or more embodiments, initiation of the remediation actions data automation may establish a persistent remediation section within the security incident reporting artifact that remains active throughout investigation and response operations. In such embodiments, the remediation actions data automation may be configured to accept updates reflecting changes in remediation action status, completion state, or associated contextual information as remediation activities progress.

Accordingly, S230 may provide at least one technical advantage by enabling the system to automatically generate and maintain a structured, incident-level digital cybersecurity artifact that consolidates investigation finding data produced by automated investigation workflows into a persistent, machine-readable representation. By instantiating the security incident reporting artifact contemporaneously with classification of a security alert as a security incident, the system avoids ad hoc or manual assembly of investigation outputs and ensures that investigation finding data, temporal context, and remediation actions data are programmatically organized according to predefined structural regions. This automated artifact generation improves computational consistency across incident handling operations, reduces duplication of investigation outputs across downstream processes, and enables subsequent system components to reliably access, reference, and update investigation finding data using a stable artifact identifier. As a result, S230 improves the technical efficiency of incident-level data management within the system by establishing a normalized, extensible, and machine-maintained incident representation that supports continuous investigation, response, and reporting operations without requiring manual data restructuring.

### 2.4 Automatically Creating, in Real Time, One or More Security Incident Finding Prompts in Response to Detecting a User Input Corresponding to the Security Incident Reporting Artifact

S240, which includes automatically creating, in real time, one or more security incident finding prompts in response to detecting a user input corresponding to the security incident reporting artifact, may function to programmatically construct one or more structured prompt objects that are configured to control generation of investigation finding data (e.g., security incident explanation, etc.) for population or updating of one or more regions of the security incident reporting artifact generated in S230.

In one or more embodiments, S240 may be triggered in response to detecting a user selection associated with a predefined region of the security incident reporting artifact. In such embodiments, the user input may correspond to a selection of a control element, placeholder, or interactive affordance rendered within a region of the security incident reporting artifact that was initialized (e.g., instantiated) but not fully populated during S230.

In one or more embodiments, as illustrated in the non-limiting example of FIG. 5, the security incident reporting artifact may include one or more user-selectable control elements displayed within an incident-level digital interface generated by the system. In such embodiments, a control element labeled “Summarize” may be rendered within the security incident reporting artifact and may be positioned in proximity to incident identification information associated with the security incident. The “Summarize” control element may be configured to receive a user input indicative of a request for automated synthesis of investigation finding data associated with the security incident.

In one or more embodiments, detection of a user selecting the control element displayed on the security incident reporting artifact may function as a trigger condition for initiating real-time construction of one or more security incident finding prompts by the system or service implementing method 200. In such embodiments, the user input corresponding to selection of the “Summarize” control button may be interpreted by the system as a request to generate an investigative summary (e.g., security incident explanation) derived from at least investigation finding data already included in the security incident reporting artifact.

In response to detecting the user input corresponding to the control element displayed on the security incident reporting artifact, S240 may function to automatically initiate construction of one or more structured prompt objects without requiring additional manual input from the user. In such embodiments, the system may identify a summary-oriented investigation category associated with the user selection and may generate one or more security incident finding prompts configured to control generation of investigation finding data corresponding to the identified investigation category.

As illustrated in the non-limiting example of FIG. 5A, in one or more embodiments, the real-time initiation of prompt construction may result in generation of an investigative summary section within the security incident reporting artifact, that may be displayed as a distinct interface region labeled “Investigative summary.” In such embodiments, the investigative summary section may be generated asynchronously in response to the user input, while the system executes one or more machine learning models using the constructed security incident finding prompts as input.

In one or more embodiments, construction of the one or more security incident finding prompts in response to selection of the control button may occur contemporaneously with display of a processing indicator within the investigative summary interface region, as illustrated in FIG. 5A. In such embodiments, the processing indicator may visually communicate that automated generation of investigation finding data is in progress while the system executes the one or more machine learning models using the constructed prompt objects.

In one or more embodiments, S240 may function to interpret the detected user input as a request to generate investigation finding data corresponding to a specific predefined investigation category associated with the selected region of the security incident reporting artifact. In such embodiments, S240 may function to automatically create one or more security incident finding prompts that are scoped (e.g., specifically configured) to the selected investigation category and constrained to operate on investigation finding data associated with the security incident. As used herein, an investigation category may refer to a predefined, system-recognized classification that defines a type of investigative analysis to be performed with respect to a security incident and corresponds to a distinct region of a security incident reporting artifact.

In one or more embodiments, an investigation category may specify a semantic and functional scope for generation, organization, and presentation of investigation finding data associated with the security incident. Each investigation category may be associated with a distinct analytical objective and may constrain the type of investigation finding data to be considered, the manner in which the investigation finding data is to be reasoned over, and the form in which resulting investigation finding data is to be encoded for population of a corresponding region of the security incident reporting artifact. In one or more embodiments, investigation categories may include, but are not limited to, an incident characterization investigation category, an affected environment identification investigation category, an incident temporal analysis investigation category, an incident causality determination investigation category, and/or the like. Each such investigation category may correspond to a distinct analytical perspective of the security incident and may be designed to support structured explanation, interpretation, and communication of investigation finding data to the subscribing entity.

In one or more embodiments, a security incident finding prompt may comprise a machine-readable prompt object that includes a prompt instruction segment and a prompt context segment. The prompt instruction segment may include machine-executable instructions that control how investigation finding data is to be analyzed, reasoned over, and transformed into structured outputs suitable for insertion into a corresponding region of the security incident reporting artifact. The prompt context segment may include selective subsets of investigation finding data, security alert data, temporal data, remediation actions data, and incident classification data associated with the security incident. In one or more embodiments, each investigation category may be mapped to one or more predefined regions of the security incident reporting artifact. This mapping may be used by the system to determine which prompt templates, prompt instruction segments, and prompt context segments are to be selected when constructing one or more security incident finding prompts. In such embodiments, selection of an investigation category may control how selective subsets of investigation finding data, alert-to-fix timeline data, and remediation actions data associated with the security incident are incorporated into a structured prompt object.

In one or more embodiments, the prompt instruction segment may be configured to implement chain-of-thought prompting by encoding an ordered sequence of reasoning directives that cause decomposition of the investigation category into intermediate analytical steps. The intermediate analytical steps may include identifying relevant investigation finding data attributes, evaluating relationships among the identified attributes, and synthesizing an explanation grounded in the investigation finding data.

In one or more embodiments, the prompt instruction segment may further implement few-shot prompting by embedding one or more exemplary investigation outputs associated with the investigation category. The exemplar investigation outputs may define an expected structure, level of technical specificity, and evidentiary grounding for generated investigation finding data that is to be introduced into the corresponding region of the security incident reporting artifact.

In one or more embodiments, S240 may function to select a prompt template from a prompt template repository based on the investigation category associated with the selected region and populate the selected prompt template with incident-specific context data associated with the security incident. In such embodiments, each prompt template may be preconfigured to guide generation of investigation finding data suitable for a specific region of the security incident reporting artifact.

### Incident Characterization Prompt

In one or more embodiments, S240 may function to automatically create an incident characterization prompt of the one or more security incident finding prompts. The incident characterization prompt may be configured to control, when used as an input to one or more machine learning models, the generation of investigation finding data (e.g., an aspect of a security incident explanation) describing a classification, nature, and general type of activity associated with the security incident. In such embodiments, the incident characterization prompt may be generated as a structured prompt object comprising a prompt context segment and a prompt instruction segment. In an implementation, the structured prompt object may be configured to constrain an output of the one or more machine learning models to an incident characterization scope associated with the incident characterization investigation category.

In one or more embodiments, the prompt context segment of the incident characterization prompt may include investigation finding data identifying one or more security alert sources, one or more security alert classification labels, one or more threat classifications, one or more severity indicators, one or more affected identities, and one or more affected computing resources associated with the security incident. In such embodiments, the prompt context segment may further include one or more structured data fields extracted from a security alert record associated with the security incident, including a vendor identifier, a vendor alert name, a vendor alert detection timestamp, an alert identifier, and one or more correlated investigation workflow outputs associated with the security incident.

Additionally, or alternatively, the prompt context segment may include one or more extracted timeline milestone values from the alert-to-fix timeline region of the security incident reporting artifact and one or more remediation actions data entries from the remediation actions data automation region of the security incident reporting artifact. In an embodiment, the remediation actions data entries may provide additional incident characterization context by indicating one or more remediation action categories that have been selected, proposed, executed, and/or completed in association with the security incident.

In one implementation, the prompt instruction segment of the incident characterization prompt may implement chain-of-thought prompting that programmatically defines an ordered reasoning procedure for deriving an incident characterization output grounded in the prompt context segment. In such implementation, the ordered reasoning procedure may include a sequence of intermediate reasoning directives that require the one or more machine learning models to identify a primary security alert classification label and a primary threat classification from among the investigation finding data, and one or more supporting incident attributes from among the affected identities and affected computing resources. The sequence of intermediate reasoning directives may further require the one or more machine learning models to correlate the primary security alert classification label with one or more activity-type descriptors, and synthesize an incident characterization output that includes a bounded set of incident characterization elements. In one or more embodiments, the bounded set of incident characterization elements may include an activity type descriptor, an affected entity descriptor, and a detection source descriptor, while excluding remediation guidance, speculative root-cause conclusions, or unsupported causal assertions. In such embodiments, the chain-of-thought prompting may further constrain the one or more machine learning models to generate an incident characterization output that is consistent with a predefined incident characterization schema, including a fixed ordering of incident characterization elements and a maximum length constraint.

In one non-limiting example, the chain-of-thought prompting may require a model-executed reasoning sequence comprising: (i) selecting a dominant vendor alert classification from the vendor alert name and the security alert classification label, (ii) identifying an incident type descriptor corresponding to the dominant vendor alert classification, (iii) identifying at least one affected identity and at least one affected computing resource, and (iv) generating a single incident characterization sentence that combines the incident type descriptor, the affected identity, and the affected computing resource without introducing investigation finding data outside the prompt context segment. In such example, if the prompt context segment includes a vendor alert name indicating a malware classification and includes an affected identity corresponding to a suspect account identifier and an affected computing resource corresponding to a host identifier, the chain-of-thought prompting may guide the one or more machine learning models to produce an incident characterization output that describes activity consistent with a malware execution event involving the host identifier and associated with the suspect account identifier, and that attributes detection to the vendor source indicated by the vendor alert name. Other examples may be possible and are contemplated.

In another non-limiting example, if the prompt context segment includes investigation finding data indicating anomalous authentication activity associated with an identity resource and includes security alert classification data indicating a suspicious login threat type, the chain-of-thought prompting may guide identification of a dominant incident characterization category corresponding to unauthorized access or account compromise activity. The chain-of-thought prompting may further control generation of an incident characterization output that describes the security incident as an unauthorized access event involving the affected identity resource and a corresponding computing environment segment identified in the prompt context segment. In such embodiments, the chain-of-thought prompting may further control selection of a neutral characterization phrase that avoids asserting causality beyond the investigation finding data, while still expressing a classification, nature, and general type of activity associated with the security incident.

In one or more embodiments, the chain-of-thought prompting implemented by the prompt instruction segment may further include one or more validation directives that require the one or more machine learning models to cross-check incident characterization elements against the prompt context segment, e.g., prior to output generation. In such embodiments, the one or more validation directives may include a directive requiring confirmation that each asserted incident characterization element is supported by an explicit data field or explicit investigation workflow output included in the prompt context segment, and a directive requiring omission of any incident characterization element that cannot be grounded in the prompt context segment. In such embodiments, the chain-of-thought prompting may reduce generation of unsupported incident descriptions and may improve consistency of incident characterization outputs across distinct security incident types.

In another implementation, the prompt instruction segment may further include few-shot prompting examples that demonstrate standardized incident characterization outputs. In such an implementation, the few-shot prompting examples may comprise one or more exemplar prompt input and output pairs, wherein each exemplar prompt input includes an exemplar set of investigation finding data fields and each exemplar output includes a corresponding standardized incident characterization output formatted according to a predefined incident characterization schema. In one or more embodiments, the few-shot prompting examples may be selected based on one or more prior incident characterization outputs that have been previously generated and validated, such that the few-shot prompting examples encode standardized phrasing conventions, standardized ordering of characterization elements, and standardized inclusion or exclusion rules for incident characterization outputs.

In one non-limiting example, a first few-shot prompting example may include an exemplar prompt input corresponding to a malware classification incident type, wherein the exemplar prompt input includes a vendor identifier, a vendor alert name indicating malware detection, a host identifier, and a suspect account identifier. In the example, the exemplary prompt output may include a standardized incident characterization output describing a malware execution incident affecting the host identifier and associated with the suspect account identifier. In another non-limiting example, a second few-shot prompting example may include an exemplar prompt input corresponding to an unauthorized access incident type, wherein the exemplar prompt input includes an alert classification label indicating suspicious login activity, an affected identity resource, and an anomalous access timestamp. Further, the exemplar prompt output may include a standardized incident characterization output describing an unauthorized access event involving the affected identity resource. In such embodiments, the few-shot prompting examples may guide the one or more machine learning models to adopt the standardized phrasing and standardized structure demonstrated by the exemplar outputs when generating an incident characterization output for a new security incident.

In one or more embodiments, the prompt instruction segment may combine the chain-of-thought prompting and the few-shot prompting examples by positioning the few-shot prompting examples as a formatting and content boundary reference and positioning the chain-of-thought prompting as a reasoning procedure for selecting and arranging incident characterization elements. In such embodiments, the incident characterization prompt may cause the one or more machine learning models to generate incident characterization investigation finding data that is consistent across incidents, is grounded in investigation finding data, and is constrained to the incident characterization investigation category without introducing remediation recommendations or findings content associated with other investigation categories.

### Incident Localization Prompt

In one or more embodiments, S240 may function to automatically create an incident localization prompt of the one or more security incident finding prompts. The incident localization prompt may be configured to control, when used as an input to one or more machine learning models, the generation of investigation finding data describing, in one embodiment, one or more digital locations within a computing environment at which activity associated with the security incident occurred and one or more impacted computing entities associated with the security incident. In such an embodiment, the incident localization prompt may be generated as a structured prompt object comprising a prompt context segment and a prompt instruction segment. In an implementation, the structured prompt object may be configured to constrain an output of the one or more machine learning models to an incident localization scope associated with an incident localization investigation category.

In one or more embodiments, the prompt context segment of the incident localization prompt may include investigation finding data identifying one or more affected computing resources, one or more affected network resources, one or more affected identity resources, and one or more affected cloud-based resources associated with the security incident. In such embodiments, the prompt context segment may further include one or more structured data fields extracted from the security alert record associated with the security incident, including, but not limiting to, a vendor identifier, a vendor alert name, a vendor alert detection timestamp, an alert identifier, and one or more correlated investigation workflow outputs associated with the security incident. In one or more embodiments, the one or more correlated investigation workflow outputs may include network address attributes, endpoint identifiers, process execution attributes, and cloud service activity attributes that are usable to localize the activity of the security incident within the computing environment.

Additionally, or alternatively, the prompt context segment may include one or more extracted timeline milestone values from the alert-to-fix timeline region of the security incident reporting artifact. The prompt context segment may further include one or more remediation actions data entries from the remediation actions data automation region of the security incident reporting artifact. In an embodiment, one or more remediation actions data entries may provide incident localization context by indicating one or more remediation action targets, including, but not limiting to, one or more host identifiers selected for host containment, one or more domain identifiers selected for blocking, one or more internet protocol addresses selected for blocking, and one or more file hash identifiers selected for blocking.

In one implementation, the prompt instruction segment of the incident localization prompt may implement chain-of-thought prompting that programmatically defines an ordered reasoning procedure for deriving an incident localization output grounded in the prompt context segment. In such implementation, the ordered reasoning procedure may include a sequence of intermediate reasoning directives that require the one or more machine learning models to identify one or more candidate affected computing entities from among the affected computing resources and the affected identity resources, identify one or more candidate network locations from among the network address attributes and network resource attributes, and correlate the one or more candidate affected computing entities with the one or more candidate network locations using one or more correlated investigation workflow outputs. The sequence of intermediate reasoning directives may further require the one or more machine learning models to synthesize an incident localization output that includes a bounded set of incident localization elements.

In one or more embodiments, the bounded set of incident localization elements may include an affected computing entity descriptor, a network location descriptor, and an environment segment descriptor, while excluding remediation guidance, speculative lateral movement assertions, or unsupported attribution conclusions. In such embodiments, the chain-of-thought prompting may further constrain the one or more machine learning models to generate an incident localization output that is consistent with a predefined incident localization schema, including a fixed ordering of incident localization elements, a maximum length constraint, and one or more output formatting constraints that require enumeration of candidate affected entities using one or more machine-readable delimiters.

In one non-limiting example, the chain-of-thought prompting may require a model-executed reasoning sequence comprising: (i) selecting one or more host identifiers from the prompt context segment, (ii) selecting one or more suspect identity identifiers associated with the one or more host identifiers, (iii) selecting one or more network address attributes associated with one or more authentication events or one or more endpoint activity events, and (iv) generating an incident localization sentence that identifies a host identifier, an identity identifier, and a network location descriptor without introducing investigation finding data outside the prompt context segment. In such example, if the prompt context segment includes a remediation actions data entry indicating host containment for a host identifier and includes an investigation workflow output indicating an internet protocol address associated with an anomalous authentication event, the chain-of-thought prompting may control the one or more machine learning models to produce an incident localization output that identifies the host identifier as an affected computing resource and identifies the internet protocol address as a network location associated with activity of the security incident. Other examples may be possible and are contemplated.

In another non-limiting example, if the prompt context segment includes investigation finding data indicating access to a cloud service resource and includes a cloud-based resource identifier and a cloud region identifier, the chain-of-thought prompting may guide identification of a cloud environment segment descriptor and may further control generation of an incident localization output that identifies the cloud-based resource identifier and the cloud region identifier as a location of the activity associated with the security incident. In such embodiments, the chain-of-thought prompting may further control selection of a neutral localization phrase that avoids asserting causality beyond the investigation finding data while still expressing one or more digital locations within the computing environment at which the activity occurred.

In one or more embodiments, the chain-of-thought prompting implemented by the prompt instruction segment may further include one or more validation directives that require the one or more machine learning models to cross-check incident localization elements against the prompt context segment, e.g., prior to output generation. In such embodiments, the one or more validation directives may include a directive requiring confirmation that each asserted host identifier, each asserted identity identifier, each asserted domain identifier, and each asserted internet protocol address is supported by an explicit data field or explicit investigation workflow output included in the prompt context segment. Additionally, or alternatively, the one or more validation directives may include a directive requiring omission of any incident localization element that cannot be grounded in the prompt context segment, thereby reducing generation of unsupported localization statements and improving consistency of incident localization outputs across distinct security incident types.

In another implementation, the prompt instruction segment may further include few-shot prompting examples that demonstrate standardized incident localization outputs. In such an implementation, the few-shot prompting examples may comprise one or more exemplar prompt input and output pairs, wherein each exemplar prompt input includes an exemplar set of investigation finding data fields and each exemplar prompt output includes a corresponding standardized incident localization output formatted according to a predefined incident localization schema. In one or more embodiments, the few-shot prompting examples may be selected based on one or more prior incident localization outputs that have been previously generated and validated, such that the few-shot prompting examples encode standardized phrasing conventions, standardized ordering of localization elements, and standardized inclusion or exclusion rules for incident localization outputs.

In one non-limiting example, a first few-shot prompting example may include an exemplar prompt input corresponding to an endpoint-focused incident type, wherein the exemplar prompt input includes a host identifier, a suspect account identifier, and an internet protocol address observed in one or more authentication logs. In the example, the exemplar prompt output may include a standardized incident localization output identifying the host identifier as an affected computing resource and identifying the internet protocol address as a network location associated with activity of the security incident. In another non-limiting example, a second few-shot prompting example may include an exemplar prompt input corresponding to a cloud service incident type, wherein the exemplar prompt input includes a cloud tenant identifier, a cloud resource identifier, and a cloud region identifier derived from one or more cloud audit logs. Further, the exemplar prompt output may include a standardized incident localization output identifying the cloud resource identifier and the cloud region identifier as a location of activity associated with the security incident. In such embodiments, the few-shot prompting examples may guide the one or more machine learning models to adopt the standardized phrasing and standardized structure demonstrated by the exemplar outputs when generating an incident localization output for a new security incident.

In one or more embodiments, the prompt instruction segment may combine the chain-of-thought prompting and the few-shot prompting examples by positioning the few-shot prompting examples as a formatting and content boundary reference and positioning the chain-of-thought prompting as a reasoning procedure for selecting and arranging incident localization elements. In such embodiments, the incident localization prompt may cause the one or more machine learning models to generate incident localization investigation finding data that is consistent across incidents, is grounded in investigation finding data, and is constrained to the incident localization investigation category, without introducing remediation recommendations or findings content associated with other investigation categories.

### Incident Temporal Analysis Prompt

In one or more embodiments, S240 may further function to automatically create an incident temporal analysis prompt of the one or more security incident finding prompts. The incident temporal analysis prompt may be configured to control, when used as input to one or more machine learning models, the generation of investigation finding data describing temporal characteristics of activity associated with the security incident. In such embodiments, the incident temporal analysis prompt may be generated as a structured prompt object comprising a prompt context segment and a prompt instruction segment. In an implementation, the structured prompt object may be configured to constrain an output of the one or more machine learning models to a temporal analysis scope associated with an incident temporal investigation category.

In one or more embodiments, the prompt context segment of the incident temporal analysis prompt may include investigation finding data identifying one or more timestamps, temporal indicators, or time-indexed attributes associated with the security incident. In such embodiments, the prompt context segment may include, but is not limited to, a security alert detection timestamp, one or more event occurrence timestamps obtained from investigation workflow outputs, one or more authentication timestamps, one or more process execution timestamps, one or more network communication timestamps, and one or more remediation action timestamps associated with the security incident.

Additionally, or alternatively, the prompt context segment may include one or more extracted timeline milestone values obtained from the alert-to-fix timeline region of the security incident reporting artifact. In such embodiments, the extracted timeline milestone values may include timestamps corresponding to alert ingestion, investigation initiation, security incident creation, remediation action initiation, remediation action completion, and elapsed time values computed between such milestones. In an embodiment, the prompt context segment may further include structured temporal metadata identifying relative ordering of events, temporal gaps between events, and concurrency or overlap of events associated with the security incident.

In one implementation, the prompt instruction segment of the incident temporal analysis prompt may implement chain-of-thought prompting that programmatically defines an ordered reasoning procedure for deriving a temporal analysis output grounded in the prompt context segment. In such implementation, the ordered reasoning procedure may include a sequence of intermediate reasoning directives that require the one or more machine learning models to identify an earliest known activity timestamp associated with the security incident, identify one or more subsequent activity timestamps associated with escalation or progression of the incident, and determine one or more temporal relationships between detected activities.

In one or more embodiments, the chain-of-thought prompting may further require the one or more machine learning models to distinguish between detection time, activity occurrence time, and response time, and to synthesize a temporal analysis output that characterizes when activity likely began, how long the activity persisted, and when the activity was detected by the system. In such embodiments, the chain-of-thought prompting may constrain the output to temporal descriptors supported by explicit timestamps or milestone data included in the prompt context segment and may prohibit inference of temporal causality beyond the available investigation finding data.

In one non-limiting example, the chain-of-thought prompting may require a model-executed reasoning sequence comprising: (i) identifying a first observed activity timestamp associated with a security alert signal, (ii) identifying one or more subsequent investigation workflow timestamps indicating continued or escalated activity, (iii) identifying a timestamp corresponding to creation of the security incident, and (iv) generating a temporal analysis output describing an estimated dwell time or duration of suspicious activity prior to detection. In such example, if the prompt context segment includes authentication log timestamps indicating anomalous access activity occurring several hours prior to alert detection, the chain-of-thought prompting may guide the one or more machine learning models to generate an output indicating that suspicious activity likely began prior to detection and persisted for a defined temporal interval.

In another non-limiting example, if the prompt context segment includes multiple timeline milestone values indicating rapid progression from alert ingestion to remediation action execution, the chain-of-thought prompting may guide generation of an incident temporal analysis output indicating near-real-time detection and response. In such embodiments, the temporal analysis output may characterize responsiveness of the system without asserting causality or attacker intent.

In one or more embodiments, the chain-of-thought prompting implemented by the prompt instruction segment may further include one or more validation directives that require the one or more machine learning models to verify that each asserted temporal element in the output corresponds to an explicit timestamp, milestone value, or investigation workflow output included in the prompt context segment. In such embodiments, the validation directives may require omission of any temporal assertion that cannot be supported by the prompt context segment, thereby reducing speculative or unsupported temporal conclusions.

In another implementation, the prompt instruction segment may further include few-shot prompting examples that demonstrate standardized temporal analysis outputs. In such implementation, the few-shot prompting examples may comprise one or more exemplar prompt input and output pairs, wherein each exemplar prompt input includes a representative set of temporal investigation finding data fields and each exemplar output includes a corresponding standardized temporal analysis statement formatted according to a predefined temporal analysis schema.

In one non-limiting example, a first few-shot prompting example may include an exemplar prompt input corresponding to a malware-type incident, wherein the exemplar prompt input includes an initial execution timestamp, a detection timestamp, and a remediation timestamp. In such an example, the exemplar prompt output may include a standardized temporal analysis output describing elapsed time between execution and detection and elapsed time between detection and remediation. In another non-limiting example, a second few-shot prompting example may include an exemplar prompt input corresponding to an unauthorized access incident, wherein the exemplar prompt input includes multiple authentication timestamps over a defined period. In such an example, the exemplar prompt output may include a standardized temporal analysis output, for example, describing a multi-hour access window preceding detection.

In one or more embodiments, the prompt instruction segment may combine the chain-of-thought prompting and the few-shot prompting examples by positioning the few-shot prompting examples as a temporal formatting and output boundary reference and positioning the chain-of-thought prompting as a reasoning procedure for selecting, ordering, and summarizing temporal elements from the prompt context segment. In such embodiments, the incident temporal analysis prompt may cause the one or more machine learning models to generate temporal investigation finding data that may be consistent across security incidents, grounded in investigation finding data, and constrained to the incident temporal investigation category without introducing remediation recommendations or non-temporal investigative categories.

### Incident Causality Analysis Prompt

In one or more embodiments, S240 may function to automatically create an incident causality analysis prompt of the one or more security incident finding prompts. The incident causality analysis prompt may be configured to control, when used as an input to one or more machine learning models, the generation of investigation finding data describing one or more causal relationships between observed activity associated with the security incident and one or more preceding system events, configurations, or conditions identified during investigation. In such embodiments, the incident causality analysis prompt may be generated as a structured prompt object comprising a prompt context segment and a prompt instruction segment. In an implementation, the structured prompt object may be configured to constrain an output of the one or more machine learning models to a causality analysis scope associated with an incident causality investigation category.

In one or more embodiments, the prompt context segment of the incident causality analysis prompt may include investigation finding data identifying one or more triggering events, precursor activities, system state changes, configuration conditions, and/or security-relevant transitions that occurred prior to, or contemporaneously, with activity associated with the security incident. In such embodiments, the prompt context segment may include, but is not limited to, authentication events, process execution events, privilege changes, policy evaluation outcomes, network connection initiations, configuration modifications, or cloud resource state changes obtained from one or more automated investigation workflows.

Additionally, or alternatively, the prompt context segment may include one or more correlated investigation workflow outputs that explicitly associate a security alert with a sequence of prior events. In such embodiments, the prompt context segment may further include alert metadata, threat classification labels, affected identity identifiers, affected computing resource identifiers, and event correlation identifiers produced by the investigations engine 120 during automated investigation of the security incident.

In one implementation, the prompt instruction segment of the incident causality analysis prompt may implement chain-of-thought prompting that programmatically defines an ordered reasoning procedure for deriving a causality analysis output grounded in the prompt context segment. In such implementations, the ordered reasoning procedure may include a sequence of intermediate reasoning directives that require the one or more machine learning models to identify one or more candidate precursor events that temporally precede the detected security incident activity and to evaluate whether such precursor events exhibit a logical or rule-based relationship to the observed activity corresponding to the security event.

In one or more embodiments, the chain-of-thought prompting may further require the one or more machine learning models to distinguish between initiating events, enabling conditions, and consequential effects associated with the security incident. In such embodiments, the ordered reasoning procedure may require classification of precursor events into categories such as initiating trigger events, contributing configuration conditions, or facilitating access conditions, while explicitly prohibiting attribution of attacker intent, motivation, or human decision-making beyond the investigation finding data.

In one non-limiting example, the chain-of-thought prompting may require a model-executed reasoning sequence comprising: (i) identifying a security alert classification label indicating suspicious login activity, (ii) identifying one or more authentication events preceding the security alert that involve a new geographic location or device fingerprint, (iii) identifying a privilege scope associated with the affected identity, and (iv) generating a causality analysis output describing that the security incident activity is causally associated with a prior anomalous authentication event involving the affected identity and a subsequent access to protected resources. In such an example, the causality analysis output may describe a machine-inferred causal relationship without asserting malicious intent or human decision-making.

In one or more embodiments, the chain-of-thought prompting implemented by the prompt instruction segment may further include one or more validation directives that require the one or more machine learning models to confirm that each asserted causal relationship is supported by explicit investigation finding data included in the prompt context segment. In such embodiments, the validation directives may require omission of any causal assertion that cannot be directly supported by correlated event data, investigation workflow outputs, or system-recorded state transitions, thereby reducing speculative or unsupported causal conclusions.

In another implementation, the prompt instruction segment may further include few-shot prompting examples that demonstrate standardized causality analysis outputs. In such implementation, the few-shot prompting examples may comprise one or more exemplar prompt input and output pairs, wherein each exemplar prompt input includes a representative set of precursor events and investigation finding data fields and each exemplar prompt output includes a corresponding standardized causality analysis statement formatted according to a predefined causality analysis schema.

In one non-limiting example, a first few-shot prompting example may include an exemplar prompt input corresponding to an unauthorized access incident type, wherein the exemplar prompt input includes anomalous authentication events, device fingerprint changes, and access log entries. In such an example, the exemplar prompt output may include a standardized causality analysis output describing that the unauthorized access activity was preceded by anomalous authentication behavior associated with the affected identity.

In one or more embodiments, the prompt instruction segment may combine the chain-of-thought prompting and the few-shot prompting examples by positioning the few-shot prompting examples as a causality formatting and content boundary reference and positioning the chain-of-thought prompting as a reasoning procedure for selecting, validating, and expressing causal relationships grounded in investigation finding data. In such embodiments, the incident causality analysis prompt may cause the one or more machine-learning models to generate causality-focused investigation finding data that is consistent across security incidents, grounded in investigation finding data, constrained to the incident causality investigation category, and free of speculative attribution or unsupported conclusions.

In one or more embodiments, other prompts not discussed herein may also be automatically generated in a manner described in the foregoing. Construction of such prompts is herein contemplated.

Accordingly, S240 may provide at least one technical advantage by programmatically constructing structured security incident finding prompts in real time in response to detected user interactions with the security incident reporting artifact, thereby enabling controlled, context-aware execution of one or more machine learning models using investigation finding data already maintained by the system. By generating prompts that include explicitly defined prompt context segments and prompt instruction segments, S240 may enable constraining model execution to investigation categories associated with the security incident and enforce grounding of generated outputs in validated investigation finding data, alert-to-fix timeline data, and remediation actions data. This prompt-based control mechanism may reduce generation of unsupported or speculative outputs, improve determinism and consistency of model-generated investigation finding data, and enable the system to reuse investigation finding data across multiple analytical perspectives without re-running investigation workflows. S240 may therefore improve the technical reliability and interpretability of machine learning model execution within the cybersecurity system by transforming free-form model invocation into a structured, event-driven, and artifact-aware prompting process that is tightly integrated with incident-level data structures.

### 2.50 Providing the One or More Security Incident Finding Prompts as Input to One or More Machine Learning Models

S250, which includes providing the one or more security incident finding prompts as input to one or more machine learning models, may function to programmatically transmit, deliver, or otherwise make available the one or more security incident finding prompts generated in S240 to one or more machine learning models for execution. In an embodiment, S250 may function to provide the one or more security incident finding prompts as structured machine-readable prompt objects that are configured to control generation of investigation finding data corresponding to one or more investigation categories associated with a security incident reporting artifact.

In one or more embodiments, the one or more security incident finding prompts may be provided to the one or more machine learning models via one or more application programming interfaces (APIs), internal service calls, model execution endpoints, or inference request mechanisms implemented by the system 100. In such embodiments, S250 may function to encapsulate each security incident finding prompt together with associated prompt context data and prompt instruction data into a model invocation request that is consumable by the one or more machine learning models. As shown by way of example in FIG. 4, the artifact generator 420 may provide the security incident finding prompts to the one or more machine learning models.

In one or more embodiments, the one or more machine learning models may include one or more large language models, natural language generation models, transformer-based models, sequence-to-sequence models, generative artificial intelligence models, or other machine learning models configured to generate structured or semi-structured investigation finding data in response to a prompt input. In such embodiments, S250 may function to select a target machine learning model from among a plurality of available machine learning models based on one or more characteristics of the security incident, the investigation category associated with the security incident finding prompt, a desired output format, and/or a predefined model routing policy.

In one or more embodiments, providing the one or more security incident finding prompts as input to the one or more machine learning models may include transmitting the prompt context segment and the prompt instruction segment together as a single composite prompt input. In such embodiments, the prompt context segment may provide investigation finding data, alert-to-fix timeline data, remediation actions data, and other contextual data associated with the security incident reporting artifact, while the prompt instruction segment may define constraints, reasoning directives, output schemas, or formatting rules that control generation of investigation finding data by the one or more machine learning models.

In one or more embodiments, S250 may function to provide multiple security incident finding prompts to the one or more machine learning models in parallel, sequentially, or in a staged execution manner. In such embodiments, a first security incident finding prompt corresponding to a first investigation category may be provided to a machine learning model to generate a first portion of investigation finding data, and a second security incident finding prompt corresponding to a second investigation category may be subsequently provided to the same or a different machine learning model to generate a second portion of investigation finding data. In other embodiments, multiple security incident finding prompts corresponding to distinct investigation categories may be concurrently provided to one or more machine learning models for parallel generation of investigation finding data.

In one or more embodiments, S250 may function to include one or more control parameters with each security incident finding prompt provided to the one or more machine learning models. Such control parameters may include, but should not be limited to, output length constraints, response format constraints, confidence thresholds, determinism parameters, randomness parameters, temperature values, or decoding strategy identifiers. In such embodiments, the control parameters may further constrain generation of investigation finding data to ensure consistency, reproducibility, and adherence to predefined investigation category schemas.

In one or more embodiments, providing the one or more security incident finding prompts as input to the one or more machine learning models may further include associating each prompt invocation with one or more identifiers corresponding to the security incident reporting artifact, the security incident, and the investigation category. In such embodiments, the identifiers may enable downstream correlation of machine learning model outputs with specific regions of the security incident reporting artifact and may support traceability of generated investigation finding data to the corresponding prompt inputs.

In one or more embodiments, S250 may function to provide the one or more security incident finding prompts to the one or more machine learning models in real time or near real time in response to detecting a user input corresponding to a control button displayed on the security incident reporting artifact, as shown by way of example in FIGS. 5 and 5A. In such embodiments, S250 may function to initiate model execution contemporaneously with user interaction, thereby enabling generation of investigation finding data while the security incident reporting artifact remains active and accessible within a dynamic digitally accessible interface.

In one or more embodiments, S250 may function as a controlled model invocation step that bridges generation of structured prompt objects in S240 with downstream generation of investigation finding data by the one or more machine learning models. Accordingly, S250 may enable the system 100 to leverage machine learning-based reasoning and language generation capabilities to produce investigation finding data that is grounded in investigation finding data, alert-to-fix timeline data, remediation actions data, and other contextual information maintained by the security incident reporting artifact.

### 2.60 Obtaining a Corpus of Investigation Finding Data Outputted by the One or More Machine-Learning Models

S260, which includes obtaining a corpus of investigation finding data (e.g., security incident explanation, etc.) outputted by the one or more machine learning models, may function to receive, collect, aggregate, and persist machine-generated investigation findings data produced by execution of the one or more machine learning models in response to the one or more security incident finding prompts provided in S250. In one or more embodiments, S260 may function to obtain a corpus of investigation finding data that comprises multiple distinct machine-generated outputs, each output corresponding to a respective investigation category associated with the security incident reporting artifact.

In one or more embodiments, the corpus of investigation finding data may comprise one or more text strings, one or more structured text blocks, one or more graphical elements, or a combination thereof, that are generated by the one or more machine learning models in response to the security incident finding prompts. In such embodiments, each element of the corpus of investigation finding data may be logically associated with a security incident identifier, a security alert identifier, an investigation category identifier, and/or a section identifier of the security incident reporting artifact.

In one or more embodiments, S260 may function to store the corpus of investigation finding data in one or more computer-readable data stores implemented by the system 100. In such embodiments, the corpus of investigation finding data may be indexed, stored, and retrievable based on one or more identifiers including, but not limited to, an alert identifier, an incident identifier, a subscriber identifier, a timestamp, and an investigation category identifier. Accordingly, the corpus of investigation finding data may be persistently maintained by the system 100 as a machine-generated evidentiary record associated with the security incident.

### Configuring the One or More Machine Learning Models | Training Data Curation

In one or more embodiments, the system or service implementing the method 200 may function to configure the one or more machine learning models based on one or more corpora of training data. That is, in one or more embodiments, the system or service implementing the method 200 may function to curate one or more corpora of training data samples and train the one or more machine learning models using the one or more corpora of curated training data.

In one or more embodiments, the one or more machine learning models may include one or more generative language models configured to generate investigation findings data (e.g., security incident explanation, etc.) responsive to the one or more security incident finding prompts. In such embodiments, the one or more generative language models may include one or more transformer-based neural network language models configured to accept, as input, a structured prompt object comprising a prompt context segment and a prompt instruction segment and output one or more text strings that conform to an investigation category scope associated with a security incident reporting artifact.

Additionally, or alternatively, in one or more embodiments, the one or more machine learning models may include one or more retrieval augmented generation models configured to generate investigation findings data based on a combination of (i) prompt-provided investigation findings data and (ii) retrieved investigation evidence sourced from one or more investigation data repositories accessible to the system 100. In such embodiments, the retrieval augmented generation models may include a retrieval subsystem configured to query a corpus of investigation records using one or more identifiers associated with a security incident and a generation subsystem configured to generate investigation findings data grounded in retrieved investigation evidence.

Additionally, or alternatively, in one or more embodiments, the one or more machine learning models may include one or more classification models configured to compute one or more incident type predictions, threat type predictions, or investigation category routing predictions used to constrain generation of investigation findings data. In such embodiments, the one or more classification models may include one or more supervised learning models including logistic regression models, gradient boosted decision tree models, support vector machine models, or neural network classification models configured to output one or more classification labels that are included in the prompt context segment of a security incident finding prompt.

Additionally, or alternatively, in one or more embodiments, the one or more machine learning models may include one or more information extraction models configured to identify, extract, and normalize structured investigation attributes from security alert records, investigation workflow outputs, timeline milestone data, and remediation actions data. In such embodiments, the one or more information extraction models may include named entity recognition models, sequence labeling models, and structured field extraction models configured to extract affected identity identifiers, host identifiers, network address identifiers, vendor alert names, timestamps, and other investigation-relevant entities for inclusion in the prompt context segment.

In one or more embodiments, the one or more corpora of training data samples may be constructed based on sourcing a plurality of historical security alerts, historical security incidents, and historical investigation artifacts from one or more cybersecurity investigation findings databases. In such embodiments, each of the one or more corpora of training data samples may include a plurality of training data samples in which each distinct training data sample includes a training sample pairing comprising (i) an incident context input and (ii) a target investigation findings output that is labeled or otherwise associated with an investigation category identifier.

In one or more embodiments, the incident context input of a training sample pairing may include a structured representation of at least a subset of a security alert record, a subset of investigation workflow outputs, a subset of alert-to-fix timeline milestone values, and a subset of remediation actions data entries. In such embodiments, the target investigation findings output of the training sample pairing may include one or more text strings or structured text blocks that correspond to a specific investigation category, including an incident characterization investigation category, a spatial impact investigation category, a temporal analysis investigation category, or a causality analysis investigation category.

For instance, in a non-limiting example, one of the training data samples included in one of the one or more corpora of training data samples may include a training sample pairing comprising (i) an incident context input that includes a vendor alert name indicating malware detection, a host identifier, and a suspect account identifier and (ii) a target investigation findings output labeled to the incident characterization investigation category and describing activity consistent with malware execution involving the host identifier and associated with the suspect account identifier.

Additionally, or alternatively, in another non-limiting example, one of the training data samples included in one of the one or more corpora of training data samples may include a training sample pairing comprising (i) an incident context input that includes an alert classification label indicating suspicious login activity, an affected identity identifier, an anomalous authentication timestamp, and a network address identifier and (ii) a target investigation findings output labeled to the spatial impact investigation category and identifying one or more affected identity resources and one or more affected network or computing environment segments implicated in the suspicious login activity.

Additionally, or alternatively, in another non-limiting example, one of the training data samples included in one of the one or more corpora of training data samples may include a training sample pairing comprising (i) an incident context input that includes a plurality of alert-to-fix timeline milestone values identifying an alert ingestion timestamp and an incident creation timestamp and (ii) a target investigation findings output labeled to the temporal analysis investigation category and describing when the activity associated with the incident likely began relative to the alert ingestion timestamp and the incident creation timestamp.

Additionally, or alternatively, in another non-limiting example, one of the training data samples included in one of the one or more corpora of training data samples may include a training sample pairing comprising (i) an incident context input that includes a sequence of investigation workflow outputs indicating an initial access mechanism and subsequent activity steps and (ii) a target investigation findings output labeled to the causality analysis investigation category and describing a bounded causality narrative grounded in the sequence of investigation workflow outputs while excluding unsupported causal assertions.

Additionally, or alternatively, in one or more embodiments, the one or more corpora of training data samples may further include prompt training samples configured to teach the one or more machine learning models adherence to a prompt instruction segment that implements chain-of-thought prompting and few-shot prompting. In such embodiments, a subset of training samples may include exemplar prompt context segments paired with exemplar prompt instruction segments and exemplar target outputs that conform to a predefined investigation findings schema, thereby training the one or more machine learning models to generate investigation findings data that follows standardized phrasing conventions, standardized ordering rules, and standardized inclusion and exclusion rules.

Accordingly, in one or more embodiments, the system or service implementing the method 200 may function to train, fine-tune, or otherwise configure the one or more machine learning models based on the one or more curated corpora of training data samples. It shall be noted that, in response to or based on such training, the one or more machine learning models may be configured with learnable parameters that encode associations between incident context inputs and investigation category-scoped outputs, thereby enabling controlled generation of investigation findings data responsive to the one or more security incident finding prompts.

### Implementing the One or More Machine Learning Models

In one or more embodiments, the system 100 implementing the method 200 may function to implement the one or more machine learning models as one or more executable model services that are operably coupled to the investigations engine 120, the artifact generator 420, and one or more data storage components of the system 100. In such embodiments, the one or more machine learning models may be deployed as software-based model instances executing on one or more processors and utilizing one or more memory devices of the system 100, thereby enabling programmatic invocation of the one or more machine learning models during investigation and response operations associated with a security incident.

In one or more embodiments, implementing the one or more machine learning models may include provisioning one or more model execution environments within the system 100. The one or more model execution environments may comprise containerized runtime environments, virtualized execution environments, or managed machine learning inference services that are configured to load trained model parameters, receive structured prompt inputs, and generate machine learning-based outputs. In such embodiments, each model execution environment may be configured with defined input interfaces for receiving the one or more security incident finding prompts generated in S240 and defined output interfaces for emitting investigation findings data generated by the one or more machine learning models.

In one or more embodiments, the one or more machine learning models may be implemented as a plurality of distinct model components that are each specialized for a corresponding investigation category. For example, a first machine learning model may be configured to generate investigation findings data for an incident characterization investigation category, a second machine learning model may be configured to generate investigation findings data for an incident temporal analysis investigation category, a third machine learning model may be configured to generate investigation findings data for an incident localization investigation category, and a fourth machine learning model may be configured to generate investigation findings data for an incident causality analysis investigation category. In such embodiments, the system 100 may maintain a model routing configuration that maps each investigation category to a corresponding machine learning model or set of machine learning models.

In one or more embodiments, implementing the one or more machine learning models may further include integrating the machine learning models with one or more system-level orchestration components. In such embodiments, the investigations engine 120 and/or a dedicated prompt execution controller may function to orchestrate invocation of the one or more machine learning models by selecting an appropriate machine learning model based on an investigation category associated with a security incident finding prompt, transmitting the structured prompt object to the selected machine learning model, and receiving the generated investigation findings data output by the machine learning model. In such embodiments, orchestration logic may further enforce execution ordering, concurrency constraints, and dependency relationships among multiple machine learning model invocations.

In one or more embodiments, the one or more machine learning models may be implemented to execute in a stateless inference mode, wherein each invocation of a machine learning model is performed independently based on a provided structured prompt object and without reliance on persistent conversational state. In such embodiments, the structured prompt objects generated in S240 may fully define the scope, constraints, and context required for generation of investigation findings data, thereby enabling deterministic, repeatable, and auditable inference behavior. In alternative embodiments, one or more of the machine learning models may be implemented in a limited stateful inference mode, wherein intermediate inference metadata may be cached or reused across related prompt invocations associated with a single security incident identifier.

In one or more embodiments, implementing the one or more machine learning models may further include configuring one or more access control policies, execution constraints, and resource limits associated with model invocation. For example, the system 100 may enforce maximum token limits, maximum response length constraints, execution timeout thresholds, or concurrency limits for each machine learning model invocation. In such embodiments, such constraints may be configured to ensure predictable system performance, bounded computational resource usage, and consistent generation of investigation findings data across security incidents.

In one or more embodiments, the one or more machine learning models may be implemented to operate in communication with one or more internal data services of the system 100. For example, during inference execution, a machine learning model may access a system-accessible cache or datastore containing normalized investigation findings data, security alert metadata, alert-to-fix timeline milestone values, or remediation actions data that have been previously stored by the system 100. In such embodiments, such data access may occur indirectly through inclusion of the data in the prompt context segment of the structured prompt object, rather than through unrestricted external retrieval, thereby preserving controlled grounding of model outputs.

In one or more embodiments, implementing the one or more machine learning models may further include logging, auditing, and traceability mechanisms that associate each model invocation with a corresponding security incident identifier, investigation category identifier, and prompt identifier. In such embodiments, the system 100 may store metadata describing which machine learning model was invoked, which structured prompt object was used as input, and which investigation findings data was produced as output. Such metadata may be used to support auditability, reproducibility, and downstream validation of investigation findings data generated by the one or more machine learning models.

In one or more embodiments, the implemented one or more machine learning models may be continuously available for invocation during ongoing investigation and response operations. Accordingly, the system 100 may implement the one or more machine learning models as integral computational components of the cybersecurity event detection and response service, thereby enabling real-time or near-real-time generation of investigation findings data in response to user interactions with the security incident reporting artifact and system-detected investigation events.

### Computing Machine Learning-Based Inferences

In one or more embodiments, the system 100 implementing the method 200 may function to compute machine learning-based inferences by providing the one or more security incident finding prompts generated in S240 as structured inputs to the one or more machine learning models implemented by the system 100. In such embodiments, each security incident finding prompt may be associated with a distinct investigation category and may be configured to cause the one or more machine learning models to generate investigation findings data (e.g., security incident explanation, etc.) that is scoped, constrained, and semantically aligned with the corresponding investigation category.

In one or more embodiments, computing the machine learning-based inferences may include executing the one or more machine learning models independently for each investigation category associated with a security incident. In such embodiments, the system 100 may invoke the one or more machine learning models using a first security incident finding prompt corresponding to an incident characterization investigation category, a second security incident finding prompt corresponding to an incident location investigation category, a third security incident finding prompt corresponding to an incident temporal analysis investigation category, and a fourth security incident finding prompt corresponding to an incident causality analysis investigation category. Each invocation may be performed using a distinct structured prompt object generated in S240 and may produce a corresponding investigation findings output.

In one or more embodiments, execution of the one or more machine learning models using the incident characterization prompt may result in generation of a first corpus of investigation findings data (e.g., first security incident explanation) that includes one or more text strings and/or one or more graphical elements answering an investigation category corresponding to identifying a classification, nature, or general type of activity associated with the security incident. In such embodiments, the first corpus of investigation findings data may include machine-generated descriptive statements, structured summaries, and/or visual indicators that explain what the security incident is, based on investigation findings data included in the prompt context segment of the incident characterization prompt.

In one or more embodiments, execution of the one or more machine learning models using the incident location analysis prompt may result in generation of a second corpus of investigation findings data (e.g., second security incident explanation) that includes one or more text strings and/or one or more graphical elements answering an investigation category corresponding to identifying where the security incident is occurring. In such embodiments, the second corpus of investigation findings data may include machine-generated descriptions identifying affected computing resources, network locations, identity resources, cloud environments, or other digital entities implicated in the security incident, grounded in investigation findings data included in the prompt context segment of the incident location analysis prompt.

In one or more embodiments, execution of the one or more machine learning models using the incident temporal analysis prompt may result in generation of a third corpus of investigation findings data (e.g., third security incident explanation) that includes one or more text strings and/or one or more graphical elements answering an investigation category corresponding to identifying when the security incident occurred or progressed. In such embodiments, the third corpus of investigation findings data may include machine-generated temporal narratives, timestamps, duration descriptors, or timeline-aligned explanations that describe when the activity associated with the security incident began, when the activity was detected, and or how the activity progressed over time, based on alert-to-fix timeline data and investigation findings data included in the prompt context segment of the incident temporal analysis prompt.

In one or more embodiments, execution of the one or more machine learning models using the incident causality analysis prompt may result in generation of a fourth corpus of investigation findings data (e.g., fourth security incident explanation) that includes one or more text strings and/or one or more graphical elements answering an investigation category corresponding to identifying how the security incident occurred. In such embodiments, the fourth corpus of investigation findings data may include machine-generated explanations describing causal sequences, contributing factors, or attack progression patterns inferred from correlated investigation workflow outputs, alert attributes, and remediation actions data included in the prompt context segment of the incident causality analysis prompt, while remaining constrained to supported investigation findings data.

In one or more embodiments, each corpus of investigation findings data generated by the one or more machine learning models may be maintained as a distinct logical collection of investigation findings outputs associated with a corresponding investigation category and a corresponding security incident identifier. In such embodiments, the system 100 may store each corpus of investigation findings data in one or more computer databases indexed by alert identifier, incident identifier, investigation category identifier, and or prompt identifier. Such storage may enable subsequent retrieval, display, update, and audit of investigation findings data generated by the one or more machine learning models.

In one or more embodiments, computing the machine learning-based inferences may further include associating each generated corpus of investigation findings data with a corresponding region of the security incident reporting artifact generated in S230. In such embodiments, the first corpus of investigation findings data may be associated with a findings section answering “what the security incident is”, the second corpus of investigation findings data may be associated with a findings section answering “where the security incident is”, the third corpus of investigation findings data may be associated with a findings section answering “when the security incident occurred”, and the fourth corpus of investigation findings data may be associated with a findings section answering “how the security incident occurred”. Accordingly, each corpus of investigation findings data may be logically and visually mapped to a predefined region of the security incident reporting artifact.

In one or more embodiments, computing the machine learning-based inferences may be performed in real time or near real time in response to detection of a user input corresponding to the security incident reporting artifact or in response to system-detected investigation events. In such embodiments, the system 100 may compute and update the corpora of investigation findings data dynamically as additional investigation findings data, alert-to-fix timeline data, or remediation actions data becomes available, thereby enabling continuous refinement of investigation findings outputs throughout an investigation lifecycle.

In one or more embodiments, the separation of machine learning-based inferences into multiple investigation category-specific corpora of investigation findings data may enable controlled, explainable, and modular generation of investigation findings. In such embodiments, each corpus of investigation findings data may be independently regenerated, validated, or replaced without requiring regeneration of other corpora, thereby improving system scalability, interpretability, and consistency of investigation findings outputs across distinct security incidents.

As shown in one non-limiting example in FIG. 4, the artifact generator 420 obtains the corpus of investigation finding data outputted by the one or more machine learning models. In an embodiment, the artifact generator 420 may receive the corpus of investigation finding data through one or more programmatic interfaces exposed by a machine learning inference service operating within or in communication with the system 100. In one or more embodiments, the artifact generator 420 may function to transmit the one or more security incident finding prompts generated in S240 to the one or more machine learning models using one or more API calls, remote procedure calls, message queue submissions, or other machine-to-machine invocation mechanisms. In such embodiments, each invocation may include a structured request payload comprising a prompt identifier, a security incident identifier, an investigation category identifier, a prompt context segment, and a prompt instruction segment, thereby enabling the one or more machine learning models to execute inference operations scoped to a specific investigation category.

As described briefly, the one or more machine learning models may be implemented as a local inference service executed by the system 100, a containerized model execution environment, or a remote machine learning service accessible over a network interface. In such embodiments, the artifact generator 420 may function to authenticate with the machine learning service, serialize the structured prompt object into a machine-readable format, and transmit the serialized prompt object to the machine learning service for execution. The machine learning service may, in response, execute the one or more machine learning models using the structured prompt object and return a machine-generated inference response comprising investigation findings data corresponding to the investigation category associated with the prompt.

In one or more embodiments, the artifact generator 420 may function to receive the machine-generated inference response as a structured response payload that includes one or more text strings, one or more graphical descriptors, one or more metadata fields, and/or one or more confidence or provenance indicators associated with the generated investigation findings data. In such embodiments, the artifact generator 420 may parse the structured response payload to extract investigation findings data elements and associate the extracted elements with a corresponding security incident identifier and investigation category identifier. The artifact generator 420 may further validate the response payload by confirming that the investigation findings data conforms to expected schemas, length constraints, and investigation category boundaries defined by the structured prompt object.

In one or more embodiments, obtaining the corpus of investigation finding data may further include persisting the extracted investigation findings data in one or more system-accessible data stores. In such embodiments, the artifact generator 420 may function to store the corpus of investigation finding data in a computer database indexed by alert identifier, incident identifier, investigation category identifier, and or prompt identifier. Such storage may enable subsequent retrieval, update, comparison, and versioning of investigation findings data generated by the one or more machine learning models. In one or more embodiments, storing the corpus of investigation finding data may further include associating timestamps, model identifiers, and prompt identifiers with the stored data to support traceability and auditability of machine learning-generated investigation findings.

In one or more embodiments, the artifact generator 420 may function to obtain multiple distinct corpora of investigation finding data by issuing multiple independent inference requests to the one or more machine learning models, each request corresponding to a different investigation category. In such embodiments, the artifact generator 420 may manage asynchronous or parallel execution of inference requests and may aggregate the returned corpora of investigation finding data upon receipt.

Accordingly, obtaining of the corpus of investigation finding data may comprise a coordinated sequence of model invocation, response handling, validation, and persistence operations that collectively enable the system 100 to capture, store, and utilize investigation findings data outputted by the one or more machine learning models during investigation and response operations.

### 2.70 Automatically Populating or Updating, in Real Time, One or More Findings Data Sections of the Security Incident Reporting Artifact

S270, which includes automatically populating or updating, in real time, one or more findings data sections of the security incident reporting artifact, may function to programmatically insert, render, or revise, in real time or near real time, investigation findings data (e.g., one or more security incident explanations) outputted by the one or more machine learning models into one or more corresponding regions of the security incident reporting artifact generated in S230. In one or more embodiments, S270 may be executed in response to receipt of one or more corpora of investigation findings data obtained in S260 and may function to bind each corpus of investigation findings data to a predefined findings data section of the security incident reporting artifact.

In one or more embodiments, S270 may function to identify a target findings data section of the security incident reporting artifact based on an investigation category associated with a corresponding security incident finding prompt. In such embodiments, S270 may function to map each corpus of investigation findings data to a predefined findings data section using an investigation category identifier, a prompt identifier, or a section identifier associated with the security incident reporting artifact. S270 may thereby ensure that investigation findings data generated for a specific investigation category is populated only within a corresponding findings data section of the security incident reporting artifact.

In one or more embodiments, S270 may function to automatically populate an investigative summary findings data section of the security incident reporting artifact using a corpus of investigation findings data generated by one or more machine learning models in response to a summary-oriented security incident finding prompt. As illustrated in the non-limiting example of FIG. 5B, the investigative summary findings data section may be rendered as a distinct interface region labeled “Investigative summary” and may include multiple structured sub-elements populated entirely through automated processes.

In one or more embodiments, populating the investigative summary findings data section may include inserting investigation findings data identifying an earliest evidence timestamp and a most recent evidence timestamp associated with activity of the security incident. In the illustrated example, the investigative summary findings data section includes an earliest evidence value corresponding to a first observed timestamp and a most recent evidence value corresponding to a last observed timestamp, each derived from investigation findings data and alert-to-fix timeline data maintained by the system.

In one or more embodiments, S270 may further function to populate the investigative summary findings data section with investigation findings data identifying an extent of attacker footprint and impact. As shown in the illustrated example, such findings data may include a machine-generated natural language statement indicating a number of impacted computing resources, such as a natural language statement identifying that “2 devices were impacted” by activity associated with the security incident. In such embodiments, the impacted computing resources may be derived from investigation findings data identifying affected hosts, identity resources, or endpoint assets.

As further illustrated in the example, the investigative summary findings data section may be populated with investigation findings data identifying one or more tools used by an attacker and corresponding “MITRE ATT&CK” framework mappings. As shown, such findings data may include identification of specific executables or commands, such as “reg.exe” “powershell.exe,” and “WindowsPowerShell/v1.0/powershell.exe” and corresponding “MITRE ATT&CK” technique identifiers, such as technique identifiers associated with “credential dumping” and “command and scripting interpreter” activity. In such embodiments, the “MITRE ATT&CK mappings” may be derived from investigation workflow outputs and threat classification data included in the corpus of investigation findings data.

In one or more embodiments, S270 may further function to populate the investigative summary findings data section with investigation findings data identifying risk assessment information associated with the security incident. As shown in the illustrated example, such findings data may include a risk descriptor indicating a severity classification, such as a “high” risk assessment, and an explanatory natural language statement describing potential impact associated with the identified activity, such as potential exposure of credential data. In such embodiments, the explanatory natural language statement may be generated by the one or more machine learning models based solely on investigation findings data included in the prompt context segment and may be constrained to avoid speculative assertions.

In one or more embodiments, S270 may function to automatically format and render the populated investigation findings data within the investigative summary findings data section using a predefined layout and presentation schema. In such embodiments, the predefined layout may include bullet-style lists, label subsections, or grouped textual elements that present the investigation findings data in a structured and human-readable form while preserving machine-readable associations with the underlying security incident identifier.

In one or more embodiments, S270 may further function to update the investigative summary findings data section in real time in response to generation of revised or additional investigation findings data by the one or more machine learning models. In such embodiments, if subsequent prompt executions produce updated investigation findings data, the system may replace, append, or revise existing content within the investigative summary findings data section without requiring manual editing or user intervention.

In one or more embodiments, S270 may function to associate each populated findings data section with metadata identifying a generation timestamp, a source prompt identifier, and a model execution identifier. In such embodiments, the metadata may enable traceability of investigation findings data back to the corresponding prompt invocation and machine learning model execution, thereby supporting auditability and controlled updating of the security incident reporting artifact.

Accordingly, S270 may provide a technical advantage by enabling real-time, automated population and updating of findings data sections of a security incident reporting artifact using structured outputs generated by one or more machine learning models. By programmatically binding investigation findings data to predefined artifact regions based on investigation categories, the system ensures consistent placement, formatting, and updating of investigation findings data without manual transcription or analyst intervention. This automated population mechanism improves computational efficiency, reduces human error in incident reporting, and enables the security incident reporting artifact to function as a continuously updated, machine-maintained representation of investigation findings data throughout the lifecycle of a security incident.

In one or more embodiments, following automatic population or updating of the one or more findings data sections of the security incident reporting artifact in S270, the system 100 may further function to evaluate a corpus of investigation findings data generated by the one or more machine learning models. In such embodiments, the evaluation may be performed as a machine-executed post-population analysis to assess quality, completeness, correctness, and/or semantic fidelity of the investigation findings data independently of the population of the security incident reporting artifact.

In one or more embodiments, evaluation of the corpus of investigation findings data may be performed using one or more additional machine learning models distinct from the one or more machine learning models used to generate the investigation findings data. In such embodiments, the corpus of investigation findings data associated with a security incident identifier may be used to compute one or more evaluation outputs that characterize properties of the generated investigation findings data.

In one or more embodiments, the evaluation outputs may include computation of one or more derivative metrics that quantify structural and informational properties of the investigation findings data. Such derivative metrics may include, but are not limited to, metrics indicating an amount of investigation findings data utilized, a degree of redundancy or overlap across findings sections, syntactic validity metrics, formatting consistency metrics, and coverage metrics indicating whether each investigation category associated with the security incident reporting artifact has been addressed by corresponding investigation findings data.

Additionally, or alternatively, in one or more embodiments, the evaluation outputs may further include one or more semantic metrics that assess semantic similarity, semantic completeness, or semantic alignment of the investigation findings data relative to one or more reference datasets. In such embodiments, the semantic metrics may be computed using one or more semantic similarity models, including transformer-based language models configured to compute similarity scores between machine-generated investigation findings data and one or more reference investigation findings datasets. Non-limiting examples of such semantic metrics may include similarity metrics derived from contextual embedding models, sentence-level similarity scoring models, or sequence comparison models.

Additionally, or alternatively, in one or more embodiments, the evaluation process may implement a model-based judgment process in which the second set of machine learning models may be configured to evaluate the investigation findings data produced by the one or more machine learning models. In such embodiments, the second set of machine learning models may be provided with evaluation prompt inputs that include the generated investigation findings data and one or more evaluation criteria, and may output evaluation data indicating completeness, correctness, coherence, and adherence to predefined investigation schemas. In such embodiments, the second set of machine learning models may function as a system-executed model that evaluates investigation findings data without human intervention.

In one or more embodiments, evaluation outputs may be stored as evaluation data in association with the security incident identifier, the investigation category identifiers, and the corresponding investigation findings data. In such embodiments, the evaluation data may be used to generate aggregate evaluation metrics, confidence indicators, or quality scores associated with the investigation findings data populated within the security incident reporting artifact.

Additionally, or alternatively, in one or more embodiments, evaluation outputs produced may be used as feedback signals for modifying behavior of the one or more machine learning models used to generate investigation findings data. In such embodiments, the evaluation outputs may be used to adjust model parameters, prompt templates, prompt instruction segments, routing logic, or selection logic associated with the one or more machine learning models. In some embodiments, the evaluation outputs may further be combined with human feedback signals to implement reinforcement learning from human feedback, wherein model outputs that satisfy evaluation criteria are reinforced and model outputs that fail to satisfy evaluation criteria are penalized.

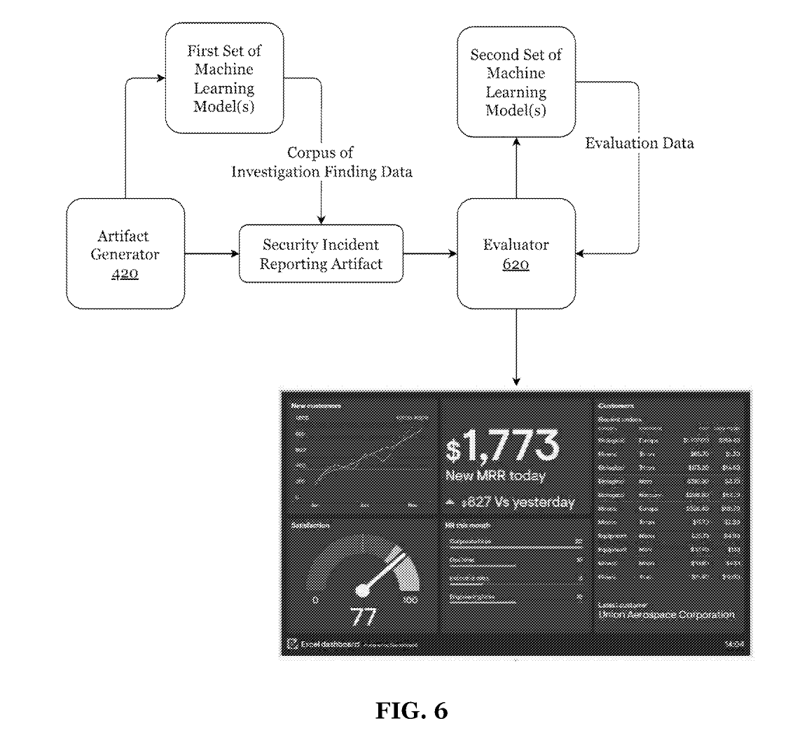

FIG. 6 illustrates one non-limiting example of an architecture for generating and evaluating investigation findings data associated with a security incident using multiple sets of machine learning models.

As illustrated in FIG. 6, the artifact generator 420 may be operably coupled to a first set of machine learning models. In one or more embodiments, the first set of machine learning models may include one or more large language models, multimodal machine learning models, or other machine-learning-based generative models configured to generate investigation findings data in response to one or more security incident finding prompts. In such embodiments, outputs of the first set of machine learning models may collectively form the corpus of investigation findings data that includes one or more machine-generated investigation outputs corresponding to distinct investigation categories of the security incident.

As described in the foregoing, the corpus of investigation findings data outputted by the first set of machine learning models may include one or more textual investigation findings, one or more structured data objects, and/or one or more graphical investigation findings. The artifact generator 420 may function to receive, store, and associate the corpus of investigation findings data with a corresponding security incident identifier and to populate or update one or more regions of a security incident reporting artifact using the corpus of investigation findings data.

As further illustrated in FIG. 6, the security incident findings artifact may be operably coupled to an evaluator 620. In one or more embodiments, the evaluator 620 may be implemented as a distinct system component configured to assess, score, or otherwise evaluate the corpus of investigation findings data generated by the first set of machine learning models. In such embodiments, the evaluator 620 may function to compute evaluation data associated with quality, completeness, correctness, or consistency of the investigation findings data.

In one or more embodiments, the evaluator 620 may be operably coupled to a second set of machine learning models distinct from the first set of machine learning models. The second set of machine learning models may include one or more evaluation-oriented large language models, semantic similarity models, metric computation models, or other machine-learning-based evaluation models. In such embodiments, the second set of machine learning models may be configured to generate evaluation data by processing the corpus of investigation findings data produced by the first set of machine learning models.

In one or more embodiments, the evaluation data generated by the second set of machine learning models may include derivative evaluation metrics, semantic evaluation metrics, and/or judgment-based evaluation outputs. For example, derivative evaluation metrics may include measurements of information density, redundancy, structural completeness, or syntactic validity of the investigation findings data. Semantic evaluation metrics may include similarity scores, alignment scores, or coherence scores comparing machine-generated investigation findings data to predefined investigation schemas or reference investigation outputs. Judgment-based evaluation outputs may include machine-generated assessments indicating whether investigation findings data satisfies predefined quality thresholds or investigation category constraints.

In one or more embodiments, the evaluator may function to aggregate evaluation data produced by the second set of machine learning models and generate one or more evaluator outputs. The evaluator outputs may include structured evaluation records, numeric scores, categorical ratings, or other machine-interpretable evaluation signals associated with the investigation findings data. In such embodiments, the evaluator outputs may be used to drive feedback mechanisms, adaptive prompt refinement, model selection, or presentation of evaluation results through a subscriber-facing interface.

As further illustrated in FIG. 6, evaluator outputs may be rendered or visualized through one or more dashboards or user interfaces that present evaluation data associated with investigation findings generation. In such embodiments, the displayed evaluation outputs may provide visibility into performance characteristics of the first set of machine learning models, the quality of the generated investigation findings data, and trends across multiple security incidents.

Accordingly, placement of the evaluation process after S270 may enable the system 100 to maintain real-time population of the security incident reporting artifact while independently executing quality assessment, semantic validation, and feedback-driven optimization of investigation findings data generation, thereby improving consistency, reliability, and technical performance of the security incident reporting workflow over time.

### Example Applications of System or Service Implementing Method 200

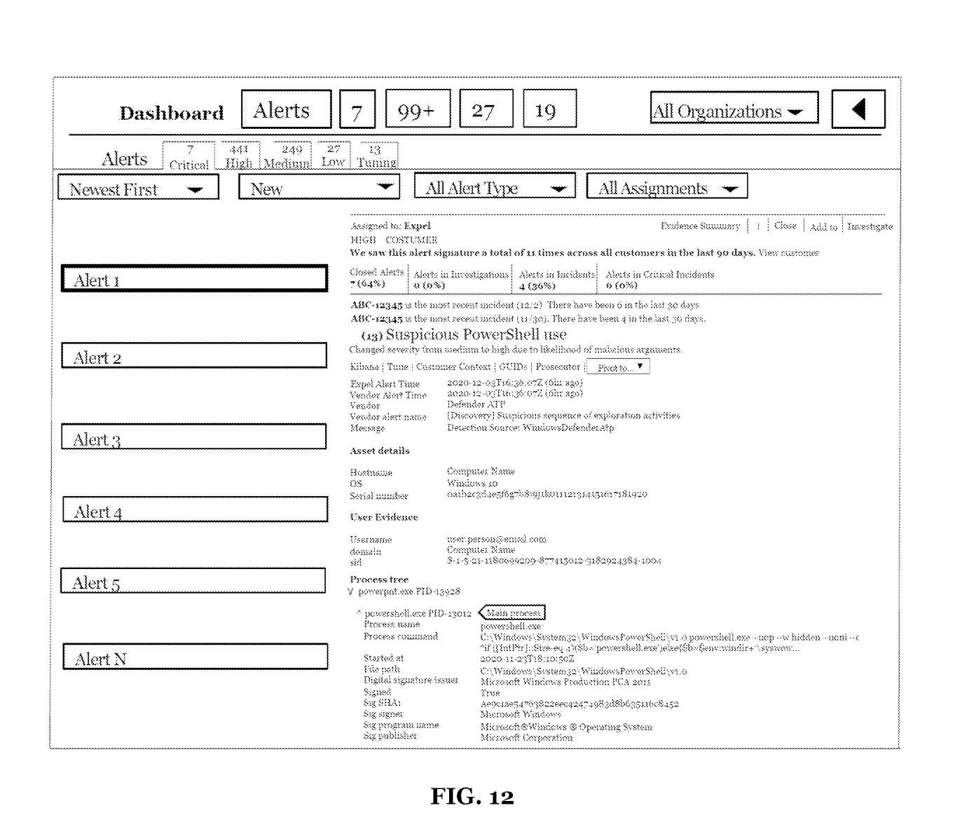

Turning to FIGS. 12 – 15, in one or more embodiments, an event detection and response service may function to display, via a graphical user interface, a security alert associated with a subscribing entity. In such an embodiment, the system or service implementing method 200 may function to receive, while the security alert is displayed on the graphical user interface, an input from the user selecting a security incident creation object (e.g., security incident creation button or the like). Accordingly, in one or more embodiments, in response to receiving the input selecting the security incident creation object, the event detection and response service may function to simultaneously, sequentially, or in parallel perform one or more operations in real-time or near real time. For instance, in a non-limiting example, the one or more operations may include (i) automatically escalating the security alert to a security incident, (ii) automatically generating, based in part on the security alert, a security incident artifact that corresponds to the security alert, (iii) automatically updating (or transitioning) the graphical user interface from displaying the security alert to displaying the security incident artifact corresponding to the security alert, and (iv) displaying a security incident explanation button on the graphical user interface while the graphical user interface is displaying the security incident artifact.

Additionally, or alternatively, in one or more embodiments, the event detection and response service may function to receive, from the user, an input selecting a security incident explanation button. In such an embodiment, in response to receiving the input from the user selecting the security incident explanation button, the event detection and response service may function to automatically create a security incident explanation prompt based at least on (i) alert metadata associated with, corresponding to, or included in the security alert and (ii) investigation findings data obtained from investigating the security alert. Additionally, in such embodiment, in response to receiving the input from the user selecting the security incident explanation button, the event detection and response service may further function to generate, using a large language model, a security incident explanation for the security incident based on providing the security incident explanation prompt to the large language model. Accordingly, in such an embodiment, the event detection and response service may function to adapt the security incident artifact to include the security incident explanation generated by the large language model and/or surface, using one or more processors, the security incident artifact comprising the security incident explanation to the subscribing entity.

At least one technical benefit of the embodiments described in FIGS. 12 - 15 includes reducing the number of user inputs and interface transitions required to escalate a security alert, generate a security incident explanation, and surface the security incident explanation within a security incident artifact. By consolidating escalation, artifact generation, prompt construction, large language model invocation, and graphical user interface updating into a coordinated sequence of automatically executed backend operations initiated by one or more discrete user inputs, the systems described herein reduce redundant navigation events, manual data compilation steps, and repeated rendering operations. Accordingly, such consolidation reduces processor cycles associated with user-driven interface updates, repeated database queries, and network communications between system components, thereby improving computational efficiency while accelerating end-to-end handling of security alerts, including incident creation, incident explanation generation, and remediation activities.

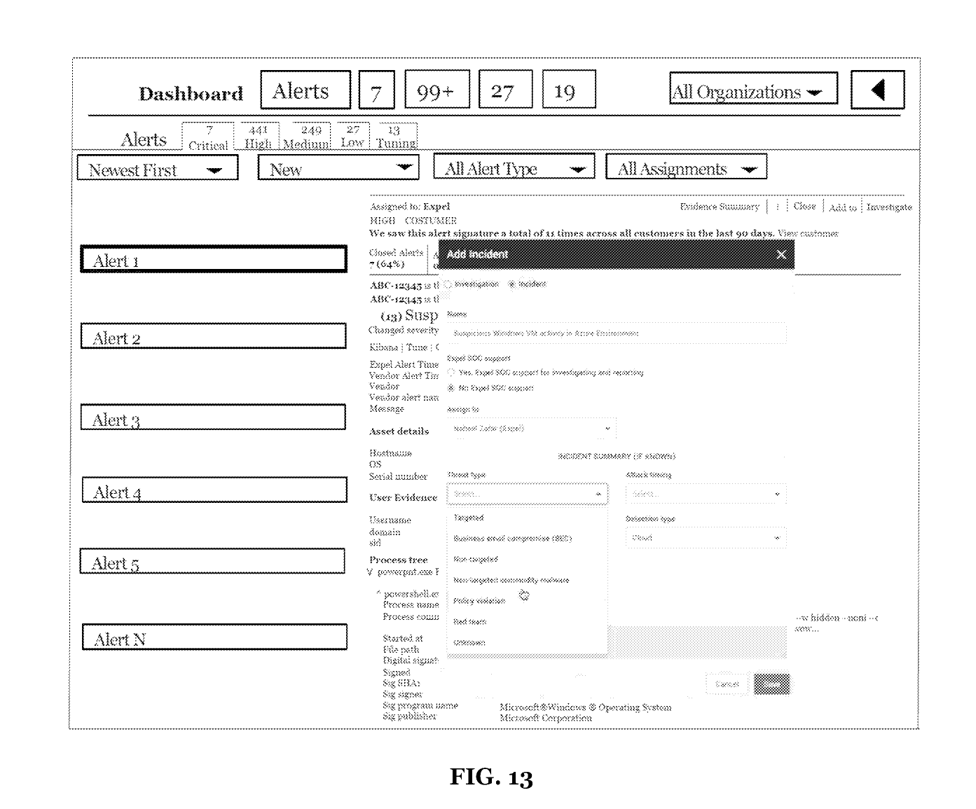

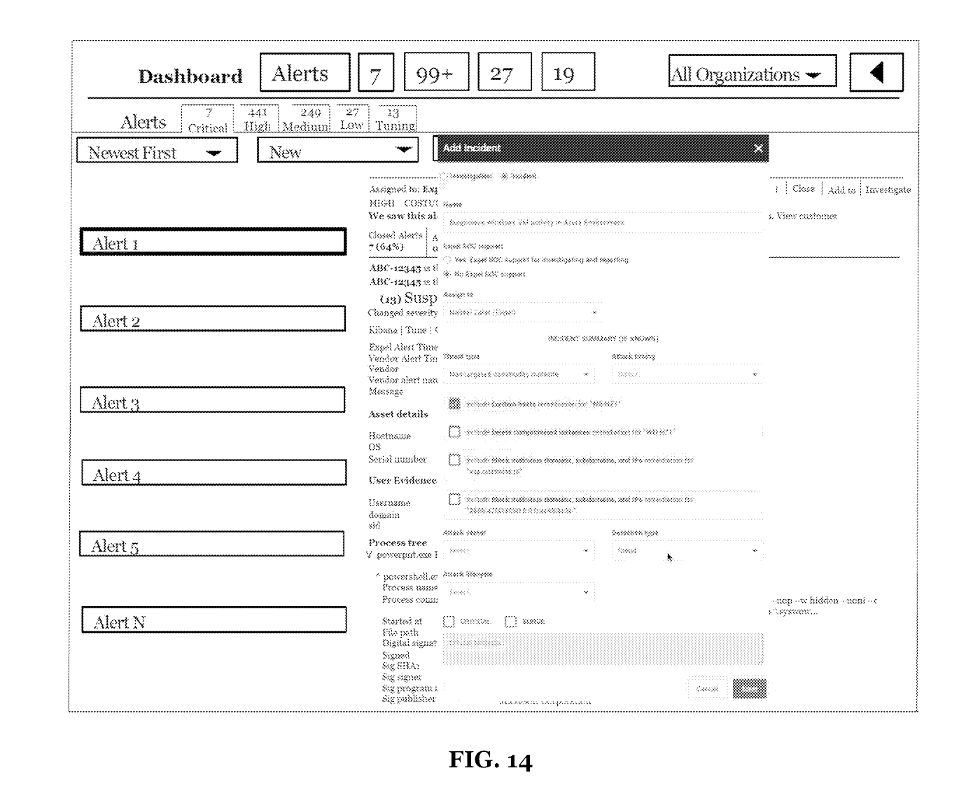

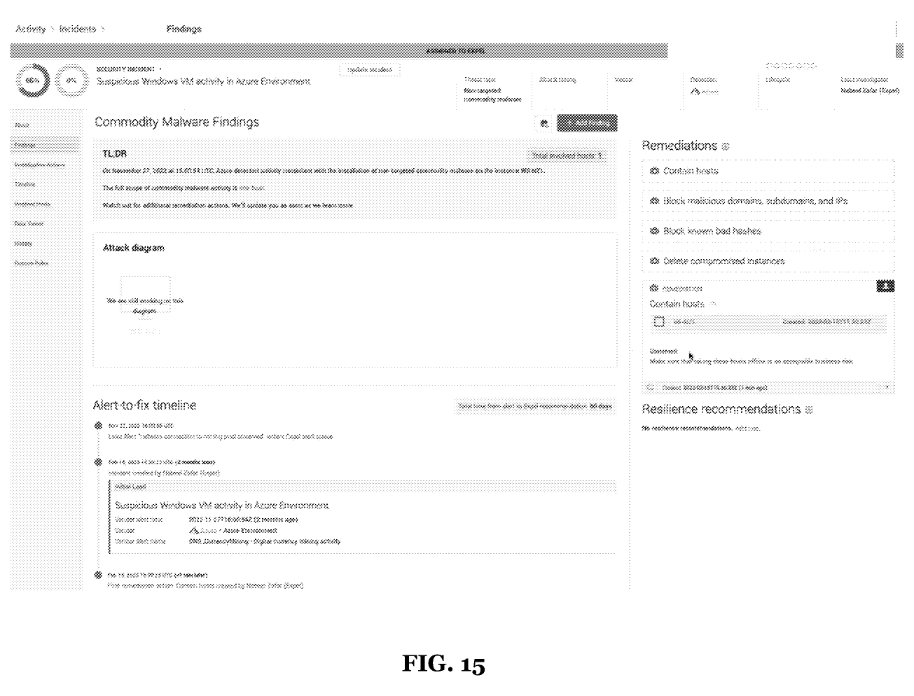

Additionally, in one or more embodiments, in response to receiving the input from the user selecting the security incident explanation button, the event detection and response service may function to automatically instantiate, before creating the security incident explanation prompt, an incident explanation user interface panel overlaying the security incident artifact displayed on the graphical user interface, as shown generally by way of example in FIGS. 13 and 14. Furthermore, in such an embodiment, in response to receiving the input from the user selecting the security incident explanation button, the event detection and response service may function to display, within the incident explanation user interface panel, a loading animation while the large language model is generating the security incident explanation for the security incident. Furthermore, in such an embodiment, in response to receiving the input from the user selecting the security incident explanation button, the event detection and response service may function to automatically render, within the incident explanation user interface panel, the security incident explanation generated for the security incident. Stated another way, a single user-initiated input may trigger dynamic instantiation of the incident explanation user interface panel, asynchronous generation of the security incident explanation by the large language model, and automatic updating of the graphical user interface to replace the loading animation with the generated security incident explanation upon completion, without requiring additional user interaction or navigation away from the security incident artifact. At least one technical benefit of such an embodiment includes maintaining continuity of the graphical user interface state while backend processing is performed, thereby reducing interface transitions, avoiding full-page reloads or view re-rendering events, and minimizing processor utilization associated with repeated graphical updates. Additionally, by eliminating the need for additional polling inputs or manual refresh actions while the security incident explanation is being generated, the systems described herein improve responsiveness of the graphical user interface and reduce unnecessary consumption of computing resources during explanation generation.

Additionally, in one or more embodiments, adapting the security incident artifact to include the security incident explanation may include one or more of writing the security incident explanation to a memory buffer in response to receiving an input from the user selecting a copy button displayed within the incident explanation user interface panel, receiving, via the graphical user interface, an input from the user selecting an adding finding button displayed within a findings section of the security incident artifact, instantiating a finding entry popover in response to receiving the input selecting the adding finding button, inserting the security incident explanation stored in the memory buffer into the finding entry popover, receiving a findings confirmation input from the user at the finding entry popover, and automatically adding the security incident explanation inserted into the finding entry popover into the findings section of the security incident artifact in response to receiving the findings confirmation input from the user.

Additionally, or alternatively, in one or more embodiments, the security incident explanation prompt automatically created by the event detection and response service may include a plurality of distinct instructions that specify one or more required output structures, content constraints, and data-assessment rules for the large language model.

For instance, in a non-limiting example, the security incident explanation prompt may include a first distinct instruction instructing the large language model to assess the alert metadata and the investigation findings data to determine a start time of malicious activity. Stated another way, the first distinct instruction may direct the large language model to assess temporal attributes included within the alert metadata and the investigation findings data to identify an earliest event indicative of malicious behavior and to incorporate the determined start time into the generated security incident explanation. At least one technical benefit of explicitly instructing the large language model to derive and reference the start time of malicious activity from the underlying security data (e.g., the alert metadata and the investigation findings data), the system described herein improves temporal accuracy and reduces the likelihood that the generated security incident explanation includes unsupported or imprecise timing information.

Additionally, in such a non-limiting example, the security incident explanation prompt may include a second distinct instruction instructing the large language model to assess the alert metadata and the investigation findings data to determine an end time of the malicious activity. Stated another way, the second distinct instruction may direct the large language model to analyze temporal attributes within the alert metadata and the investigation findings data to identify a most recent event associated with the malicious activity and to incorporate the determined end time into the generated security incident explanation. At least one technical benefit of explicitly instructing the large language model to derive and reference the end time of the malicious activity from the security data (e.g., the alert metadata and the investigation findings data) includes improving completeness of the generated security incident explanation and reducing the likelihood that the explanation omits temporal boundaries of the security incident.

Additionally, in such an embodiment, the security incident explanation prompt may include a third distinct instruction instructing the large language model to assess the alert metadata and the investigation findings data to determine a total number of distinct computing assets of the subscribing entity involved in the security incident. Stated another way, the third distinct instruction may direct the large language model to assess host identifiers, endpoint attributes, network addresses, account associations, or other asset-related fields within the alert metadata and the investigation findings data to identify and enumerate distinct computing assets impacted by or associated with the malicious activity, and to incorporate the determined total number of distinct computing assets into the generated security incident explanation. At least one technical benefit of explicitly instructing the large language model to derive and reference the total number of distinct computing assets from the underlying security data (e.g., the alert metadata and the investigation findings data) includes improving quantitative accuracy of the generated security incident explanation and reducing the likelihood that the security incident explanation overstates, understates, or ambiguously describes the scope of the security incident.

Additionally, in such an embodiment, the security incident explanation prompt may include a fourth distinct instruction instructing the large language model to assess the alert metadata and the investigation findings data to determine a plurality of distinct tools used by an attacker to perform the malicious activity. A tool, in some embodiments, may include an executable file, script interpreter, command-line utility, administrative utility, credential dumping utility, remote access tool, or other software component identified within process execution logs, command-line parameters, file paths, or threat intelligence mappings included in the alert metadata or investigation findings data. Stated another way, the fourth distinct instruction may direct the large language model to assess process names, executable paths, command-line arguments, and associated threat framework mappings (e.g., MITRE ATT&CK techniques) to identify and enumerate tools leveraged during the security incident and to incorporate the identified tools into the generated security incident explanation. At least one technical benefit of explicitly instructing the large language model to derive and reference attacker tools from the underlying security data (e.g., the alert metadata and the investigation findings data) includes improving evidentiary specificity of the generated security incident explanation and reducing the likelihood that the security incident explanation omits, misidentifies, or generically describes tools associated with the malicious activity.

Additionally, in such an embodiment, the security incident explanation prompt may include a fifth distinct instruction instructing the large language model to determine a corresponding attack technique associated with each of the plurality of distinct tools used by the attacker to perform the malicious activity. An attack technique associated with a respective tool, in some embodiments, may refer to a standardized classification of malicious behavior (e.g., MITRE ATT&CK technique or the like) that the respective tool is used to execute, such as a credential access technique, command and scripting interpreter technique, privilege escalation technique, lateral movement technique, or other defined malicious action. In certain embodiments, the attack technique may correspond to a technique identifier and descriptive label defined within a threat intelligence framework and may be incorporated into the generated security incident explanation to contextualize and/or explain how the respective tool was used during the security incident.

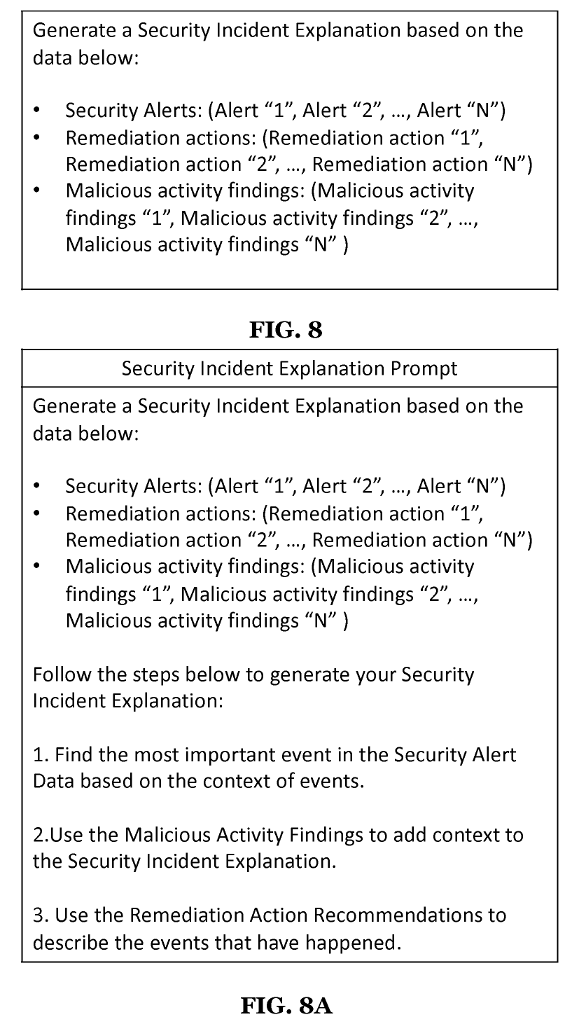

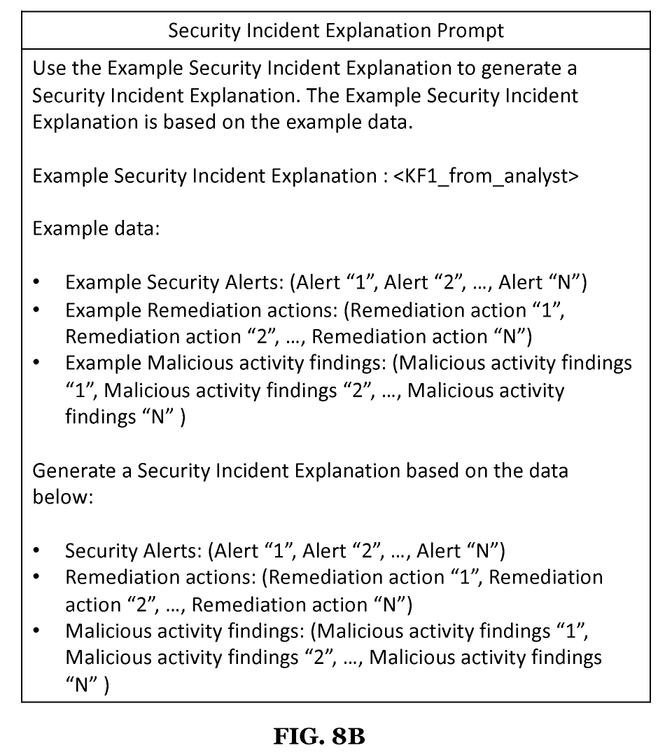

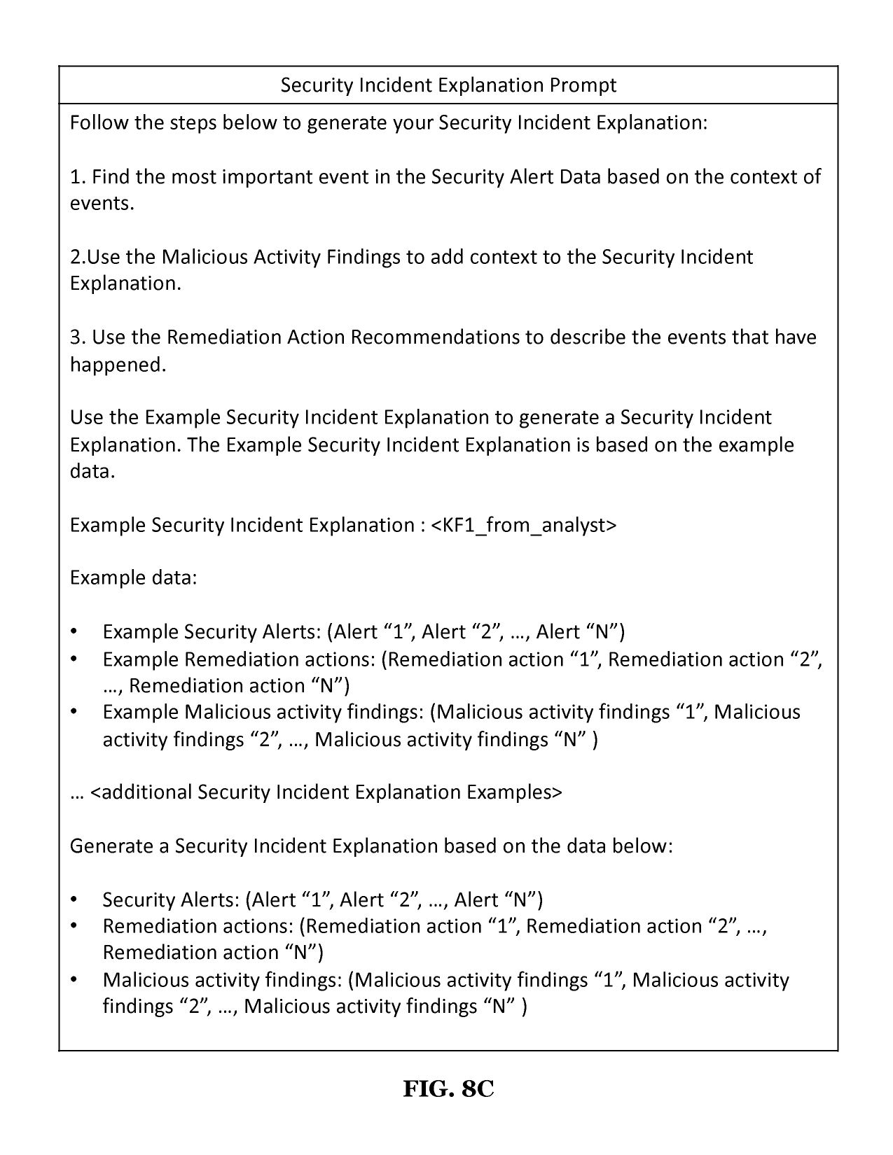

Additionally, in such an embodiment, the security incident explanation prompt may include a sixth distinct instruction instructing the large language model to assess the alert metadata and the investigation findings data to determine a degree of risk for the security incident. In such an embodiment, the degree of risk determined for the security incident may include an incident severity class (e.g., high, medium, low, etc.) determined for the security incident and a corresponding explanatory text string describing why the malicious activity corresponds the determined incident severity class based on the underlying security data (e.g., the alert metadata and the investigation findings data). For instance, in a non-limiting example, the degree of risk determined for the security incident may include an incident severity class (e.g., high) and a corresponding explanatory text string describing a rationale on why the large language model determined the security incident corresponded to the incident severity class (e.g., the attacker was able to dump a database, which contains hashed user credentials. This could allow the attacker to gain unauthorized access to a computing environment of the subscribing entity), as shown generally by way of example in FIGS. 8 – 8C.

Additionally, in such an embodiment, the security incident explanation prompt may include a seventh distinct instruction instructing the large language model to generate a risk justification (e.g., explanatory text string or the like) explaining a basis for the degree of risk determined for the security incident.

Additionally, in such an embodiment, the security incident explanation prompt may include an eighth distinct instruction instructing the large language model to generate, for each piece of evidence included in the alert metadata or the investigation findings data, one or more text strings explaining how that respective piece of evidence relates to the malicious activity. In some embodiments, a piece of evidence may comprise a command invocation, executable file path, process execution record, registry modification, network communication event, or other telemetry captured in the alert metadata or investigation findings data. Stated another way, the eighth distinct instruction may direct the large language model to analyze each identified evidentiary artifact and generate a corresponding explanatory statement describing what action was performed, how the action was performed, and how the action supports a conclusion that malicious activity occurred. For example, if the evidence includes execution of a registry utility with parameters indicative of credential database access, the large language model may generate an explanatory statement indicating that the command was used to dump authentication data, thereby linking the evidence to credential access activity. By explicitly instructing the large language model to generate evidence-specific explanatory text derived from the underlying security data, the systems described herein improve traceability between evidentiary artifacts and conclusions presented in the security incident explanation and reduce the likelihood that the explanation omits contextual interpretation of the evidence. At least one technical benefit of such an embodiment includes enabling structured, evidence-to-explanation mapping within the graphical user interface, thereby improving transparency of automated reasoning, facilitating verification by a user, and reducing processor cycles that would otherwise be consumed by manual cross-referencing of security telemetry with explanatory content.

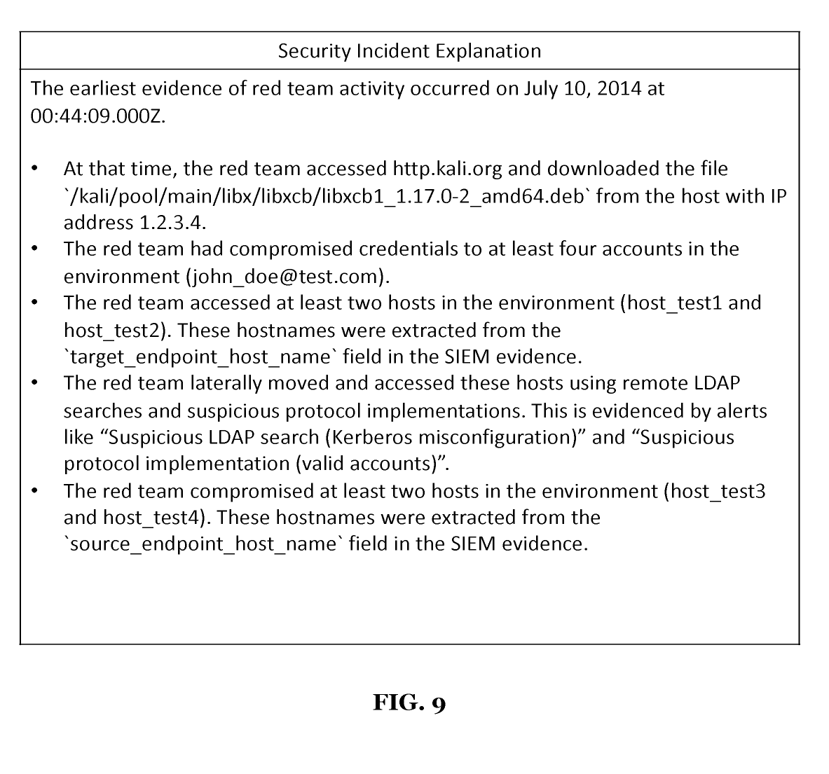

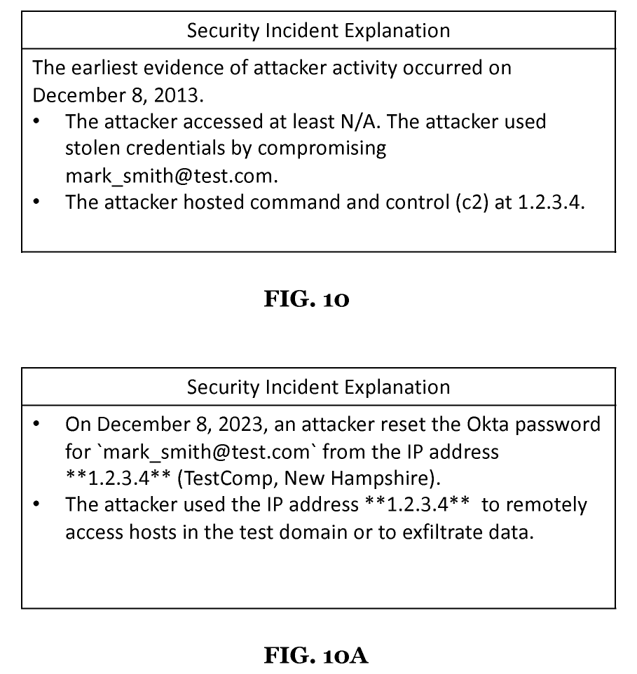

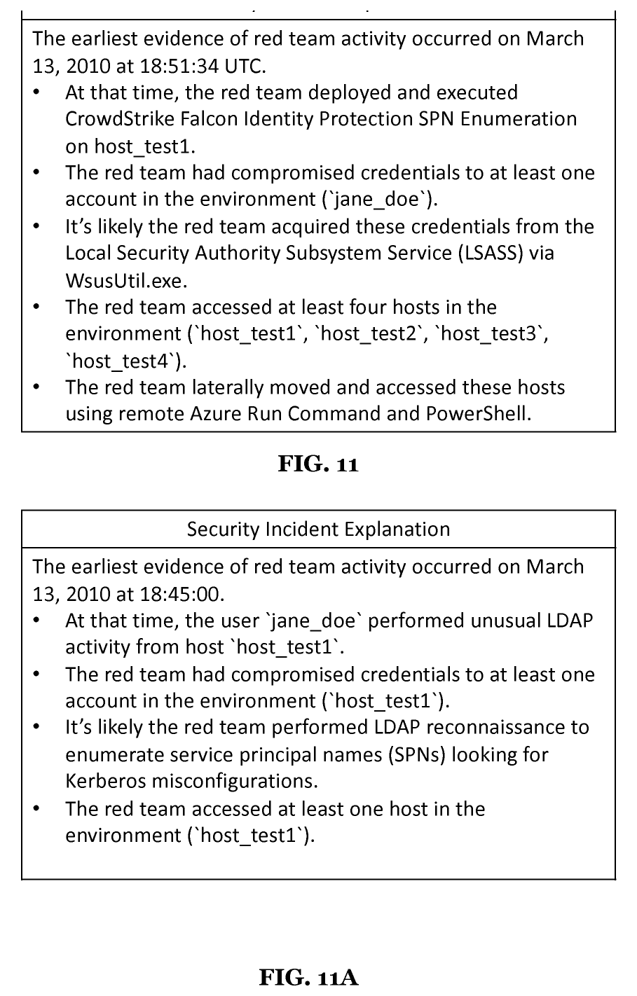

Turning to FIGS. 9 – 11A., in one or more embodiments, the security incident explanation may include one or more of a first timestamp value corresponding to an earliest timestamped piece of evidence included in the investigation findings data, a second timestamp value corresponding to a latest timestamped piece of evidence included in the investigation findings data, a total number of distinct computing assets of the subscribing entity involved in the security incident, a command string executed in a computing environment of the subscribing entity that caused the security incident, a first file path corresponding to a first executable file that executed the command string, a second file path corresponding to a second executable file that invoked execution of the first executable file, and a set of text strings that explains, in natural language (i) that the second executable file invoked the first executable file, (ii) that the first executable file executed the command string, and (iii) a malicious operation performed by execution of the command string. Stated another way, in one or more embodiments, the security incident explanation may specify a structured causal chain derived from the alert metadata and investigation findings data that links temporal boundaries, affected assets, process execution hierarchy, and command activity to a specific malicious operation, thereby translating discrete security telemetry into a coherent narrative describing how the malicious activity was initiated and executed within the computing environment.

Additionally, or alternatively, in one or more embodiments, the event detection and response service may ingest or obtain a plurality of distinct third-party security alerts generated by a plurality of distinct third-party security services (e.g., Cloudflare®, 1Passowrd®, Amazon GuardDuty®, Amazon Web Services CloudTrail®, Datadog®m Duo®, Sumo logic Cloud SIEM®, etc.) in operable communication with the event detection and response service and, in response, the plurality of distinct third-party security alerts against a plurality of detection instructions provided by the event detection and response service. In such an embodiment, the event detection and response service may generate the security alert associated with the subscribing entity based on detecting that the plurality of distinct third-party security alerts satisfies at least one of the plurality of detection instructions in analogous ways described above.

Accordingly, in such an embodiment, the plurality of distinct third-party security alerts are associated with the security alert generated by the event detection and response service and, in turn, the security incident explanation prompt may include the alert metadata associated with the security alert and each distinct piece of alert data specified in the plurality of distinct third-party security alerts. Stated another way, in one or more embodiments, the security incident explanation prompt may include alert data generated by native detection mechanisms of the event detection and response service in combination with third-party alert data obtained from a plurality of third-party security devices, services, or the like. By including both internally generated detection data and externally ingested alert data within the security incident explanation prompt, the systems described herein enable the large language model to generate a unified security incident explanation that reflects cross-product security telemetry within a single explanation output.

Additionally, or alternatively, in one or more embodiments, the event detection and response service may construct the security incident explanation prompt using a structured dataset comprising (i) one or more security alerts generated by native detection mechanisms (e.g., detection rule, detection instruction, etc.) of the event detection and response service, (ii) one or more third-party alerts obtained from a plurality of integrated third-party security products, services, or devices, (iii) one or more remediation actions initiated by analysts or executed via automation, and (iv) investigation findings identifying additional malicious activity within the computing environment of the subscribing entity. In such an embodiment, the event detection and response service may format, normalize, and explicitly structure the structured dataset prior to constructing the security incident explanation prompt such that contextual relationships between alerts, remediation actions, and malicious activity findings are clearly represented within the security incident explanation prompt. By structuring and clearly describing the security data before providing the security incident explanation prompt to the large language model, the systems described herein improve representational fidelity of the input data, reduce ambiguity in model interpretation, and improve factual consistency of the generated security incident explanation.

It shall be recognized that, in one or more embodiments, before receiving the input selecting the security incident creation object, the event detection and response service may function to display, by the event detection and response service, an incident creation popover that includes the security incident creation object, as shown generally by way of example in FIGS. 13 and 14. In such an embodiment, the event detection and response service may function to receive, via the incident creation popover, one or more remediation actions specified by the user for remediating or mitigating a security threat associated with the security incident. Accordingly, in such an embodiment, in response to receiving the input selecting the security incident creation object, the event detection and response service may automatically perform, in real-time or near real-time, the one or more remediation actions to remediate or mitigate the security threat associated with the security incident. It shall be further recognized that, in one or more embodiments, the security incident explanation prompt may further include the one or more remediation actions.

Stated differently, in one or more embodiments, the event detection and response service may capture remediation actions specified by the user within the incident creation popover and associate the remediation actions with the security incident at the time of incident creation, such that the remediation actions are both automatically executed and incorporated into the security incident explanation prompt. In such an embodiment, the large language model may generate the security incident explanation to include references to the remediation actions performed or scheduled, thereby linking detected malicious activity with corresponding mitigation steps within a single explanation output.

For instance, in a non-limiting example, the security alert generated by the system or service implementing method 200 may include a network host of the subscribing entity. In such an embodiment, in response to escalating the security alert to the security incident, the system or service implementing method 200 may function to automatically execute, in real-time or near real-time, a remediation action (e.g., automated remediation action or the like) that mitigates, in real-time or near real-time, a security threat associated with the security incident. Such remediation action may include, for example, automatically terminating existing network connections on the network host included in the security alert and preventing new network connections from digitally communicating with the network host included in the security alert.

In another non-limiting example, the security alert generated by the system or service implementing method 200 may include a user account of the subscribing entity and a computing environment of the subscribing entity. In such an embodiment, in response to escalating the security alert to the security incident, the system or service implementing method 200 may function to automatically execute, in real-time or near real-time, a remediation action (e.g., automated remediation action or the like) that mitigates, in real-time or near real-time, a security threat associated with the security incident. Such remediation action may include, for example, automatically disabling the user account included in the security alert to temporarily or permanently prevent unauthorized access to the computing environment of the subscribing entity.

In another non-limiting example, the security alert generated by the system or service implementing method 200 may include data associated with an application, a respective hash signature of the application, and/or a representation of a computing environment in which the application was executed. In such an embodiment, in response to escalating the security alert to the security incident, the system or service implementing method 200 may function to automatically execute, in real-time or near real-time, a remediation action (e.g., automated remediation action or the like) that mitigates, in real-time or near real-time, a security threat associated with the security incident. Such remediation action may include, for example, automatically blocking the respective hash signature included in the security alert to prevent the application associated with the respective hash signature from being re-executed within the computing environment of the subscribing entity.

In another non-limiting example, the security alert generated by the system or service implementing method 200 may include data associated with a cloud computing environment of the subscribing entity. In such an embodiment, in response to escalating the security alert to the security incident, the system or service implementing method 200 may function to automatically execute, in real-time or near real-time, a remediation action (e.g., automated remediation action or the like) that mitigates, in real-time or near real-time, a security threat associated with the security incident. Such remediation action may include, for example, automatically terminating the cloud computing environment of the subscribing entity to suspend or cease digital events from occurring on the cloud computing environment.

It shall be recognized that, in one or more embodiments, investigating the security alert may include automatically identifying, from a repository of automated investigation workflows, one or more automated investigation workflows digitally mapped to a threat type associated with the security alert and, in response, automatically executing, using the one or more processors, the one or more automated investigation workflows in response to identifying the one or more automated investigation workflows digitally mapped to the threat type associated with the security alert. It shall be recognized that, in one or more embodiments, executing each of the one or more automated investigation workflows may include generating one or more application programming interface (API) calls based on the alert metadata associated with the security alert, transmitting the one or more API calls to one or more API endpoints of the plurality of distinct third-party security services, and obtaining, in response to transmitting the one or more API calls, log data associated with the security incident. Accordingly, in such an embodiment, the investigation findings data may include the log data obtained from executing each of the one or more automated investigation workflows and the security incident explanation prompt may further include the log data obtained from executing each of the one or more automated investigation workflows. In some embodiments, the investigation findings data may include data that answers a plurality of investigation questions such as, but not limited to, when a user account logged into a computing asset; from which source internet protocol (IP) address the login originated; whether the login was successful or failed; whether multi-factor authentication was satisfied or bypassed; which processes were executed following the login; whether privileged credentials were accessed; whether a command was executed to access a security-sensitive database; which computing assets communicated with external hosts; whether lateral movement occurred between computing assets; when remediation actions were initiated or completed; when the malicious activity began; when the malicious activity ended; which computing assets were affected; which user accounts were involved; which tools were executed; what commands were run; what files were accessed or modified; and what remediation actions were performed.

Additionally, or alternatively, in one or more embodiments, the large language model may generate the security incident explanation by (i) assessing, in accordance with one or more instructions included in the security incident explanation prompt, the alert metadata associated with the security alert, (ii) assessing, in accordance with the one or more instructions included in the security incident explanation prompt, each distinct piece of alert data specified in the plurality of distinct third-party security alerts, and (iii) assessing, in accordance with the one or more instructions included in the security incident explanation prompt, the log data obtained from executing each of the one or more automated investigation workflows. At least one technical benefit of instructing the large language model to separately and explicitly evaluate multiple distinct categories of security data in accordance with structured prompt instructions includes improving deterministic processing of heterogeneous security telemetry, reducing data underutilization across disparate sources, increasing consistency of cross-source correlation, and reducing the likelihood that the generated security incident explanation includes unsupported inferences or omissions relative to the underlying security data.

Turning to FIGS. 9 – 11A, in one or more embodiments, the security incident explanation prompt may include a plurality of example security alerts associated with a prior security incident, a plurality of example remediation actions performed in response to detecting the prior security incident, a plurality of example malicious activity findings identified during a security investigation of the prior security incident, and an example security incident explanation generated for the prior security incident based on an assessment of the plurality of example security alerts, the plurality of example remediation actions, and the plurality of example malicious activity findings. In such an embodiment, the security incident explanation prompt may include a first instruction that (i) instructs the large language model to use the example security incident explanation when generating the security incident explanation for the security incident and (ii) specifies the example security incident explanation is derived from the plurality of example security alerts, the plurality of example remediation actions, and the plurality of example malicious activity findings. Stated another way, in one or more embodiments, the security incident explanation prompt may provide the large language model with a structured example illustrating how security alert data, remediation actions, and malicious activity findings are transformed into a security incident explanation, thereby guiding or controlling generation of the security incident explanation for the current security incident in a manner consistent with the structure, level of detail, and reasoning reflected in the example security incident explanation.

Accordingly, in such an embodiment, the security incident explanation prompt may further include the alert metadata associated with the security alert, the investigation findings data obtained from investigating the security alert, one or more remediation actions proposed by the event detection and response service to remediate or mitigate a security threat associated with the security incident, and a second instruction that further instructs the large language model to generate the security incident explanation for the security incident based on the alert metadata associated with the security alert, the investigation findings data obtained from investigating the security alert, and the one or more remediation actions proposed by the event detection and response service to remediate or mitigate the security threat associated with the security incident. Stated another way, in one or more embodiments, the security incident explanation prompt may combine (i) a structured example illustrating how prior security data was transformed into a security incident explanation and (ii) structured data corresponding to the current security incident, together with explicit instructions directing the large language model to apply the reasoning pattern reflected in the example to the structured data of the current security incident. By configuring the security incident explanation prompt in this manner, the systems described herein guide generation of the security incident explanation toward a consistent format and analytical approach while reducing variability and minimizing hallucinations in the generated output.

Additionally, or alternatively, in one or more embodiments, before the event detection and response service generates the security incident explanation prompt, the event detection and response service may function to (e.g., automatically) assess an alert queue to determine whether the alert queue includes any pending security alerts associated with the subscribing entity and related to the security incident. In such an embodiment, the event detection and response service may function to detect, based on the assessment of the alert queue, that a plurality of pending security alerts stored in the alert queue are related to the security incident. Furthermore, in such an embodiment, the event detection and response service may function to generate a plurality of remediation actions to remediate or mitigate a security threat associated with the security alert and the plurality of pending security alerts. It shall be recognized that, in one or more embodiments, the investigation findings data may include a plurality of distinct malicious activity findings identified during investigation of the security alert and the plurality of pending security alerts.

Accordingly, in such an embodiment, the security incident explanation prompt may include the security alert associated with the subscribing entity, the plurality of pending security alerts, the plurality of remediation actions generated for the security alert and the plurality of pending security alerts, the plurality of distinct malicious activity findings identified during the investigation of the security alert and the plurality of pending security alerts, a first instruction that instructs the large language model to generate the security incident explanation based on the security alert, the plurality of pending security alerts, the plurality of distinct malicious activity findings, and the plurality of remediation actions, and a second instruction that further instructs the large language model to generate the security incident explanation by at least: (a) determining, based on one or more event selection criteria, a target event included in the security alert and the plurality of pending security alerts, using the plurality of distinct malicious activity findings to add context to the security incident explanation, and using the plurality of remediation actions to describe malicious digital activity that occurred in one or more computing environments of the subscribing entity.

Stated another way, in one or more embodiments, the event detection and response service may automatically detect, from the alert queue, one or more pending security alerts that are related to or otherwise associated with the security incident based on one or more correlation criteria. In some embodiments, a respective pending security alert may be determined to be related to the security incident when the respective pending security alert includes one or more attributes equivalent to one or more attributes of the security alert, such as a computing asset identifier, a user account identifier, an event timestamp within a defined temporal proximity, a network address, a command execution pattern, a file artifact, or any other alert metadata field. Upon detecting that the plurality of pending security alerts are associated with the security incident, the event detection and response service may aggregate the related pending security alerts with the security alert prior to constructing the security incident explanation prompt. By automatically detecting and incorporating related pending security alerts into the security incident explanation prompt, the systems described herein reduce the likelihood that correlated malicious activity is evaluated in isolation and improve completeness of the security incident explanation.

A pending security alert, in one or more embodiments, may comprise a security alert generated by the event detection and response service that has not yet been investigated, reviewed, or assessed by a security analyst of the event detection and response service. Stated another way, a pending security alert in an alert queue may refer to a security alert awaiting triage, investigation, or disposition and for which no escalation decision, remediation action, or dismissal determination has yet been made.

At least one technical benefit of automatically detecting and aggregating pending security alerts associated with the security incident prior to constructing the security incident explanation prompt includes reducing redundant evaluation of correlated malicious activity across multiple alerts, minimizing duplicate data retrieval operations, and improving computational efficiency by consolidating related alert metadata, investigation findings data, and remediation actions into a unified explanation generation process. Additionally, by evaluating correlated pending security alerts collectively rather than independently, the systems described herein reduce fragmentation of security context and improve accuracy and completeness of the generated security incident explanation.

Turning to FIGS. 9 – 11A, in one or more embodiments, the security incident explanation may include a first set of text strings describing, in natural language, an earliest timestamp of malicious activity identified in the investigation findings data, a second set of text strings describing, in natural language, the malicious activity that occurred at the earliest timestamp, a third set of text strings describing, in natural language, a total number of digital accounts of the subscribing entity determined to be compromised, a fourth set of text strings describing, in natural language, a plurality of computing hosts within a computing environment of the subscribing entity that were accessed during the security incident, a fifth set of text strings describing, in natural language, one or more techniques used by a threat actor to access or move between the plurality of computing hosts during the security incident, a sixth set of text strings describing, in natural language, that the plurality of computing hosts were compromised, and a seventh set of text strings describing, in natural language, one or more pieces of evidence included in the investigation findings data that resulted in the large language model detecting that the plurality of computing hosts were compromised.

Turning to FIGS. 9 – 11A, in one or more embodiments, the security incident explanation may include a first set of text strings describing, in natural language, an earliest timestamp of attacker activity detected in the investigation findings data, a second set of text strings describing, in natural language, a computing resource of the subscribing entity that a threat actor accessed during the security incident, a third set of text strings describing, in natural language, a digital account of the subscribing entity that the threat actor used to access the computing resource of the subscribing entity, and a fourth set of text strings describing, in natural language, that the threat actor operated command-and-control infrastructure at a network address specified in the investigation findings data. In some embodiments, command-and-control infrastructure may refer to one or more network-accessible computing systems, servers, domains, internet protocol (IP) addresses, cloud-hosted resources, or other communication endpoints that are configured to transmit commands to, receive data from, or otherwise maintain communication with a compromised computing resource within the computing environment of the subscribing entity. Command-and-control infrastructure may include infrastructure operated directly by a threat actor or indirectly through intermediary systems and may be identified in the investigation findings data based on observed outbound network communications, beaconing behavior, domain name system (DNS) requests, encrypted communication sessions, or other network telemetry indicative of remote command exchange.

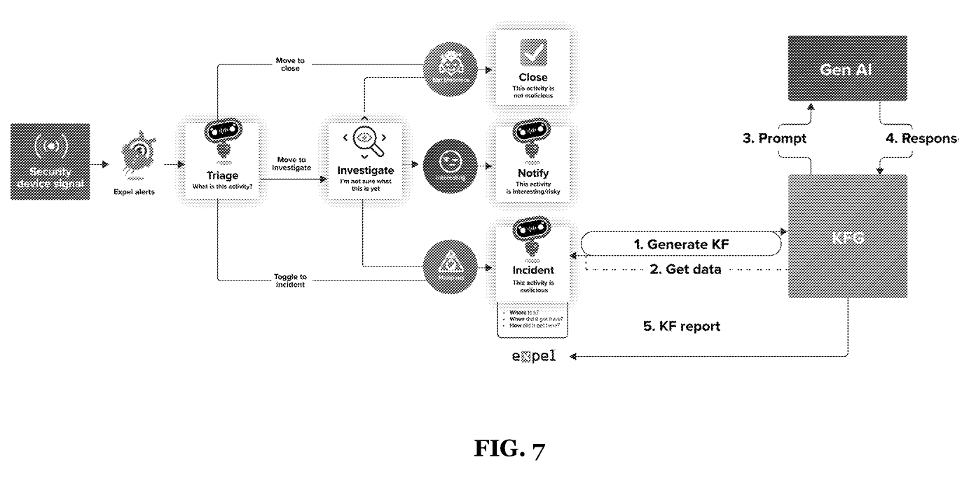

Turning to FIG. 7, in one or more embodiments, in response to escalating the security alert to the security incident, the event detection and response service may function to transmit, over a computer network, a security incident explanation request to a security incident explanation microservice. In one or more embodiments, in response to the security incident explanation microservice receiving the security incident explanation request, the security incident explanation microservice may function to query one or more databases of the event detection and response service to retrieve the alert metadata associated with the security alert and the investigation findings data obtained from investigating the security alert. Furthermore, in such an embodiment, the security incident explanation microservice may function to generate the security incident explanation prompt after the security incident explanation microservice receives the alert metadata associated with the security alert and the investigation findings data obtained from investigating the security alert.

Accordingly, in such an embodiment, the security incident explanation microservice may function to transmit the security incident explanation prompt generated by the security incident explanation microservice to the large language model and, in response, store, in computer memory accessible to the security incident explanation microservice, the security incident explanation generated by the large language model. In one or more embodiments, the security incident explanation microservice may function to transmit the security incident explanation stored in the computer memory to the event detection and response service.

Stated another way, in one or more embodiments, the security incident explanation microservice may operate as an intermediary processing component configured to (i) retrieve structured security data associated with the security incident, (ii) construct the security incident explanation prompt based on the retrieved structured security data, (iii) transmit the security incident explanation prompt to the large language model over the computer network, (iv) receive the security incident explanation generated by the large language model, and (v) persist the generated security incident explanation in computer memory for subsequent retrieval and presentation within the graphical user interface of the event detection and response service. By separating construction of the security incident explanation prompt and management of large language model interactions into the security incident explanation microservice, the systems described herein improve modularity of the system architecture, reduce processing overhead on the event detection and response service, and enable scalable, asynchronous generation of security incident explanations.

It shall be recognized that, in one or more embodiments, the event detection and response service may function to automatically insert the security incident explanation generated by the large language model into a findings section of the security incident artifact.

### Secure Prompt Creation

In one or more embodiments, automatically creating the security incident explanation prompt may include obtaining, from one or more databases of the event detection and response service, the alert metadata associated with the security alert and the investigation findings data obtained from investigating the security alert and, in response, automatically anonymizing, by the one or more processors, at least one piece of data included in the alert metadata or the investigation findings data to an anonymized piece of data. In such an embodiment, the security incident explanation prompt may include the anonymized piece of data and exclude the at least one piece of data in original form.

Accordingly, in such an embodiment, the security incident explanation generated by the large language model may include the anonymized piece of data. It shall be recognized that, in such an embodiment, in response to adapting the security incident artifact to include the security incident explanation generated by the large language model, the event detection and response service may automatically replace the anonymized piece of data included in the security incident artifact with the at least one piece of data in original form.

Stated another way, in one or more embodiments, the event detection and response service may implement a reversible anonymization layer during construction of the security incident explanation prompt, such that the large language model receives and processes anonymized representations of one or more sensitive data elements (e.g., user account identifiers, computing asset identifiers, network addresses, file paths, domain names, or other security-sensitive metadata) instead of the corresponding original data elements. In such an embodiment, the event detection and response service may maintain, in memory, an association mapping between each anonymized piece of data and its corresponding original data element. After the large language model generates the security incident explanation containing the anonymized piece of data, the event detection and response service may utilize the association mapping to automatically substitute the original data element in place of the anonymized piece of data within the security incident artifact prior to presentation to the subscribing entity.

At least one technical benefit of this approach includes preventing exposure of sensitive data elements to the large language model during generation of the security incident explanation while preserving accuracy and contextual integrity of the security incident artifact ultimately displayed to the subscribing entity.

Additionally, or alternatively, in one or more embodiments, automatically creating the security incident explanation prompt may include automatically obtaining, from one or more databases of the event detection and response service, the alert metadata associated with the security alert and the investigation findings data obtained from investigating the security alert. Furthermore, in such an embodiment, the event detection and response service may function to automatically detect, using one or more processors, personally identifiable information included in the alert metadata and the investigation findings data and, in response, automatically generate a sanitized version of the alert metadata and the investigation findings data by removing the personally identifiable information from the alert metadata and the investigation findings data. Accordingly, in such an embodiment, the security incident explanation prompt may be constructed using the sanitized version of the alert metadata and the investigation findings data.

Stated another way, in one or more embodiments, prior to transmitting the security incident explanation prompt to the large language model, the event detection and response service may implement an automated sanitization process that detects and removes personally identifiable information (PII) from the alert metadata and the investigation findings data, such that the large language model processes only the sanitized version of the security data. In such an embodiment, the personally identifiable information may include, without limitation, full names, email addresses, phone numbers, physical addresses, government-issued identifiers, account identifiers associated with specific individuals, or any other data element classified as sensitive under one or more data protection policies. By constructing the security incident explanation prompt using the sanitized version of the alert metadata and the investigation findings data, the systems described herein reduce the likelihood that the large language model generates output containing personally identifiable information, prevent inadvertent propagation of sensitive user data, and maintain data privacy controls specified by the event detection and response service.

### Post-Generation Feedback

In one or more embodiments, after the large language model generates the security incident explanation for the security incident, the event detection and response service may function to receive, via the graphical user interface, feedback data from the user indicating an efficacy of the security incident explanation generated by the large language model and, in response, automatically generate, using the one or more processors, a training data sample. The training data sample, in such an embodiment, may include the security incident explanation prompt provided to the large language model, the security incident explanation generated by the large language model based on the large language model processing the security incident explanation prompt, and the feedback data. Accordingly, in such an embodiment, the event detection and response service may function to train the large language model using at least the training data sample.

The feedback data, in one or more embodiments, may include one or more structured or unstructured inputs provided via the graphical user interface indicating an assessment of the security incident explanation generated by the large language model. For example, the feedback data may include a quantitative rating, a binary approval or rejection indicator, a selection of one or more predefined evaluation categories (e.g., completeness, accuracy, clarity, factual consistency, or presence of hallucinated content), one or more textual annotations identifying portions of the security incident explanation that are incorrect or incomplete, one or more modifications made to the security incident explanation by the user, or any combination thereof. In some embodiments, the feedback data may further include metadata identifying which portion of the security incident explanation the feedback corresponds to, thereby enabling targeted retraining or refinement of specific components of the large language model or prompt generation parameters.

Additionally, or alternatively, the feedback data, in one or more embodiments, may comprise one or more data elements captured via the graphical user interface that indicate whether the security incident explanation generated by the large language model is correct, complete, and/or suitable for use in association with the security incident. In some embodiments, the feedback data may include one or more explicit evaluation signals provided by the user, such as a binary approval/rejection indicator, a numerical rating, or a selection of one or more predefined evaluation categories (e.g., accuracy, completeness, clarity, consistency with investigation findings data, or presence of hallucinated content). The feedback data, in some embodiments, may include one or more user-provided corrections to the generated security incident explanation, such as edits to text strings, deletion of one or more text strings, insertion of replacement text strings, or annotations identifying which portions of the security incident explanation are unsupported by the alert metadata or the investigation findings data. In further embodiments, the feedback data may include metadata identifying a location within the security incident explanation to which the feedback applies (e.g., a referenced sentence, section, evidence explanation, timestamp field, affected asset field, or remediation field), thereby enabling the event detection and response service to generate a plurality of targeted training data samples and to retrain, fine-tune, and/or adjust prompt generation parameters to reduce hallucinations and improve factual alignment of subsequently generated security incident explanations.

At least one technical benefit of capturing and incorporating the feedback data into the training data sample includes reducing hallucinations generated by the large language model and improving factual alignment between the security incident explanation and the underlying alert metadata and investigation findings data. By associating user-provided corrections and evaluation signals with the corresponding security incident explanation prompt and generated output, the systems described herein enable targeted retraining, fine-tuning, and/or prompt parameter adjustment that incrementally improves completeness, temporal accuracy, evidentiary traceability, and consistency of subsequently generated security incident explanations. Additionally, leveraging structured feedback data to iteratively refine the large language model reduces the likelihood that unsupported inferences, omitted evidence, or imprecise characterizations of malicious activity are propagated in future outputs, thereby enhancing reliability, trustworthiness, and operational usefulness of the automatically generated security incident explanations within a security operations environment.

It shall be recognized that, in one or more embodiments, the event detection and response service automatically created the security incident explanation prompt based on one or more prompt generation parameters stored in memory. In such an embodiment, after the large language model generates the security incident explanation for the security incident, the event detection and response service may receive, via the graphical user interface, feedback data from the user indicating an efficacy of the security incident explanation generated for the security incident and, in response, adjust, based on the feedback data, at least one of the one or more prompt generation parameters to modify how the event detection and response service constructs subsequent security incident explanation prompts.

For instance, in one or more embodiments, adjusting the one or more prompt generation parameters may cause the event detection and response service to generate modified textual instructions included in subsequently constructed security incident explanation prompts when compared to one or more previously constructed security incident explanation prompts generated prior to receiving the feedback data. In such an embodiment, the modified textual instructions may include revised, expanded, restricted, reordered, or newly inserted instruction text that alters how the large language model evaluates the alert metadata, investigation findings data, pending security alerts, or remediation actions when generating the security incident explanation. For example, a subsequently constructed security incident explanation prompt may include additional instruction text requiring explicit evidentiary citation, stricter temporal derivation requirements, mandatory enumeration of affected computing assets, prohibition of unsupported inferences, or more granular risk justification language, thereby programmatically refining generation behavior of the large language model based on the received feedback data.

In another non-limiting example, adjusting the one or more prompt generation parameters may include (i) adding an instruction requiring the large language model to determine whether lateral movement occurred by explicitly evaluating process execution chains and remote authentication events; (ii) inserting an instruction requiring identification of a command-and-control network address only if supported by observed outbound communication telemetry included in the investigation findings data; (iii) expanding an instruction to require correlation of multiple pending security alerts before describing a malicious campaign; (iv) revising an instruction to require enumeration of each compromised digital account along with a corresponding timestamp of first observed misuse; (v) adding an instruction requiring the large language model to distinguish between confirmed malicious activity and suspected malicious activity based on confidence indicators derived from the alert metadata; (vi) modifying an instruction to require inclusion of remediation status information indicating whether a remediation action was initiated, completed, or pending; (vii) inserting a constraint requiring explicit differentiation between native detection data and third-party ingested alert data when describing evidence sources; (viii) adding an instruction requiring generation of a structured timeline section summarizing sequential malicious events; (ix) modifying risk determination instructions to require explicit reference to severity classification criteria; and/or (x) inserting an instruction requiring omission of any conclusion (e.g., output text string) that cannot be directly tied to at least one data element included in the security incident explanation prompt.

By programmatically adjusting the textual content of the security incident explanation prompt in this manner, the event detection and response service systematically automatically and/or periodically refines how the large language model generates subsequent security incident explanations, thereby reducing unsupported inferences and hallucinations generated by the large language model, improving evidentiary traceability, enhancing completeness of asset and account enumeration, and improving factual consistency across generated outputs.

### Security Alert Investigation

In one or more embodiments, the event detection and response service may have generated the security alert based on digital activity that occurred on a computing asset of the subscribing entity. In such an embodiment, investigating the security alert may include executing an automated investigation protocol for the security alert, as described in U.S. Patent Application No. 19/304,982, titled SYSTEMS AND METHODS FOR REAL-TIME GENERATION AND EXECUTION OF COMPUTER-EXECUTABLE INVESTIGATIVE QUERIES IN A CYBERSECURITY EVENT DETECTION AND RESPONSE PLATFORM, which is incorporated in its entireties by this reference.

Executing the automated investigation protocol for the security alert, in one or more embodiments, may include one or more of (a) automatically extracting, from the security alert, an alert identifier of the security alert, a third-party service that detected the digital activity, and a globally unique identifier (GUID) that corresponds to the subscribing entity; (b) automatically detecting that (i) a first directory path comprising the GUID exists within a hierarchical file system and (ii) a second directory path comprising a name of the third-party service exists within the hierarchical file system; (c) in response to detecting that the first directory path and the second directory path exist within the hierarchical file system, automatically loading, into memory, a subscriber-specific investigative queries file located within the first directory path and a service-specific investigative queries file located within the second directory path; (d) automatically extracting, from the subscriber-specific investigative queries file loaded into the memory, a plurality of subscriber-specific investigative query objects digitally mapped to the alert identifier corresponding to the security alert; (e) in response to extracting the plurality of subscriber-specific investigative query objects, automatically constructing a first plurality of computer-executable investigation queries using the plurality of subscriber-specific investigative query objects and a first subset of the alert metadata associated with the security alert; (f) automatically extracting, from the service-specific investigative queries file loaded into the memory, a plurality of service-specific investigative query objects digitally mapped to the alert identifier corresponding to the security alert; (g) in response to extracting the plurality of service-specific investigative query objects, automatically constructing a second plurality of computer-executable investigation queries using the plurality of service-specific investigative query objects and a second subset of the alert metadata associated with the security alert; and (h) obtaining, in response to executing the first plurality of computer-executable investigation queries and the second plurality of computer-executable investigation queries, the investigation findings data.

In one or more embodiments, executing the first plurality of computer-executable investigation queries may include transmitting, over a computer network, one or more API calls to an API endpoint provided by the third-party service. In such an embodiment, in response to transmitting the one or more API calls to the API endpoint provided by the third-party service, the event detection and response service may obtain a subset of the investigation findings data. The subset of the investigation findings data may include a first set of raw logs retrieved from the third-party service that occurred before the security alert was generated and a second set of raw logs retrieved from the third-party service that occurred after the security alert was generated. At least one technical benefit of retrieving raw logs from both before and after generation of the security alert includes enabling temporal expansion of the investigative scope beyond the initial detection event, thereby allowing the event detection and response service to identify precursor activity that may have led to the security alert and follow-on activity that may have occurred subsequent to the security alert. By programmatically querying and aggregating historical and post-alert log data from the third-party service, the systems described herein improve completeness of the investigation findings data, enhance the ability to derive accurate temporal boundaries of malicious activity, reduce the likelihood that related malicious activity is evaluated in isolation, and provide a more comprehensive evidentiary basis for generation of the security incident explanation.

In one or more embodiments, executing the second plurality of computer-executable investigation queries may include transmitting, over a computer network, one or more API calls to an API endpoint provided by the third-party service. In such an embodiment, in response to transmitting the one or more API calls to the API endpoint provided by the third-party service, the event detection and response service may obtain a subset of the investigation findings data. The subset of the investigation findings data may include a first set of raw logs retrieved from the third-party service that occurred before the security alert was generated and a second set of raw logs retrieved from the third-party service that occurred after the security alert was generated. At least one technical benefit of retrieving raw logs from both before and after generation of the security alert includes enabling temporal expansion of the investigative scope beyond the initial detection event, thereby allowing the event detection and response service to identify precursor activity that may have led to the security alert and follow-on activity that may have occurred subsequent to the security alert. By programmatically querying and aggregating historical and post-alert log data from the third-party service, the systems described herein improve completeness of the investigation findings data, enhance the ability to derive accurate temporal boundaries of malicious activity, reduce the likelihood that related malicious activity is evaluated in isolation, and provide a more comprehensive evidentiary basis for generation of the security incident explanation.

It shall be recognized that, in some embodiments, the first plurality of computer-executable investigation queries and the second plurality of computer-executable investigation queries may be simultaneously executed.

In another non-limiting example, executing one of the first plurality of computer-executable investigation queries may include creating a first application programming interface (API) call operably configured to retrieve a first set of investigation findings data from the third-party service; creating a second API call operably configured to retrieve a second set of investigation findings data from a second third-party service different from the third-party service; transmitting, over a computer network, the first API call to an API endpoint provided by the third-party service; and transmitting, over the computer network, the second API call to an API endpoint provided by the second third-party service. In such a non-limiting example, executing one of the second plurality of computer-executable investigation queries may include creating a third API call operably configured to retrieve a third set of investigation findings data from the third-party service and transmitting, over the computer network, the third API call to the API endpoint provided by the third-party service. Accordingly, in such an embodiment, the investigation findings data may include the first set of investigation findings data, the second set of investigation findings data, and the third set of investigation findings data.

### Automated Querying and Retrieval of Example Prompt Components

In one or more embodiments, the system or service implementing method 200 may dynamically (e.g., automatically) select, in real-time or near real-time, one or more example prompt inputs and corresponding example investigation outputs based on a threat classification, alert type, or investigation category associated with the security alert (e.g., a current security alert, a target security alert, etc.) or the security incident (e.g., a current security incident, a target security incident, etc.). In such embodiments, the system or service implementing method 200 may maintain a repository of example security alerts, example remediation actions, example malicious activity findings, and example security incident explanations that are indexed according to alert classification labels, threat types, attack techniques, and/or investigation categories. When constructing the security incident explanation prompt for a target security incident, the system or service implementing method 200 may automatically identify a subset of examples (e.g., a subset of example security alerts, a subset of example remediation actions performed in response to detecting the subset of example security alerts, a subset of example malicious activity findings identified during a security investigation of the subset of example security alerts, a subset of example security incident explanations generated for or associated with the subset of example security alerts, etc.) within the repository that correspond to the alert classification label or threat type associated with one or more current security alerts included in the target security incident and, in turn, include such examples into the prompt example region of the security incident explanation prompt. In other words, the security incident explanation prompt does not include example security alerts, example remediation actions, example malicious activity findings, and example security incident explanations that are not mapped to or correspond to the alert classification label or the threat type associated with the one or more current security alerts included in the target security incident.

In other words, the system or service implementing method 200 may execute a filtering operation when selecting the subset of examples (e.g., example security alerts, example remediation actions, example malicious activity findings, and example security incident explanations) from the repository such that examples (e.g., example security alerts, example remediation actions, example malicious activity findings, and example security incident explanations) associated with unrelated alert classifications or unrelated threat categories are excluded from the prompt example region of the security incident explanation prompt. For instance, if the one or more current security alerts correspond to a malware detection alert type, the system or service implementing method 200 may automatically retrieve examples (e.g., example security alerts, example remediation actions, example malicious activity findings, and example security incident explanations) from the repository that correspond to malware execution events, malicious process chains, credential dumping activity, or other endpoint-based attack techniques, while excluding (e.g., not retrieving) examples (e.g., example security alerts, example remediation actions, example malicious activity findings, and example security incident explanations) stored in the repository that correspond to phishing alerts, suspicious email activity, or identity compromise alerts. Similarly, if the one or more current security alerts correspond to an unauthorized access alert type, the system or service implementing method 200 may only retrieve examples (e.g., example security alerts, example remediation actions, example malicious activity findings, and example security incident explanations) describing anomalous authentication behavior, identity misuse, or account compromise scenarios while excluding examples (e.g., example security alerts, example remediation actions, example malicious activity findings, and example security incident explanations) associated with endpoint malware execution or command-line attack techniques.

In one or more embodiments, the dynamic selection and filtering of example prompt inputs may function to improve semantic alignment between the examples included in the security incident explanation prompt and the activity associated with the target security incident. By conditioning the machine learning model on examples that correspond to the same or similar threat classifications as the one or more current security alerts included in the target security incident, the system or service implementing method 200 may reduce ambiguity within the prompt context and improve the ability of the machine learning model to generate investigation findings data and security incident explanations that accurately reflect characteristics of the detected security incident.

It shall be recognized that, in one or more embodiments, the automatic selection of examples (e.g., example security alerts, example remediation actions, example malicious activity findings, and example security incident explanations) may be performed using a mapping data structure that associates one or more alert classification labels, threat types, attack techniques, or investigation categories with one or more corresponding example prompt inputs and example investigation outputs stored within the repository. In such embodiments, the mapping data structure may function to enable the system or service implementing method 200 to efficiently identify example security alerts and associated investigation artifacts that correspond to a threat classification or alert type associated with one or more current security alerts included in a target security incident. In one or more embodiments, the mapping data structure may comprise one or more reference tables, indexed data structures, key-value mappings, or other data structures stored in memory that associate a threat classification label or alert type with a corresponding set of example security alerts, example remediation actions, example malicious activity findings, and example security incident explanations. In such embodiments, the system or service implementing method 200 may query the mapping data structure using the alert classification label, threat type identifier, or investigation category associated with the one or more current security alerts in order to retrieve a subset of examples (e.g., example security alerts, example remediation actions, example malicious activity findings, and example security incident explanations) that correspond to the detected alert type. In one or more embodiments, the mapping data structure may further include exclusion mappings that identify example prompts associated with unrelated threat categories that should be excluded from the prompt example region of the security incident explanation prompt. Accordingly, the mapping data structure may enable the system or service implementing method 200 to both retrieve examples corresponding to the detected alert classification and exclude examples associated with unrelated alert classifications, thereby improving semantic alignment between the selected examples and the activity associated with the target security incident.

### 3. Computer-Implemented Method and Computer Program Product

Embodiments of the system and/or method can include every combination and permutation of the various system components and the various method processes, wherein one or more instances of the method and/or processes described herein can be performed in real-time or near real-time, asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although omitted for conciseness, the embodiments include every combination and permutation of the implementations of the systems and methods described herein. Furthermore, each method step, process step, or the like described herein may be performed in real-time or near real-time. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

As a person skilled in the art will recognize from the previous detailed description and from the figures and claims, modifications and changes can be made to the preferred embodiments of the invention without departing from the scope of this invention defined in the following claims.

We claim:

1. A computer-implemented method comprising:
at an event detection and response service implemented by a network of distributed computers:
displaying, via a graphical user interface, a security alert associated with a subscribing entity;
receiving, while the security alert is displayed on the graphical user interface, an input from a user selecting a security incident creation object;
in response to receiving the input selecting the security incident creation object:
automatically escalating the security alert to a security incident;
automatically generating, based in part on the security alert, a security incident artifact that corresponds to the security alert;
automatically updating the graphical user interface from displaying the security alert to displaying the security incident artifact corresponding to the security alert; and
displaying a security incident explanation button on the graphical user interface while the graphical user interface is displaying the security incident artifact;
receiving, from the user, an input selecting the security incident explanation button;
in response to receiving the input from the user selecting the security incident explanation button:
automatically creating a security incident explanation prompt based on (i) alert metadata associated with the security alert and (ii) investigation findings data obtained from investigating the security alert; and
generating, using a large language model, a security incident explanation for the security incident based on providing the security incident explanation prompt to the large language model;
adapting the security incident artifact to include the security incident explanation generated by the large language model; and
surfacing, using one or more processors, the security incident artifact comprising the security incident explanation to the subscribing entity.

2. The computer-implemented method according to claim 1, further comprising:
in response to receiving the input from the user selecting the security incident explanation button:
automatically instantiating, before creating the security incident explanation prompt, an incident explanation user interface panel overlaying the security incident artifact displayed on the graphical user interface;
displaying, within the incident explanation user interface panel, a loading animation while the large language model is generating the security incident explanation for the security incident; and
automatically rendering, within the incident explanation user interface panel, the security incident explanation generated for the security incident.

3. The computer-implemented method according to claim 2, wherein:
adapting the security incident artifact to include the security incident explanation includes:
writing the security incident explanation to a memory buffer in response to receiving an input from the user selecting a copy button displayed within the incident explanation user interface panel;
receiving, via the graphical user interface, an input from the user selecting an adding finding button displayed within a findings section of the security incident artifact;
instantiating a finding entry popover in response to receiving the input selecting the adding finding button;
inserting the security incident explanation stored in the memory buffer into the finding entry popover;
receiving a findings confirmation input from the user at the finding entry popover; and
in response to receiving the findings confirmation input from the user, automatically adding the security incident explanation inserted into the finding entry popover into the findings section of the security incident artifact.

4. The computer-implemented method according to claim 1, wherein the security incident explanation prompt automatically created by the event detection and response service includes:
a first distinct instruction instructing the large language model to assess the alert metadata and the investigation findings data to determine a start time of malicious activity;
a second distinct instruction instructing the large language model to assess the alert metadata and the investigation findings data to determine an end time of the malicious activity;
a third distinct instruction instructing the large language model to assess the alert metadata and the investigation findings data to determine a total number of distinct computing assets of the subscribing entity involved in the security incident;
a fourth distinct instruction instructing the large language model to assess the alert metadata and the investigation findings data to determine a plurality of distinct tools used by an attacker to perform the malicious activity;
a fifth distinct instruction instructing the large language model to determine a corresponding attack technique associated with each of the plurality of distinct tools used by the attacker to perform the malicious activity;
a sixth distinct instruction instructing the large language model to assess the alert metadata and the investigation findings data to determine a degree of risk for the security incident;
a seventh distinct instruction instructing the large language model to generate a risk justification explaining a basis for the degree of risk determined for the security incident; and
an eighth distinct instruction instructing the large language model to generate, for each piece of evidence included in the alert metadata or the investigation findings data, one or more text strings explaining how that respective piece of evidence relates to the malicious activity.

5. The computer-implemented method according to claim 1, wherein the security incident explanation includes:
a first timestamp value corresponding to an earliest timestamped piece of evidence included in the investigation findings data,
a second timestamp value corresponding to a latest timestamped piece of evidence included in the investigation findings data,
a total number of distinct computing assets of the subscribing entity involved in the security incident,
a command string executed in a computing environment of the subscribing entity that caused the security incident,
a first file path corresponding to a first executable file that executed the command string,
a second file path corresponding to a second executable file that invoked execution of the first executable file, and
a set of text strings that explains, in natural language:
(i) that the second executable file invoked the first executable file,
(ii) that the first executable file executed the command string, and
(iii) a malicious operation performed by execution of the command string.

6. The computer-implemented method according to claim 1, further comprising:
ingesting, by the event detection and response service, a plurality of distinct third-party security alerts generated by a plurality of distinct third-party security services in operable communication with the event detection and response service;
assessing the plurality of distinct third-party security alerts against a plurality of detection instructions provided by the event detection and response service; and
generating, by the event detection and response service, the security alert associated with the subscribing entity based on detecting that the plurality of distinct third-party security alerts satisfies at least one of the plurality of detection instructions, wherein:
the plurality of distinct third-party security alerts are associated with the security alert generated by the event detection and response service; and
the security incident explanation prompt includes:
the alert metadata associated with the security alert, and
each distinct piece of alert data specified in the plurality of distinct third-party security alerts.

7. The computer-implemented method according to claim 6, further comprising:
before receiving the input selecting the security incident creation object:
displaying, by the event detection and response service, an incident creation popover that includes the security incident creation object;
receiving, via the incident creation popover, one or more remediation actions specified by the user for remediating or mitigating a security threat associated with the security incident; and
in response to receiving the input selecting the security incident creation object, automatically performing, in real-time or near real-time, the one or more remediation actions to remediate or mitigate the security threat associated with the security incident, wherein:
the security incident explanation prompt further includes the one or more remediation actions.

8. The computer-implemented method according to claim 7, wherein:
investigating the security alert includes:
automatically identifying, from a repository of automated investigation workflows, one or more automated investigation workflows digitally mapped to a threat type associated with the security alert; and
automatically executing, using the one or more processors, the one or more automated investigation workflows in response to identifying the one or more automated investigation workflows digitally mapped to the threat type associated with the security alert, wherein executing each of the one or more automated investigation workflows includes:
generating one or more application programming interface (API) calls based on the alert metadata associated with the security alert,
transmitting the one or more API calls to one or more API endpoints of the plurality of distinct third-party security services, and
obtaining, in response to transmitting the one or more API calls, log data associated with the security incident,
the investigation findings data includes the log data obtained from executing each of the one or more automated investigation workflows, and
the security incident explanation prompt further includes the log data obtained from executing each of the one or more automated investigation workflows.

9. The computer-implemented method according to claim 8, wherein:
the large language model generates the security incident explanation by at least:
assessing, in accordance with one or more instructions included in the security incident explanation prompt, the alert metadata associated with the security alert,
assessing, in accordance with the one or more instructions included in the security incident explanation prompt, each distinct piece of alert data specified in the plurality of distinct third-party security alerts,
assessing, in accordance with the one or more instructions included in the security incident explanation prompt, the one or more remediation actions, and
assessing, in accordance with the one or more instructions included in the security incident explanation prompt, the log data obtained from executing each of the one or more automated investigation workflows.

10. The computer-implemented method according to claim 1, wherein:
the security incident explanation prompt includes:
a plurality of example security alerts associated with a prior security incident,
a plurality of example remediation actions performed in response to detecting the prior security incident,
a plurality of example malicious activity findings identified during a security investigation of the prior security incident,
an example security incident explanation generated for the prior security incident based on an assessment of the plurality of example security alerts, the plurality of example remediation actions, and the plurality of example malicious activity findings,
a first instruction that:
(i) instructs the large language model to use the example security incident explanation when generating the security incident explanation for the security incident, and
(ii) specifies the example security incident explanation is derived from the plurality of example security alerts, the plurality of example remediation actions, and the plurality of example malicious activity findings,
the alert metadata associated with the security alert,
the investigation findings data obtained from investigating the security alert,
one or more remediation actions proposed by the event detection and response service to remediate or mitigate a security threat associated with the security incident, and
a second instruction that further instructs the large language model to generate the security incident explanation for the security incident based on the alert metadata associated with the security alert, the investigation findings data obtained from investigating the security alert, and the one or more remediation actions proposed by the event detection and response service to remediate or mitigate the security threat associated with the security incident.

11. The computer-implemented method according to claim 1, further comprising:
before generating the security incident explanation prompt:
assessing an alert queue to determine whether the alert queue includes any pending security alerts associated with the subscribing entity and related to the security incident;
detecting, based on the assessing of the alert queue, that a plurality of pending security alerts stored in the alert queue are related to the security incident; and
generating a plurality of remediation actions to remediate or mitigate a security threat associated with the security alert and the plurality of pending security alerts, wherein:
the investigation findings data includes a plurality of distinct malicious activity findings identified during investigation of the security alert and the plurality of pending security alerts,
the security incident explanation prompt includes:
the security alert associated with the subscribing entity,
the plurality of pending security alerts,
the plurality of remediation actions generated for the security alert and the plurality of pending security alerts, and
the plurality of distinct malicious activity findings identified during the investigation of the security alert and the plurality of pending security alerts,
a first instruction that instructs the large language model to generate the security incident explanation based on the security alert, the plurality of pending security alerts, the plurality of distinct malicious activity findings, and the plurality of remediation actions, and
a second instruction that further instructs the large language model to
generate the security incident explanation by at least:
determining, based on one or more event selection criteria, a target event included in the security alert and the plurality of pending security alerts,
using the plurality of distinct malicious activity findings to add context to the security incident explanation, and
using the plurality of remediation actions to describe malicious digital activity that occurred in one or more computing environments of the subscribing entity.

12. The computer-implemented method according to claim 1, wherein the security incident explanation includes:
a first set of text strings describing, in natural language, an earliest timestamp of malicious activity identified in the investigation findings data,
a second set of text strings describing, in natural language, the malicious activity that occurred at the earliest timestamp,
a third set of text strings describing, in natural language, a total number of digital accounts of the subscribing entity determined to be compromised,
a fourth set of text strings describing, in natural language, a plurality of computing hosts within a computing environment of the subscribing entity that were accessed during the security incident,
a fifth set of text strings describing, in natural language, one or more techniques used by a threat actor to access or move between the plurality of computing hosts during the security incident, and
a sixth set of text strings describing, in natural language, that the plurality of computing hosts were compromised; and
a seventh set of text strings describing, in natural language, one or more pieces of evidence included in the investigation findings data that resulted in the large language model detecting that the plurality of computing hosts were compromised.

13. The computer-implemented method according to claim 1, wherein the security incident explanation includes:
a first set of text strings describing, in natural language, an earliest timestamp of attacker activity detected in the investigation findings data,
a second set of text strings describing, in natural language, a computing resource of the subscribing entity that a threat actor accessed during the security incident,
a third set of text strings describing, in natural language, a digital account of the subscribing entity that the threat actor used to access the computing resource of the subscribing entity, and
a fourth set of text strings describing, in natural language, that the threat actor operated command-and-control infrastructure at a network address specified in the investigation findings data.

14. The computer-implemented method according to claim 1, further comprising:
in response to escalating the security alert to the security incident, transmitting, over a computer network, a security incident explanation request to a security incident explanation microservice;
in response to the security incident explanation microservice receiving the security incident explanation request, querying one or more databases of the event detection and response service to retrieve the alert metadata associated with the security alert and the investigation findings data obtained from investigating the security alert;
generating, using the security incident explanation microservice, the security incident explanation prompt after the security incident explanation microservice receives the alert metadata associated with the security alert and the investigation findings data obtained from investigating the security alert;
transmitting the security incident explanation prompt generated by the security incident explanation microservice to the large language model;
storing, in computer memory accessible to the security incident explanation microservice, the security incident explanation generated by the large language model; and
transmitting, by the security incident explanation microservice, the security incident explanation stored in the computer memory to the event detection and response service.

15. The computer-implemented method according to claim 1, further comprising:
after the large language model generates the security incident explanation for the security incident:
receiving, via the graphical user interface, feedback data from the user indicating an efficacy of the security incident explanation generated by the large language model;
automatically generating, using the one or more processors, a training data sample that includes:
the security incident explanation prompt provided to the large language model,
the security incident explanation generated by the large language model based on the large language model processing the security incident explanation prompt, and
the feedback data; and
training the large language model using at least the training data sample.

16. The computer-implemented method according to claim 1, wherein:
the event detection and response service automatically created the security incident explanation prompt based on one or more prompt generation parameters stored in memory, and
the computer-implemented method includes:
after the large language model generates the security incident explanation for the security incident:
receiving, via the graphical user interface, feedback data from the user indicating an efficacy of the security incident explanation generated for the security incident, and
adjusting, based on the feedback data, at least one of the one or more prompt generation parameters to modify how the event detection and response service constructs subsequent security incident explanation prompts.

17. The computer-implemented method according to claim 1, wherein adapting the security incident artifact to include the security incident explanation generated by the large language model includes:
automatically inserting the security incident explanation generated by the large language model into a findings section of the security incident artifact.

18. The computer-implemented method according to claim 1, wherein:
automatically creating the security incident explanation prompt includes:
obtaining, from one or more databases of the event detection and response service, the alert metadata associated with the security alert and the investigation findings data obtained from investigating the security alert, and
automatically anonymizing, by the one or more processors, at least one piece of data included in the alert metadata or the investigation findings data to an anonymized piece of data, wherein the security incident explanation prompt includes the anonymized piece of data and excludes the at least one piece of data in original form,
the security incident explanation generated by the large language model includes the anonymized piece of data, and
the computer-implemented method further includes:
in response to adapting the security incident artifact to include the security incident explanation generated by the large language model, automatically replacing the anonymized piece of data included in the security incident artifact with the at least one piece of data in original form.

19. The computer-implemented method according to claim 1, wherein automatically creating the security incident explanation prompt includes:
automatically obtaining, from one or more databases of the event detection and response service, the alert metadata associated with the security alert and the investigation findings data obtained from investigating the security alert,
automatically detecting personally identifiable information included in the alert metadata and the investigation findings data,
in response to detecting the personally identifiable information, automatically generating a sanitized version of the alert metadata and the investigation findings data by removing the personally identifiable information from the alert metadata and the investigation findings data, and
automatically constructing the security incident explanation prompt using the sanitized version of the alert metadata and the investigation findings data.

20. A computer-implemented method comprising:
at an event detection and response service implemented by a network of distributed computers:
displaying, via a graphical user interface, a security alert associated with a subscribing entity;
receiving, while the security alert is displayed on the graphical user interface, an input from a user selecting a security incident creation object;
in response to receiving the input selecting the security incident creation object:
automatically escalating, in real-time, the security alert to a security incident;
automatically generating, in real-time, a security incident artifact that corresponds to the security alert;
automatically updating, in real-time, the graphical user interface from displaying the security alert to displaying the security incident artifact corresponding to the security alert; and
displaying a security incident explanation button on the graphical user interface while the graphical user interface is displaying the security incident artifact;
receiving, from the user, an input selecting the security incident explanation button;
in response to receiving the input from the user selecting the security incident explanation button:
automatically creating, in real-time, a security incident explanation prompt based on (i) alert metadata associated with the security alert and (ii) investigation findings data obtained from investigating the security alert; and
generating, in real-time, using a large language model, a security incident explanation for the security incident based on providing the security incident explanation prompt to the large language model;
adapting, in real-time, the security incident artifact to include the security incident explanation generated by the large language model; and
surfacing, using one or more processors, the security incident artifact comprising the security incident explanation to the subscribing entity.
